(19) United States
(12) Patent Application Publication
(10) Pub. No.: US 2015/0011394 A1
(43) Pub. Date: Jan. 8, 2015

(54) USE OF HOST DEFENSE INDUCERS FOR CONTROLLING BACTERIAL HARMFUL ORGANISMS IN USEFUL PLANTS

(71) Applicant: BAYER INTELLECTUAL PROPERTY GMBH, Monheim (DE)

(72) Inventors: Miguel Lino Dias, Leverkusen (DE); Gilbert Labourdette, Paray-le-Monial (FR); Norberto Hernandez, Bogota (CO); Hiroyuki Hadano, Tochigi (JP); Ingo Wetcholowsky, Langenfeld (DE); Matias Pastore, Buenos Aires (AR); Akihisa Oshima, Beijing (CN); Karl-Wilhelm Muenks, Carmichael, CA (US)

(73) Assignee: BAYER INTELLECTUAL PROPERTY GMBH, Monheim (DE)

(21) Appl. No.: 14/373,348

(22) PCT Filed: Jan. 17, 2013
(86) PCT No.: PCT/EP2013/050772

§ 371 Date: Jul. 19, 2014

(30) Foreign Application Priority Data
Jan. 21, 2012 (CN) PCT/CN2012/000117
Aug. 20, 2012 (CN) PCT/CN2012/001113

(51) Int. Cl. A01N 43/80; A01N 43/56; A01N 57/12; A01N 37/50

(52) U.S. Cl. CPC A01N 43/80; A01N 37/50; A01N 43/56; A01N 57/12
USPC 504/269; 548/214

(57) ABSTRACT

The present invention relates to the use of host defense inducers for controlling selected bacterial harmful organisms in useful plants, wherein the bacterial harmful organisms are selected from the group consisting of Acidovorax avenae, Burkholderia spec., Burkholderia glumae, Candidatus Liberibacter spec., Corynebacterium, Erwinia spec., Pseudomonas syringae, Pseudomonas syringae pv. actinidae, Pseudomonas syringae pv. glycinea, Pseudomonas syringae pv. tomato, Pseudomonas syringae pv. lachrymans, Streptomyces spp., Xanthomonas spp., Xanthomonas axonopodis, Xanthomonas axonopodis pv. citri, Xanthomonas axonopodis pv. glycines, Xanthomonas campestris, Xanthomonas campestris pv. musacearum, Xanthomonas campestris pv. pruni, Xanthomonas fragariae and Xanthomonas transluscens. In a preferred aspect of the invention the host defense inducer is isotianil. The present invention also relates to a method for controlling the selected bacterial harmful organisms in useful plants by treatment with a host defense inducer.

The present invention relates to the use of host defense inducers for controlling selected bacterial harmful organisms in useful plants, wherein the bacterial harmful organisms are selected from the group consisting of Acidovorax avenae, Burkholderia spec., Burkholderia glumae, Candidatus Liberibacter spec., Corynebacterium, Erwinia spec., Pseudomonas syringae, Pseudomonas syringae pv. actinidae, Pseudomonas syringae pv. glycinea, Pseudomonas syringae pv. tomato, Pseudomonas syringae pv. lachrymans, Streptomyces spp., Xanthomonas spp., Xanthomonas axonopodis, Xanthomonas axonopodis pv. citri, Xanthomonas axonopodis pv. glycines, Xanthomonas campestris, Xanthomonas campestris pv. musacearum, Xanthomonas campestris pv. pruni, Xanthomonas fragariae and Xanthomonas transluscens. In a preferred aspect of the invention the host defense inducer is isotianil. The present invention also relates to a method for controlling the selected bacterial harmful organisms in useful plants by treatment with a host defense inducer.

### INTRODUCTION AND PRIOR ART

International patent application WO 2010/089055 A2 and the corresponding European patent application EP 2393363 A2 generally disclose the use of sulphur-containing heteroaromatic acid analogues according to a general formula (I) for controlling bacterial harmful organisms in useful plants. The general formula (I) encompasses inter alia the host defense inducers tiadinil (compound I-1) and isotianil (compound I-15) out of a list of 20 different preferred specific compounds. The host defense inducer acibenzolar-S-methyl and probenazole are not comprised by formula (I). Further, the application broadly refers to various bacteria strains and to diverse plants to be treated. The application specifically only refers to one concrete example, wherein the use of compound I-15 (isotianil) in the treatment of rice against Xanthomonas campestris pv. oryzae is described. In view thereof, the present invention can be considered as a selection invention over WO 2010/089055 A2, wherein from a first general list of compounds the host defense inducers isotianil and tiadinil are selected and from a second general list of diverse bacterial harmful organisms specific bacteria strains are selected. The use of the host defense inducer acibenzolar-S-methyl and probenazole which are also preferred according to the present invention, for controlling bacterial harmful organisms in useful plants, is not covered by WO 2010/089055 A2. A further even more specific selection is directed to the use of the host defense inducers for controlling specific bacterial harmful organisms in specific plants. The inventors of the present invention surprisingly found the beneficial effects of such selected compounds in combating the specific selection of bacterial harmful plants, especially in specific plants.

The beneficial effects and new use of the selected host defense inducers have now been shown by the inventors of the present invention for the first time and were not obviously suggested by the mentioned prior art.

Bacteria as pathogens in useful plants are encountered inter alia in temperate or warm and humid climates, where they cause bacterioses in a large number of useful plants with in some cases considerable economic losses.

Rice, for example, may be infected with Acidovorax avenae or Burkholderia glumae, causing brown stripe or bacterial grain rot, respectively.

Citrus greening disease (Huanglongbing, HLB, citrus vein phloem degeneration (CVPD), yellow shoot disease, leaf mottle yellow (in the Philippines), libukin (in Taiwan) and citrus dieback (in India)), caused by Candidatus Liberibacter spp., is probably the most deleterious disease of citrus and greatly reduces production, destroys the economic value of fruit and can ultimately lead to the death of the entire plant. Candidatus Liberibacter spp. is a genus of gram-negative bacteria in the Rhizobiaceae family. Members of the genus are plant pathogens, which are mostly transmitted by psyllids. The disease is distinguished by the common symptoms of yellowing of the veins and adjacent tissues; followed by yellowing or mottling of the entire leaf; followed by premature defoliation, dieback of twigs, decay of feeder rootlets and lateral roots, and decline in vigor; and followed by, ultimately, the death of the entire plant. Affected trees have stunted growth, bear multiple off-season flowers (most of which fall off), and produce small, irregularly-shaped fruit with a thick, pale peel that remains green at the bottom. Fruit from these trees tastes bitter. Infected trees do not recover and there is no curative method existing. The control of HLB is based on the preventive control of the vectors using systemic insecticides and contact insecticides. However, the efficacy and activity spectrum of these compounds are not always completely satisfactory. Newly infected trees show the first symptoms after a latency period of 6-12 months. In addition, it is essential to eradicate infected trees to prevent further uptake by psyllids and spreading of the disease. There is no cure for Huanglongbing and efforts to control the disease have been slow because infected citrus plants are difficult to maintain, regenerate, and study. Researchers at the Agricultural Research Service have used Huanglongbing-infected lemon trees to infect periwinkle plants in an effort to study the disease. Periwinkle plants are easily infected with the disease and respond well when experimentally treated with antibiotics. Researchers are testing the effect of penicillin G sodium and the biocide 2,2-dibromo-3-nitrilopropionamide as potential treatments for infected citrus plants based on the positive results that were observed when applied to infected periwinkle HLB bacteria live and multiply exclusively in the phloem of citrus trees. Hitherto, there are however only few bactericides for the curative control of HLB, e.g. the international application WO 2011/029536 A2 refers to the use of cyclic ketoenols against Candidatus liberibacter spp.

Citrus canker is a disease affecting citrus species that is caused by the bacterium Xanthomonas axonopodis pv. citri (=Xanthomonas campestris pv. citri). Infection causes lesions on the leaves, stems, and fruit of citrus trees, including lime, oranges, and grapefruit. While not harmful to humans, canker significantly affects the vitality of citrus trees, causing leaves and fruit to drop prematurely; a fruit infected with canker is safe to eat but too unsightly to be sold. The impact is worsened because the presence of citrus canker in an area triggers immediate quarantine restrictions, disrupting the movement of fresh fruit. Citrus canker is believed to have originated in the area of Southeast Asia-India. It is now also present in Japan, South and Central Africa, the Middle East, Bangladesh, the Pacific Islands, some countries in South America, and Florida. Some areas of the world have eradicated citrus canker and others have ongoing eradication programs (citrus groves have been destroyed in attempts to eradicate the disease), but the disease remains endemic in most areas where it has appeared. Because of its rapid spread, high potential for damage and impact on export sales and domestic trade, citrus canker is a significant threat to all citrus-growing regions.

The kiwifruit industry is widely affected by Pseudomonas ssp. infections, e.g. infection with Pseudomonas syringae pv. actinidae (Psa) was first identified in New Zealand and in Japan and Italy, too, where it is extremely damaging on Gold kiwifruit. Presently, intensive research and testing of possible solutions against Psa damage in kiwi fruits are carried out.

Potato tuber Bacterial scab (Common scab) is an emerging issue in core potato growing areas which badly affects the tuber quality. The effected potato tubers are graded as low quality and achieve low prices in the market and in case of high infestation the potatoes are difficult to sell. It is general perception of the farmer that the disease is increasing every year.

Infection with Erwinia species, for example, may cause the death of entire fruit plantations such as apples or pears. Also known is bacterial soft rot in potatoes, tumour formation in plants caused by infection with agrobacteria and also a large number of necrotic diseases when cereals such as wheat or rice, vegetables or citrus fruit are infected by Xanthomonas species.

The standard treatment against bacterial harmful organisms comprises the use of antibiotics such as e.g. streptomycin, blasticidin S or kasugamycin, which is, in principle, the only effective way for controlling bacteria in useful plants. However, this approach is adopted only in rare cases since these antibiotics rely on the same mechanisms of action as antibiotics used in human and veterinary medicine, and there are therefore huge reservations against the use of antibiotics in plant protection. There are concerns that the formation of resistance is promoted; moreover, most antibiotics are expensive and can frequently only be obtained by employing biotechnological methods, inter alia. Another approach for controlling bacteria in plant aims at the use of copper oxychloride, which is disadvantageous because of the necessity of high doses to be applied in the standard treatment. Copper oxychloride is e.g. used in controlling Pseudomonas syringae for example in the protection of tomatoes. Further, copper oxychloride is discussed as being phytotoxic and its use is more and more restricted as it is known to accumulate in the soil. In addition, copper oxychloride formulations normally leave visible residues on leaves and fruits, which is not appreciated and accepted by consumers.

There is therefore a great need for specific effective methods for controlling bacterial diseases in useful plants, which methods furthermore require only small amounts of substance to be applied and, in addition, do not damage the plants or harm human or animal health.

It has now been found that host defense inducers such as preferably acibenzolar-S-methyl, isotianil, probenazole and tiadinil, or combinations thereof, are particularly suitable for controlling bacterial harmful organisms of the group consisting of group consisting of Acidovorax avenae, Burkholderia spec., Burkholderia glumae, Candidatus Liberibacter spec., Corynebacterium, Erwinia spec., Pseudomonas syringae, Pseudomonas syringae pv. actinidae, Pseudomonas syringae pv. glycinea, Pseudomonas syringae pv. tomato, Pseudomonas syringae pv. lachrymans, Streptomyces spp., Xanthomonas spp., Xanthomonas axonopodis, Xanthomonas axonopodis pv. citri, Xanthomonas axonopodis pv. glycines, Xanthomonas campestris, Xanthomonas campestris pv. musacearum Xanthomonas campestris pv. pruni, Xanthomonas fragariae and Xanthomonas transluscens in useful plants.

### Problem to be Solved

It was the object of the present invention to provide novel active compounds for controlling selected bacterial harmful organisms in useful plants.

### DESCRIPTION OF THE INVENTION

The problem underlying the present invention has been solved by identifying the beneficial effects of host defense inducers such as preferably acibenzolar-S-methyl, isotianil, probenazole and tiadinil, in the treatment of useful plants against selected bacterial harmful organisms.

In the context of the present invention host defense inducers refer to compounds which are characterized by their capability of stimulating the plant's own defense mechanisms so that the plant is protected against infection. Host defense inducers are then used for inducing early and strongly genes known as plant defense inducers. They prime the plant for stronger and/or faster induction of defense genes after a pathogen attack. According to the present invention, host defense inducers comprise e.g.

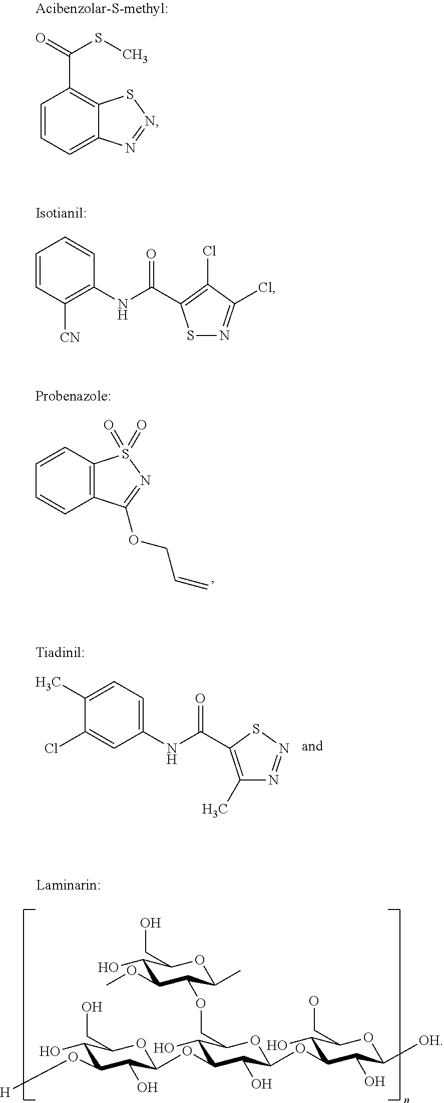

Therefrom, acibenzolar-S-methyl, isotianil, probenazole and tiadinil, or combinations thereof, are preferred; the most preferred host defense inducer is isotianil.

The host defense inducers of the present invention may, if appropriate, be present in the form of mixtures of various isomeric forms which are possible, in particular stereoisomers, such as optical isomers.

The host defense inducers according to the present invention are suitable in the use for controlling bacterial harmful organisms. According to the present invention bacterial harmful organisms include inter alia bacteria causing damage to plants or to a part of a plant.

Bacteria include inter alia Actinobacteria and Proteobacteria and are selected from the families of the Xanthomonadaceae, Pseudomonadaceae, Enterobacteriaceae, Microbacteriaceae, and Rhizobiaceae.

According to the present invention the bacterial harmful organisms are selected from the group consisting of:

Acidovorax avenae (=Pseudomonas avenae, Pseudomonas avenae subsp. avenae, Pseudomonas rubrilineans), including e.g. Acidovorax avenae subsp. avenae (=Pseudomonas avenae subsp. avenae), Acidovorax avenae subsp. cattleyae (=Pseudomonas cattleyae), Acidovorax avenae subsp. citrulli (=Pseudomonas pseudoalcaligenes subsp. citrulli, Pseudomonas avenae subsp. citrulli));

Burkholderia spec., including e.g. Burkholderia andropogonis (=Pseudomonas andropogonis, Pseudomonas woodsii), Burkholderia caryophylli (=Pseudomonas caryophylli), Burkholderia cepacia (=Pseudomonas cepacia), Burkholderia gladioli (=Pseudomonas gladioli), Burkholderia gladioli pv. agaricicola (=Pseudomnas gladioli pv. agaricicola), Burkholderia gladioli pv. alliicola (=Pseusomonas gladioli pv. alliicola), Burkholderia gladioli pv. gladioli (=Pseudomonas gladioli, Pseudomonas gladioli pv. gladioli), Burkholderia glumae (=Pseudomonas glumae), Burkholderia plantarii (=Pseudomonas plantarii) Burkholderia solanacearum (=Ralstonia solanacearum);

Candidatus Liberibacter spec., including e.g. Liberibacter africanus (Laf), Liberibacter americanus (Lam), Liberibacter asiaticus (Las), Liberibacter europaeus (Leu), Liberibacter psyllaurous, Liberibacter solanacearum (Lso);

Corynebacterium, including e.g. Corynebacterium fascians, Corynebacterium flaccumfaciens pv. flaccumfaciens, Corynebacterium michiganensis, Corynebacterium michiganense pv. tritici, Corynebacterium michiganense pv. nebraskense, Corynebacterium sepedonicum;

Erwinia spec. including e.g. Erwinia amylovora, Erwinia ananas, Erwinia carotovora (=Pectobacterium carotovorum), Erwinia carotovora subsp. atroseptica, Erwinia carotovora subsp. carotovora, Erwinia chrysanthemi, Erwinia chrysanthemi pv. zeae, Erwinia dissolvers, Erwinia herbicola, Erwinia rhapontic, Erwinia stewartiii, Erwinia tracheiphila, Erwinia uredovora;

Pseudomonas syringae, including e.g. Pseudomonas syringae pv. actinidiae (Psa), Pseudomonas syringae pv. atrofaciens, Pseudomonas syringae pv. coronafaciens, Pseudomonas syringae pv. glycinea, Pseudomonas syringae pv. lachrymans, Pseudomonas syringae pv. maculicola Pseudomonas syringae pv. papulans, Pseudomonas syringae pv. striafaciens, Pseudomonas syringae pv. syringae, Pseudomonas syringae pv. tomato, Pseudomonas syringae pv. tabaci;

Streptomyces ssp., including e.g. Streptomyces acidiscabies, Streptomyces albidoflavus, Streptomyces candidus (=Actinomyces candidus), Streptomyces caviscabies, Streptomyces collinus, Streptomyces europaeiscabiei, Streptomyces intermedius, Streptomyces ipomoeae, Streptomyces luridiscabiei, Streptomyces niveiscabiei, Streptomyces puniciscabiei, Streptomyces retuculiscabiei, Streptomyces scabiei, Streptomyces scabies, Streptomyces setonii, Streptomyces steliiscabiei, Streptomyces turgidiscabies, Streptomyces wedmorensis;

Xanthomonas axonopodis, including e.g. Xanthomonas axonopodis pv. alfalfae (=Xanthomonas alfalfae), Xanthomonas axonopodis pv. aurantifolii (=Xanthomonas fuscans subsp. aurantifolii), Xanthomonas axonopodis pv. allii (=Xanthomonas campestris pv. allii), Xanthomonas axonopodis pv. axonopodis, Xanthomonas axonopodis pv. bauhiniae (=Xanthomonas campestris pv. bauhiniae), Xanthomonas axonopodis pv. begoniae (=Xanthomonas campestris pv. begoniae), Xanthomonas axonopodis pv. betlicola (=Xanthomonas campestris pv. betlicola), Xanthomonas axonopodis pv. biophyti (=Xanthomonas campestris pv. biophyti), Xanthomonas axonopodis pv. cajani (=Xanthomonas campestris pv. cajani), Xanthomonas axonopodis pv. cassayae (=Xanthomonas cassayae, Xanthomonas campestris pv. cassayae), Xanthomonas axonopodis pv. cassiae (=Xanthomonas campestris pv. cassiae), Xanthomonas axonopodis pv. citri (=Xanthomonas citri), Xanthomonas axonopodis pv. citrumelo (=Xanthomonas alfalfae subsp. citrumelonis), Xanthomonas axonopodis pv. clitoriae (=Xanthomonas campestris pv. clitoriae), Xanthomonas axonopodis pv. coracanae (=Xanthomonas campestris pv. coracanae), Xanthomonas axonopodis pv. cyamopsidis (=Xanthomonas campestris pv. cyamopsidis), Xanthomonas axonopodis pv. desmodii (=Xanthomonas campestris pv. desmodii), Xanthomonas axonopodis pv. desmodiigangetici (=Xanthomonas campestris pv. desmodiigangetici), Xanthomonas axonopodis pv. desmodiilaxiflori (=Xanthomonas campestris pv. desmodiilaxiflori), Xanthomonas axonopodis pv. desmodiirotundifolii (=Xanthomonas campestris pv. desmodiirotundifolii), Xanthomonas axonopodis pv. dieffenbachiae (=Xanthomonas campestris pv. dieffenbachiae), Xanthomonas axonopodis pv. erythrinae (=Xanthomonas campestris pv. erythrinae), Xanthomonas axonopodis pv. fascicularis (=Xanthomonas campestris pv. fasciculari), Xanthomonas axonopodis pv. glycines (=Xanthomonas campestris pv. glycines), Xanthomonas axonopodis pv. khayae (=Xanthomonas campestris pv. khayae), Xanthomonas axonopodis pv. lespedezae (=Xanthomonas campestris pv. lespedezae), Xanthomonas axonopodis pv. maculifoliigardeniae (=Xanthomonas campestris pv. maculifoliigardeniae), Xanthomonas axonopodis pv. malvacearum (=Xanthomonas citri subsp. malvacearum), Xanthomonas axonopodis pv. manihotis (=Xanthomonas campestris pv. manihotis), Xanthomonas axonopodis pv. martyniicola (=Xanthomonas campestris pv. martyniicola), Xanthomonas axonopodis pv. melhusii (=Xanthomonas campestris pv. melhusii), Xanthomonas axonopodis pv. nakataecorchori (=Xanthomonas campestris pv. nakataecorchori), Xanthomonas axonopodis pv. passiflorae (=Xanthomonas campestris pv. passiflorae), Xanthomonas axonopodis pv. patelii (=Xanthomonas campestris pv. patelii), Xanthomonas axonopodis pv. pedalii (=Xanthomonas campestris pv. pedalii), Xanthomonas axonopodis pv. phaseoli (=Xanthomonas campestris pv. phaseoli, Xanthomonas phaseoli), Xanthomonas axonopodis pv. phaseoli var. fuscans (=Xanthomonas fuscans), Xanthomonas axonopodis pv. phyllanthi (=Xanthomonas campestris pv. phyllanthi), Xanthomonas axonopodis pv. physalidicola (=Xanthomonas campestris pv. physalidicola), Xanthomonas axonopodis pv. poinsettiicola (=Xanthomonas campestris pv. poinsettiicola), Xanthomonas axonopodis pv. punicae (=Xanthomonas campestris pv. punicae), Xanthomonas axonopodis pv. rhynchosiae (=Xanthomonas campestris pv. rhynchosiae), Xanthomonas axonopodis pv. ricini (=Xanthomonas campestris pv. ricini), Xanthomonas axonopodis pv. sesbaniae (=Xanthomonas campestris pv. sesbaniae), Xanthomonas axonopodis pv. tamarindi (=Xanthomonas campestris pv. tamarindi), Xanthomonas axonopodis pv. vasculorum (=Xanthomonas campestris pv. vasculorum), Xanthomonas axonopodis pv. vesicatoria (=Xanthomonas campestris pv. vesicatoria, Xanthomonas vesicatoria), Xanthomonas axonopodis pv. vignaeradiatae (=Xanthomonas campestris pv. vignaeradiatae), Xanthomonas axonopodis pv. vignicola (=Xanthomonas campestris pv. vignicola), Xanthomonas axonopodis pv. vitians (=Xanthomonas campestris pv. vitians);

Xanthomonas campestris pv. musacearum, Xanthomonas campestris pv. pruni (=Xanthomonas arboricola pv. pruni), Xanthomonas fragariae; Xanthomonas translucens (=Xanthomonas campestris pv. hordei) including e.g. Xanthomonas translucens pv. arrhenatheri (=Xanthomonas campestris pv. arrhenatheri), Xanthomonas translucens pv. cerealis (=Xanthomonas campestris pv. cerealis), Xanthomonas translucens pv. graminis (=Xanthomonas campestris pv. graminis), Xanthomonas translucens pv. phlei (=Xanthomonas campestris pv. phlei), Xanthomonas translucens pv. phleipratensis (=Xanthomonas campestris pv. phleipratensis), Xanthomonas translucens pv. poae (=Xanthomonas campestris pv. poae), Xanthomonas translucens pv. secalis (=Xanthomonas campestris pv. secalis), Xanthomonas translucens pv. translucens (=Xanthomonas campestris pv. translucens), Xanthomonas translucens pv. undulosa (=Xanthomonas campestris pv. undulosa.

Preferably, the bacterial harmful organisms are selected from the group consisting of:

Acidovorax avenae subsp. avenae (=Pseudomonas avenae subsp. avenae), Acidovorax avenae subsp. citrulli (=Pseudomonas pseudoalcaligenes subsp. citrulli, Pseudomonas avenae subsp. citrulli), Burkholderia glumae (=Pseudomonas glumae), Burkholderia solanacearum (=Ralstonia solanacearum), Candidatus Liberibacter spec. as defined above, Corynebacterium michiganense pv. nebraskense, Erwinia amylovora, Erwinia carotovora (=Pectobacterium carotovorum), Erwinia carotovora subsp. atroseptica, Erwinia carotovora subsp. carotovora, Erwinia chrysanthemi, Erwinia chrysanthemi pv. zeae, Erwinia herbicola, Erwinia stewartiii, Erwinia uredovora, Pseudomonas syringae, Pseudomonas syringae pv. actinidiae (Psa), Pseudomonas syringae pv. glycinea, Pseudomonas syringae pv. lachrymans, Pseudomonas syringae pv. papulans, Pseudomonas syringae pv. syringae, Pseudomonas syringae pv. tomato, Pseudomonas syringae pv. tabaci, Streptomyces scabies, Xanthomonas axonopodis pv. citri, Xanthomonas axonopodis pv. glycines (=Xanthomonas campestris pv. glycines), Xanthomonas axonopodis pv. punicae (=Xanthomonas campestris pv. punicae), Xanthomonas axonopodis pv. vesicatoria (=Xanthomonas campestris pv. vesicatoria, Xanthomonas vesicatoria), Xanthomonas campestris, Xanthomonas campestris pv. musacearum, Xanthomonas campestris pv. pruni (=Xanthomonas arboricola pv. pruni), Xanthomonas fragariae, Xanthomonas translucens pv. translucens (=Xanthomonas campestris pv. translucens).

In a more preferred aspect of the present invention the bacterial harmful organisms are selected from the group consisting of:

Acidovorax avenae (=Pseudomonas avenae, Pseudomonas avenae subsp. avenae, Pseudomonas rubrilineans) as defined above, Burkholderia spec. as defined above, Burkholderia glumae, Candidatus Liberibacter spec. as defined above, Corynebacterium as defined above, Erwinia spec. as defined above, Erwinia amylovora, Erwinia carotovora (=Pectobacterium carotovorum), Erwinia carotovora subsp. atroseptica, Erwinia carotovora subsp. carotovora, Erwinia chrysanthemi, Erwinia chrysanthemi pv. zeae, Erwinia herbicola, Erwinia stewartiii, Erwinia uredovora, Pseudomonas syringae as defined above, Pseudomonas syringae pv. actinidae, Pseudomonas syringae pv. glycinea, Pseudomonas syringae pv. tomato, Pseudomonas syringae pv. lachrymans, Streptomyces spp., Streptomyces scabies, Xanthomonas spp., Xanthomonas axonopodis as defined above, Xanthomonas axonopodis pv. citri, Xanthomonas axonopodis pv. glycines, Xanthomonas campestris, Xanthomonas campestris pv. musacearum, Xanthomonas campestris pv. pruni (=Xanthomonas arboricola pv. pruni), Xanthomonas fragariae and Xanthomonas translucens (=Xanthomonas campestris pv. hordei) as defined above.

Even more preferred is a selection consisting of:

Acidovorax avenae, Burkholderia spec., Burkholderia glumae, Candidatus Liberibacter spec., Corynebacterium, Erwinia spec., Pseudomonas syringae, Pseudomonas syringae pv. actinidae, Pseudomonas syringae pv. glycinea, Pseudomonas syringae pv. tomato, Pseudomonas syringae pv. lachrymans, Streptomyces spp., Xanthomonas spp., Xanthomonas axonopodis, Xanthomonas axonopodis pv. citri, Xanthomonas axonopodis pv. glycines, Xanthomonas campestris, Xanthomonas campestris pv. musacearum, Xanthomonas campestris pv. pruni, Xanthomonas fragariae and Xanthomonas transluscens.

In an even more preferred aspect of the present invention the bacterial harmful organisms are selected from the group consisting of:

Acidovorax avenae, Burkholderia spec., Burkholderia glumae, Candidatus Liberibacter spec., Corynebacterium, Erwinia amylovora, Erwinia carotovora, Erwinia carotovora subsp. atroseptica, Erwinia carotovora subsp. carotovora, Erwinia chrysanthemi, Erwinia chrysanthemi pv. zeae, Erwinia herbicola, Erwinia stewartiii, Erwinia uredovora, Pseudomonas syringae, Pseudomonas syringae pv. actinidae, Pseudomonas syringae pv. glycinea, Pseudomonas syringae pv. lachrymans, Pseudomonas syringae pv. tomato, Streptomyces scabies, Xanthomonas axonopodis, Xanthomonas axonopodis pv. citri, Xanthomonas axonopodis pv. glycines, Xanthomonas campestris, Xanthomonas campestris pv. musacearum, Xanthomonas campestris pv. pruni, Xanthomonas fragariae and Xanthomonas translucens

The most preferred selection comprises the group consisting of:

Burkholderia glumae, Candidatus Liberibacter spec., Xanthomonas axonopodis pv. citri, Pseudomonas syringae, Pseudomonas syringae pv. actinidae, Pseudomonas syringae pv. glycinea, Pseudomonas syringae pv. lachrymans, Pseudomonas syringae pv. tomato, Streptomyces scabies, Xanthomonas axonopodis pv. glycines, Xanthomonas campestris pv. pruni and Xanthomonas campestris.

The host defense inducers according to the present invention can therefore be employed for protecting plants against attack by the abovementioned pathogens within a certain post-treatment period. The period within which protection is afforded generally extends from 1 to 10 days, preferably 1 to 7 days, after the treatment of the plants with the active compounds. Depending on the form of application, the accessibility of the active compounds to the plant can be controlled in a targeted manner

The good plant tolerance of the host defense inducers at the concentrations required for controlling plant diseases permits a treatment of aerial and subterranean plant parts, of vegetative propagation material, and of the soil.

The host defense inducers according to the present invention are also suitable for increasing the yield, show low toxicity and are well tolerated by plants.

In the context of the present invention, on application to plants an advantageous effect was observed.

In accordance with the invention, all plants may be treated. Plants are, in the present context, understood as meaning all plant parts and plant populations, such as desired and undesired wild plants or crop plants (including naturally occurring crop plants). Crop plants may be plants which can be obtained by traditional breeding and optimization methods or else by biotechnological and recombinant methods, or combinations of these methods, including the transgenic plants and including the plant varieties capable or not of being protected by Plant Breeders' Rights. Such methods are, for example, doubled haploids, protoplast fusion, random or targeted mutagenesis and also molecular or genetic markers.

Plant parts are intended to mean all aerial and subterranean parts and organs of the plants, such as herb, pseudostem, shoot, leaf, bract, leaf sheaths, petiole, lamina, flower and root, examples which may be mentioned being leaves, needles, stalks, stems, flowers, fruiting bodies, fruit, banana hand, bunches and seeds, and also roots, tubers, rhizomes, offshoots, suckers, secondary growth. The plant parts also include crop material and vegetative and generative propagation material, for example cuttings, tubers, rhizomes, slips and seeds.

As has already been mentioned above, all plants can be treated in accordance with the invention. In a preferred embodiment, plant species and plant varieties, and their parts, which are found in the wild or which are obtained by conventional biological breeding methods, such as hybridization, meristem cultures, micropropagation, somatic embryogenesis, direct organogenesis or protoplast fusion, are treated. In a further preferred embodiment, transgenic plants and plant varieties which have been obtained by recombinant methods, if appropriate in combination with traditional methods (genetically modified organisms), are treated, such as, for example, transformation by means of Agrobacterium or particle bombardment of embryogenic cells, and micropropagation. Plants include all plant parts as mentioned above.

It is especially preferred to treat, in accordance with the invention, plants of those plant varieties which are in each case commercially available or in use. Plant varieties are understood as meaning plants with new properties (“traits”) which have been obtained by conventional breeding, by mutagenesis or else by recombinant DNA techniques. They may be varieties, breeds, biotypes and genotypes.

The method of treatment according to the invention can be used in the treatment of genetically modified organisms (GMos), e.g. plants or seeds. Genetically modified plants (or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example antisense technology, cosuppression technology or RNA interference [RNAi] technology). A heterologous gene that is located in the genome is also called a transgene. A transgene that is defined by its particular location in the plant genome is called a transformation or transgenic event.

Plants and plant varieties which are preferably to be treated according to the invention include all plants which have genetic material which imparts particularly advantageous, useful traits to these plants (whether obtained by breeding and/or biotechnological means).

Plants that may be treated according to the invention are hybrid plants that already express the characteristics of heterosis, or hybrid vigour, which results in generally higher yield, vigour, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling (i.e. the mechanical removal of the male reproductive organs or male flowers) but, more typically, male sterility is the result of genetic determinants in the plant genome. In that case, and especially when seed is the desired product to be harvested from the hybrid plants, it is typically useful to ensure that male fertility in the hybrid plants, which contain the genetic determinants responsible for male sterility, is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmic male sterility (CMS) were for instance described for Brassica species. However, genetic determinants for male sterility can also be located in the nuclear genome. Male sterile plants can also be obtained by plant biotechnology methods such as genetic engineering. A particularly useful means of obtaining male sterile plants is described in WO 89/10396 in which, for example, a ribonuclease such as a barnase is selectively expressed in the tapetum cells in the stamens. Fertility can then be restored by expression in the tapetum cells of a ribonuclease inhibitor such as barstar.

Plants or plant varieties (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

Plants which can be treated in accordance with the invention and which may be mentioned are the following:

cotton, flax, grapevine, vegetables and fruits (for example kiwi, pineapple), such as Rosaceae sp. (for example pome fruits such as apples and pears, but also stone fruits such as apricots, cherries, almonds and peaches, and soft fruits such as strawberries), or pomegranate from the genus of Punica, Ribesioidae sp., Juglandaceae sp., Betulaceae sp., Anacardiaceae sp., Fagaceae sp., Moraceae sp., Oleaceae sp., Actimidaceae sp., Lauraceae sp., Musaceae sp. (for example banana plants and banana plantations as well as plantains), Rubiaceae sp. (for example coffee), Theaceae sp., Sterculiceae sp., Rutaceae sp. (for example citrus, lemons, oranges and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumbers, melons, cucurbits, pumpkins), Alliaceae sp. (for example leeks, onions), Papilionaceae sp. (for example peas); major crop plants such as Gramineae sp. (for example corn, maize, turf, cereals such as wheat, rye, rice, barley, oats, sorghum, millet and triticale), Asteraceae sp. (for example sunflower), Brassicaceae sp. (for example cabbage such as white cabbage and red cabbage, broccoli, cauliflower, Brussels sprouts, pak choi, kohlrabi, small radishes, and also oilseed rape, mustard, horseradish and cress), Fabacae sp. (for example beans, peanuts), Papilionaceae sp. (for example soya beans), Solanaceae sp. (for example potatoes), Chenopodiaceae sp. (for example sugar beet, fodder beet, Swiss chard, beetroot); useful plants and ornamental plants in gardens and forests; and in each case genetically modified types of these plants.

Preferably, the host defense inducers of the present invention are used for the treatment in plants selected from the group consisting of:

vegetables and fruits (for example kiwi, melon, pineapple), such as Rosaceae sp. (for example pome fruits such as apples and pears, but also stone fruits such as apricots, cherries, almonds and peaches, and soft fruits such as strawberries), or pomegranate from the genus of Punica, Musaceae sp. (for example banana plants and banana plantations as well as plantains), Rutaceae sp. (for example citrus, lemons, oranges and grapefruit); vegetables, such as Solanaceae sp. (for example tomatoes), Cucurbitaceae sp. (for example cucumbers, melons, cucurbits, pumpkins), major crop plants such as Gramineae sp. (for example corn, maize, turf, cereals such as wheat, rye, rice, barley, oats, sorghum, millet and triticale), Brassicaceae sp. (for example cabbage such as white cabbage and red cabbage, broccoli, cauliflower, Brussels sprouts, pak choi, kohlrabi, small radishes, and also oilseed rape, mustard, horseradish and cress), Papilionaceae sp. (for example soya beans), Solanaceae sp. (for example potatoes); and in each case genetically modified types of these plants.

Even more preferred is the treatment of plants selected from the group consisting of:

fruits, vegetables, potatoes, cereals, corn, rice and soybeans.

Therefrom a further preferred selection relates to the group consisting of:

kiwi, melon, pineapple, pome fruits such as apples, pears and pomegranate, stone fruits such as peaches, soft fruits such as strawberries, banana plants and banana plantations as well as plantains, citrus, lemons, oranges and grapefruit; tomatoes, cucumbers, melons, cucurbits, corn, cereals such as wheat, rice, cabbage, cauliflower, soya beans, potatoes; and in each case genetically modified types of these plants.

The most preferred selection of useful plants to be treated in accordance with the present invention relates to: apples, bananas, citrus, kiwi, melons, peaches, pears, pineapple, pome fruit, pomegranate, cabbage, cauliflower, cucumbers, cucurbits, tomatoes, potatoes, wheat, rice and soybeans.

And further to: citrus, kiwi, peaches, cucumbers, tomatoes, potatoes, wheat and soybeans.

A further preferred aspect of the present invention relates to the use of host defense inducers for controlling at least one of:

Acidovorax avenae and/or Burkholderia glumae in rice; Candidatus Liberibacter spec. and/or Xanthomonas axonopodis pv. citri in citrus; Corynebacterium in corn; Pseudomonas syringae pv. actinidae in Kiwi; Xanthomonas campestris in peaches, bananas and/or plantains; Xanthomonas axonopodis in pomegranate; Pseudomonas syringae pv. glycinea and/or Xanthomonas axonopodis in soybeans; Burkholderia spec. and/or Xanthomonas transluscens in cereals (preferably in wheat); Pseudomonas syringae, Pseudomonas syringae pv. tomato and/or Xanthomonas campestris in tomatoes; Pseudomonas syringae and/or Pseudomonas syringae pv. lachrymans in cucumbers; Erwinia carotovora, Erwinia carotovora subsp. atroseptica and/or Streptomyces scabies in potatoes; Erwinia carotovora in bananas and/or plantains.

Therein it is more preferred to use the host defense inducers for controlling at least one of: Acidovorax avenae and/or Burkholderia spec. (preferably Burkholderia glumae) in rice; Candidatus Liberibacter spec. and/or Xanthomonas axonopodis (preferably Xanthomonas axonopodis pv. citri) in citrus; Pseudomonas syringae (preferably Pseudomonas syringae pv. actinidae) in Kiwi; Xanthomonas campestris and/or Xanthomonas campestris pv. pruni in peaches; Pseudomonas syringae (preferably Pseudomonas syringae pv. glycinea) and/or Xanthomonas axonopodis (preferably Xanthomonas axonopodis pv. glycines (=Xanthomonas campestris pv. glycines) in soybeans; Burkholderia spec. and/or Xanthomonas transluscens in cereals; Pseudomonas syringae (preferably Pseudomonas syringae pv. tomato) and/or Xanthomonas campestris in tomatoes; Pseudomonas syringae and/or Pseudomonas syringae pv. lachrymans in cucumbers; as well as Erwinia atroseptica, Erwinia carotovora and/or Streptomyces scabies in potatoes.

Most preferred is to use the host defense inducers for controlling Burkholderia glumae in rice, Liberibacter spec. and/or Xanthomonas axonopodis pv. citri in citrus, Pseudomonas syringae pv. actinidiae (Psa) in kiwi, Pseudomonas syringae pv. glycinea and/or Xanthomonas axonopodis pv. glycines in soybeans, Pseudomonas syringae and/or Pseudomonas syringae pv. tomato in tomato and Xanthomonas campestris and/or Xanthomonas campestris pv. pruni in peaches, Pseudomonas syringae Pseudomonas syringae pv. lachrymans in cucumbers and/or Streptomyces scabies in potatoes.

Application Forms

The treatment according to the invention of the plants and plant parts with the active compound combinations or compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching), drip irrigating and, in the case of propagation material, in particular in the case of seeds, furthermore as a powder for dry seed treatment, a solution for seed treatment, a water-soluble powder for slurry treatment, by incrusting, by coating with one or more coats, etc. Preference is given to application by dipping, spraying, atomizing, irrigating, evaporating, dusting, fogging, broadcasting, foaming, painting, spreading-on, watering (drenching) and drip irrigating. Also encompassed by the present invention is nursery box treatment.

In an especially preferred embodiment of the present invention, host defense inducers or their formulations are used for application in the form of solutions, emulsions or suspensions to be applied by spraying, for the treatment of vegetative propagation material, or for rhizome or foliar application.

Depending on its respective physical and/or chemical properties, the selected host defense inducer can be converted into the customary formulations, such as solutions, emulsions, suspensions, powders, foams, pastes, granules, sachets, aerosols, microencapsulations in polymeric substances, and ULV cold- and hot-fogging formulations.

These formulations are prepared in a known manner, for example by mixing the host defense inducers with extenders, that is to say liquid solvents, pressurized liquefied gases and/or solid carriers, optionally with the use of surfactants, that is emulsifiers and/or dispersants and/or foam formers. If water is used as the extender, it is possible for example also to use organic solvents as cosolvents. Liquid solvents which are suitable in the main are: aromatics such as xylene, toluene or alkyl [symbol] inaphthalenes, chlorinated aromatics or chlorinated aliphatic hydrocarbons such as chlorobenzenes, chloroethylenes or methylene chloride, aliphatic hydrocarbons, such as cyclohexane or paraffins, for example mineral oil fractions, alcohols such as butanol or glycol, and their ethers and esters, ketones such as acetone, methyl ethyl ketone, methyl isobutyl ketone or cyclohexanone, strongly polar solvents such as dimethylformamide and di [symbol] me [symbol] thyl sulph [symbol] oxide, and water, and also mineral, animal and vegetable oils such as, for example, palm oil or other plant seed oils. Liquefied gaseous extenders or carriers are understood as meaning those liquids which are gaseous at normal temperature and under normal pressure, for example aerosol propellants such as halohydrocarbons and butane, propane, nitrogen and carbon dioxide.

Suitable solid carriers are: for example ground natural minerals such as kaolins, clays, talc, chalk, quartz, attapulgite, montmorillonite or diatomaceous earth, and ground synthetic minerals such as highly disperse silica, alumina and silicates. Suitable solid carriers for granules are: for example crushed and fractionated natural rocks such as calcite, pumice, marble, sepiolite, dolomite, and synthetic granules of inorganic and organic meals, and granules of organic material such as sawdust, coconut shells, maize cobs and tobacco stalks. Emulsifiers and/or foam formers which are suitable are: for example nonionic, cationic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, and protein hydrolysates. Suitable dispersants are: for example, lignosulphite waste liquors and methylcellulose.

Adhesives such as carboxymethylcellulose, natural and synthetic polymers in the form of powders, granules or latices, such as gum arabic, polyvinyl alcohol, polyvinyl acetate, and natural phospholipids such as cephalins and lecithins, and synthetic phospholipids, may be used in the formulations. Further additives may be mineral and vegetable oils.

It is possible to use colorants such as inorganic pigments, for example iron oxide, titanium oxide, Prussian Blue, and organic dyestuffs, such as alizarin, azo and metal phthalocyanine dyestuffs, and trace nutrients, such as salts of iron, manganese, boron, copper, cobalt, molybdenum and zinc.

In general, the formulations contain between 0.1 and 95% by weight of active compound (host defense inducer), preferably between 0.5 and 90%.

The control of the selected bacterial harmful organisms by treating the vegetative propagation material of plants has been known for a long time and is the subject of continuous improvements. However, the treatment of vegetative propagation material involves a series of problems which cannot always be solved in a satisfactory manner. Thus, it is desirable to develop methods for protecting the vegetative propagation material and the germinating plant which do away with, or at least markedly reduce, the additional application of plant protection products after planting or after emergence of the plants. It is furthermore desirable to optimize the amount of the active compound employed such that the vegetative propagation material and the germinating plant are protected the best possible from attack by the bacterial harmful organisms without, however, damaging the plant itself by the active compound employed. In particular, methods for the treatment of vegetative propagation material should also take into consideration the intrinsic properties of transgenic plants in order to achieve an optimal protection of the vegetative propagation material and the germinating plant while keeping the application rate of plant protection products as low as possible.

The present invention therefore relates in particular also to a method of protecting vegetative propagation material and germinating plants from attack by the selected bacterial harmful organisms, by treating the seed and the vegetative propagation material with a compound or formulation according to the invention.

The invention also relates to the use of the compounds according to the invention for the treatment of vegetative propagation material for protecting the vegetative propagation material and the germinating plant from the selected bacterial harmful organisms.

One of the advantages of the present invention is that, owing to the special systemic properties of the compounds according to the invention, the treatment of the vegetative propagation material with these compounds protects not only the vegetative propagation material itself, but also the plants which it gives rise to after planting, from the bacterial harmful organisms. In this manner, the immediate treatment of the crop at the time of planting, or shortly thereafter, can be dispensed with.

Another advantage is that the compounds according to the invention can be employed in particular also in transgenic vegetative propagation material.

The compounds according to the invention are suitable for protecting vegetative propagation material of any plant variety which is employed in agriculture, in the greenhouse, in forests or in horticulture. In particular, this is vegetative propagation material of the plants as defined and preferred herein.

Within the scope of the present invention, the compounds according to the invention are applied to the vegetative propagation material either alone or in a suitable formulation. Preferably, the vegetative propagation material is treated in a state in which it is sufficiently stable such that no damage occurs during the treatment. In general, the vegetative propagation material can be treated at any point in time between harvesting and planting out. Usually, vegetative propagation material is used which has been separated from the plant and freed from cobs, shells, stalks, coats, hairs or fruit flesh.

When treating the vegetative propagation material, care must be taken in general that the amount of the compound or formulation according to the invention, and/or of further additives, applied to the vegetative propagation material is chosen such that the germination of the vegetative propagation material is not adversely affected, or that the plant which it gives rise to is not damaged. This must be considered in particular in the case of active compounds which, at certain application rates, may have phytotoxic effects.

The compounds or formulations according to the invention can be applied directly, that is to say without containing further components and without having been diluted. In general, it is preferred to apply the compounds or formulations to the vegetative propagation material in the form of a suitable formulation. Suitable formulations and methods for the treatment of seed and of vegetative propagation material are known to the skilled worker.

The compounds or formulations which can be used in accordance with the invention can be converted into the customary formulations, such as solutions, emulsions, suspensions, powders, foams and ULV formulations.

These formulations are prepared in the known manner by mixing the host defense inducers with customary additives, such as, for example, customary extenders and also solvents or diluents, colorants, wetters, dispersants, emulsifiers, antifoams, preservatives, secondary thickeners, adhesives, gibberellins, mineral and vegetable oils, and also water.

Colorants which may be present in the formulations which can be used in accordance with the invention are all colorants which are customary for such purposes. In this context, both pigments, which are sparingly soluble in water, and dyes, which are soluble in water, may be used. Examples which may be mentioned are the colorants known by the names Rhodamin B, C.I. Pigment Red 112 and C.I. Solvent Red 1.

Wetters which may be present in the formulations which can be used in accordance with the invention are all substances which are customary for formulating agrochemical active compounds and which promote wetting. Alkylnaphthalenesulphonates, such as diisopropyl- or diisobutylnaphtha [symbol] lenesulphonates, may preferably be used.

Suitable dispersants and/or emulsifiers which may be present in the formulations which can be used in accordance with the invention are all nonionic, anionic and cationic dispersants which are conventionally used for the formulation of agrochemical active compounds. The following may be used by preference: nonionic or anionic dispersants or mixtures of nonionic or anionic dispersants. Suitable nonionic dispersants which may be mentioned are, in particular, ethylene oxide/propylene oxide block polymers, alkylphenol polyglycol ethers and tristyrylphenol polyglycol ethers and their phosphated or sulphated derivatives. Suitable anionic dispersants are, in particular, lignosulphonates, salts of polyacrylic acid, and arylsulphonate/formaldehyde condensates.

Antifoams which may be present in the formulations which can be used in accordance with the invention are all foam-inhibitor substances which are conventionally used for the formulation of agrochemical active compounds. Silicone antifoams and magnesium stearate may be used by preference.

Preservatives which may be present in the formulations which can be used in accordance with the invention are all substances which can be employed for such purposes in agrochemical compositions. Examples which may be mentioned are dichlorophene and benzyl alcohol hemiformal.

Secondary thickeners which may be present in the formulations which can be used in accordance with the invention are all substances which can be employed for such purposes in agrochemical compositions. Cellulose derivatives, acrylic acid derivatives, xanthan, modified clays and highly disperse silica are preferably suitable.

Adhesives which may be present in the formulations which can be used in accordance with the invention are all customary binders which can be used in mordants. Polyvinylpyrrolidone, polyvinyl acetate, polyvinyl alcohol and tylose may be mentioned by preference.

Gibberellins which may be present in the formulations which can be used in accordance with the invention are preferably Gibberellin A1, Gibberellin A3 (gibberellic acid), Gibberellin A4, Gibberellin A7. Especially preferred is gibberellic acid.

The gibberellins are known (cf. R. Wegler “Chemie der Pflanzenschutz- and Schädlingsbekämpfungsmittel” [Chemistry of plant protection and pesticide agents], volume 2, Springer Verlag, Berlin-Heidelberg-New York, 1970, pages 401-412).

The formulations which can be used in accordance with the invention can be employed, for the treatment of various types of seed, either directly or after previously having been diluted with water.

Thus, the concentrates or the preparations obtainable therefrom by dilution with water can be employed for dressing the seed. The formulations which can be used in accordance with the invention, or their diluted preparations, can also be employed for treating the vegetative propagation material of transgenic plants. Here, additional synergistic effects may also occur in combination with the substances formed by expression.

The application rate of the formulations which can be used in accordance with the invention can be varied within a substantial range. It depends on the respective active compound content in the formulations, and on the vegetative propagation material. As a rule, the application rates of active compound are between 0.001 and 50 g per kilogram of vegetative propagation material, preferably between 0.01 and 15 g per kilogram of vegetative propagation material.

Combinations/Formulations

The preferred host defense inducers of the present invention, (1.1) acibenzolar-S-methyl, (1.2) isotianil, (1.3) probenazole and (1.4) tiadinil can be employed as such or, in formulations, also in a combination with known bactericides, fungicides, acaricides, nematicides, herbicides, insecticides, micronutrients and micronutrient-containing compounds, safeners, lipochito-oligosaccharide compounds (LCO), soil-improvement products or products for reducing plant stress, for example Myconate, in order to widen the spectrum of action or to prevent the development of resistance, for example.

In the meaning of the invention, a lipochito-oligosaccharide (LCO) compound is a compound having the general LCO structure, i.e. an oligomeric backbone of β-1,4-linked N-acetyl-D-glucosamine residues with a N-linked fatty acyl chain at the non-reducing end, as described in U.S. Pat. No. 5,549,718; U.S. Pat. No. 5,646,018; U.S. Pat. No. 5,175,149; and U.S. Pat. No. 5,321,011. This basic structure may contain modifications or substitutions found in naturally occurring LCO's, such as those described in Spaink, Critical Reviews in Plant Sciences 54: 257-288, 2000; D'Haeze and Holsters, Glycobiology 12: 79R-105R, 2002. Naturally occurring LCO's are defined as compounds which can be found in nature. This basic structure may also contain modifications or substitutions which have not been found so far in naturally occurring LCO's. Examples of such analogs for which the conjugated amide bond is mimicked by a benzamide bond or which contain a function of benzylamine type are the following compounds of formula (I) which are described in WO 2005/063784 and WO 2008/071672, the content of which is incorporated herein by reference. The LCO's compounds may be isolated directly from a particular culture of Rhizobiaceae bacterial strains, synthesized chemically, or obtained chemo-enzymatically. Via the latter method, the oligosaccharide skeleton may be formed by culturing of recombinant bacterial strains, such as Escherichia coli, in a fermenter, and the lipid chain may then be attached chemically. LCO's used in embodiments of the invention may be recovered from natural Rhizobiaceae bacterial strains that produce LCO's, such as strains of Azorhizobium, Bradyrhizobium (including B. japonicum), Mesorhizobium, Rhizobium (including R. leguminosarum), Sinorhizobium (including S. meliloti), or from bacterial strains genetically engineered to produce LCO's. These methods are known in the art and have been described, for example, in U.S. Pat. Nos. 5,549,718 and 5,646,018, which are incorporated herein by reference. Hungria and Stacey (Soil Biol. Biochem. 29: 819-830, 1997) list specific LCO structures that are produced by different rhizobial species. LCO's may be utilized in various forms of purity and may be used alone or with rhizobia. Methods to provide only LCO's include simply removing the rhizobial cells from a mixture of LCOs and rhizobia, or continuing to isolate and purify the LCO molecules through LCO solvent phase separation followed by HPLC chromatography as described by Lerouge, et.al (U.S. Pat. No. 5,549,718). Purification can be enhanced by repeated HPLC, and the purifed LCO molecules can be freeze-dried for long-term storage. This method is acceptable for the production of LCO's from all genera and species of the Rhizobiaceae. Commercial products containing LCO's are available, such as OPTIMIZE® (EMD Crop BioScience). LCO compounds, which can be identical or not to naturally occurring LCO's, may also be obtained by chemical synthesis and/or through genetic engineering. Synthesis of precursor oligosaccharide molecules for the construction of LCO by genetically engineered organisms is disclosed in Samain et al., Carbohydrate Research 302: 35-42, 1997.

Preparation of numerous LCOs compounds wherein the oligosaccharide skeleton is obtained by culturing recombinant bacterial strains, such as recombinant Escherichia coli cells harboring heterologous gene from rhizobia, and wherein the lipid chain is chemically attached is disclosed in WO 2005/063784 and WO 2008/07167, the content of which is incorporated herein by reference. Examples of lipochito-oligosaccharide compounds include, but are not limited to LCO compounds specifically disclosed in WO 2010/125065.

Preferably the host defense inducers are present in a composition comprising at least one further compound selected from the group consisting of bactericides, antibiotics, fungicides, insecticides, herbicides, micronutrients and micronutrient-containing compounds, and lipochito-oligosaccharide compounds (LCO). Preferably, this at least one further compound is selected from the group consisting of:

Antibiotics such as kasugamycin, streptomycin, oxytetracyclin, validamycin, gentamycin, aureofungin, blasticidin-S, cycloheximide, griseofulvin, moroxydine, natamycin, polyoxins, polyoxorim and combinations thereof.

Fungicides:

(1) Inhibitors of the ergosterol biosynthesis, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifine, nuarimol, oxpoconazole, paclobutrazol, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}imidoformamide and O-[1-(4-methoxyphenoxy)-3,3-dimethylbutan-2-yl]1H-imidazole-1-carbothioate.

(2) inhibitors of the respiratory chain at complex I or II, for example bixafen, boscalid, carboxin, diflumetorim, fenfuram, fluopyram, flutolanil, fluxapyroxad, furametpyr, furmecyclox, isopyrazam (mixture of syn-epimeric racemate 1RS,4SR,9RS and anti-epimeric racemate 1RS,4SR,9SR), isopyrazam (anti-epimeric racemate 1RS,4SR,9SR), isopyrazam (anti-epimeric enantiomer 1R,4S,9S), isopyrazam (anti-epimeric enantiomer 1S,4R,9R), isopyrazam (syn epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamide, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[4-(2,4-dichlorophenyl)-1-methoxypropan-2-yl]-3-(difluoromethyl)-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazolin-4-amine, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.

(3) inhibitors of the respiratory chain at complex III, for example ametoctradin, amisulbrom, azoxystrobin, cyazofamid, coumethoxystrobin, coumoxystrobin, dimoxystrobin, enestroburin, famoxadone, fenamidone, fenoxystrobin, fluoxastrobin, kresoxim-methyl, metominostrobin, orysastrobin, picoxystrobin, pyraclostrobin, pyrametostrobin, pyraoxystrobin, pyribencarb, triclopyricarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, methyl (2E)-2-{2-[({cyclopropyl[(4-methoxyphenyl)imino]methyl}sulfanyl)methyl]phenyl}-3-methoxyprop-2-enoate, N-(3-ethyl-3,5,5-trimethylcyclohexyl)-3-(formylamino)-2-hydroxybenzamide, 2-{2-[(2,5-dimethylphenoxy)methyl]phenyl}-2-methoxy-N-methylacetamide and (2R)-2-{2-[(2,5-dimethylphenoxy)methyl]phenyl}-2-methoxy-N-methylacetamide.

(4) Inhibitors of the mitosis and cell division, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine and 3-chloro-5-(6-chloropyridin-3-yl)-6-methyl-4-(2,4,6-trifluorophenyl)pyridazine.

(5) Compounds capable to have a multisite action, for example bordeaux mixture, captafol, captan, chlorothalonil, copper hydroxide, copper naphthenate, copper oxide, copper oxychloride, copper(2+) sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulphur and sulphur preparations including calcium polysulphide, thiram, tolylfluanid, zineb and ziram.

(6) Compounds capable to induce a host defence, for example acibenzolar-S-methyl, isotianil, probenazole and tiadinil.

(7) Inhibitors of the amino acid and/or protein biosynthesis, for example andoprim, blasticidin-S, cyprodinil, kasugamycin, kasugamycin hydrochloride hydrate, mepanipyrim, pyrimethanil and 3-(5-fluoro-3,3,4,4-tetramethyl-3,4-dihydroisoquinolin-1-yl)quinoline.

(8) Inhibitors of the ATP production, for example fentin acetate, fentin chloride, fentin hydroxide and silthiofam.

(9) Inhibitors of the cell wall synthesis, for example benthiavalicarb, dimethomorph, flumorph, iprovalicarb, mandipropamid, polyoxins, polyoxorim, validamycin A and valifenalate.

(10) Inhibitors of the lipid and membrane synthesis, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.

(11) Inhibitors of the melanine biosynthesis, for example carpropamid, diclocymet, fenoxanil, phthalide, pyroquilon, tricyclazole and 2,2,2-trifluoroethyl{3-methyl-1-[(4-methylbenzoyl)amino]butan-2-yl}carbamate.

(12) Inhibitors of the nucleic acid synthesis, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.

(13) Inhibitors of the signal transduction, for example chlozolinate, fenpiclonil, fludioxonil, iprodione, procymidone, quinoxyfen and vinclozolin.

(14) Compounds capable to act as an uncoupler, for example binapacryl, dinocap, ferimzone, fluazinam and meptyldinocap.

(15) Further compounds, for example benthiazole, bethoxazin, capsimycin, carvone, chinomethionat, pyriofenone (chlazafenone), cufraneb, cyflufenamid, cymoxanil, cyprosulfamide, dazomet, debacarb, dichlorophen, diclomezine, difenzoquat, difenzoquat methylsulphate, diphenylamine, ecomate, fenpyrazamine, flumetover, fluoroimide, flusulfamide, flutianil, fosetyl-aluminium, fosetyl-calcium, fosetyl-sodium, hexachlorobenzene, irumamycin, methasulfocarb, methyl isothiocyanate, metrafenone, mildiomycin, natamycin, nickel dimethyldithiocarbamate, nitrothal-isopropyl, octhilinone, oxamocarb, oxyfenthiin, pentachlorophenol and salts, phenothrin, phosphorous acid and its salts, propamocarb-fosetylate, propanosine-sodium, proquinazid, pyrimorph, (2E)-3-(4-tert-butylphenyl)-3-(2-chloropyridin-4-yl)-1-(morpholin-4-yl)prop-2-en-1-one, (2Z)-3-(4-tert-butylphenyl)-3-(2-chloropyridin-4-yl)-1-(morpholin-4-yl)prop-2-en-1-one, pyrroInitrine, tebufloquin, tecloftalam, tolnifanide, triazoxide, trichlamide, zarilamid, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulfonyl)pyridine, 2,3-dibutyl-6-chlorothieno[2,3-d]pyrimidin-4(3H)-one, 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts, 3-(4,4,5-trifluoro-3,3-dimethyl-3,4-dihydroisoquinolin-1-yl)quinoline, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulfonohydrazide, 5-fluoro-2-[(4-fluorobenzyl)oxy]pyrimidin-4-amine, 5-fluoro-2-[(4-methylbenzyl)oxy]pyrimidin-4-amine, 5-methyl-6-octyl[1,2,4]triazolo[1,5-a]pyrimidin-7-amine, ethyl (2Z)-3-amino-2-cyano-3-phenylprop-2-enoate, N′-(4-{[3-(4-chlorobenzyl)-1,2,4-thiadiazol-5-yl]oxy}-2,5-dimethylphenyl)-N-ethyl-N-methylimidoformamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N-{(Z)-[(cyclopropylmethoxy)imino][6-(difluoromethoxy)-2,3-difluorophenyl]methyl}-2-phenylacetamide, N′-{4-[(3-tert-butyl-4-cyano-1,2-thiazol-5-yl)oxy]-2-chloro-5-methylphenyl}-N-ethyl-N-methylimidoformamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl}carbamate, phenazine-1-carboxylic acid, quinolin-8-ol, quinolin-8-ol sulfate (2:1) and tert-butyl {6-[({[(1-methyl-1H-tetrazol-5-yl)(phenyl)methylene]amino}oxy)methyl]pyridin-2-yl}carbamate.

(16) Further compounds, for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)(2,3,4-trimethoxy-6-methylphenyl)methanone, N-[2-(4-{[3-(4-chlorophenyl)prop-2-yn-1-yl]oxy}-3-methoxyphenyl)ethyl]-N2-(methylsulfonyl)valinamide, 4-oxo-4-[(2-phenylethyl)amino]butanoic acid and but-3-yn-1-yl{6-[({[(Z)-(1-methyl-1H-tetrazol-5-yl) (phenyl)methylene]amino}oxy)methyl]pyridin-2-yl}carbamate, and combinations thereof.

Insecticides, Acaricides, and Nematicides:

(1) Acetylcholinesterase (AChE) inhibitors, for example carbamates, e.g. Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, and Xylylcarb; or organophosphates, e.g. Acephate, Azamethiphos, Azinphos-ethyl, Azinphos-methyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, and Vamidothion.

(2) GABA-gated chloride channel antagonists, for example cyclodiene organochlorines, e.g. Chlordane and Endosulfan; or phenylpyrazoles (fiproles), e.g. Ethiprole and Fipronil.

(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin, and Transfluthrin; or DDT; or Methoxychlor.

(4) Nicotinic acetylcholine receptor (nAChR) agonists, for example neonicotinoids, e.g. Acetamiprid, Clothianidin, Dinotefuran, Imidacloprid, Nitenpyram, Thiacloprid, and Thiamethoxam; or Nicotine.

(5) Nicotinic acetylcholine receptor (nAChR) allosteric activators, for example spinosyns, e.g. Spinetoram and Spinosad.

(6) Chloride channel activators, for example avermectins/milbemycins, e.g. Abamectin, Emamectin benzoate, Lepimectin, and Milbemectin.

(7) Juvenile hormone mimics, for example juvenile hormon analogues, e.g. Hydroprene, Kinoprene, and Methoprene; or Fenoxycarb; or Pyriproxyfen.

(8) Miscellaneous non-specific (multi-site) inhibitors, for example alkyl halides, e.g. Methyl bromide and other alkyl halides; or Chloropicrin; or Sulfuryl fluoride; or Borax; or Tartar emetic.

(9) Selective homopteran feeding blockers, e.g. Pymetrozine; or Flonicamid.

(10) Mite growth inhibitors, e.g. Clofentezine, Hexythiazox, and Diflovidazin; or Etoxazole.

(11) Microbial disruptors of insect midgut membranes, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT crop proteins: Cry1Ab, Cry1Ac, Cry1Fa, Cry2Ab, mCry3A, Cry3Ab, Cry3Bb, Cry34/35Ab1.

(12) Inhibitors of mitochondrial ATP synthase, for example Diafenthiuron; or organotin miticides, e.g. Azocyclotin, Cyhexatin, and Fenbutatin oxide; or Propargite; or Tetradifon.

(13) Uncouplers of oxidative phoshorylation via disruption of the proton gradient, for example Chlorfenapyr, DNOC, and Sulfluramid.

(14) Nicotinic acetylcholine receptor (nAChR) channel blockers, for example Bensultap, Cartap hydrochloride, Thiocyclam, and Thiosultap-sodium.

(15) Inhibitors of chitin biosynthesis, type 0, for example Bistrifluoron, Chlorfluazuron, Diflubenzuron, Flucycloxuron, Flufenoxuron, Hexaflumuron, Lufenuron, Novaluron, Noviflumuron, Teflubenzuron, and Triflumuron.

(16) Inhibitors of chitin biosynthesis, type 1, for example Buprofezin.

(17) Moulting disruptors, for example Cyromazine.

(18) Ecdysone receptor agonists, for example Chromafenozide, Halofenozide, Methoxyfenozide, and Tebufenozide.

(19) Octopamine receptor agonists, for example Amitraz.

(20) Mitochondrial complex III electron transport inhibitors, for example Hydramethylnon; or Acequinocyl; or Fluacrypyrim.

(21) Mitochondrial complex I electron transport inhibitors, for example METI acaricides, e.g. Fenazaquin, Fenpyroximate, Pyrimidifen, Pyridaben, Tebufenpyrad, and Tolfenpyrad; or Rotenone (Derris).

(22) Voltage-dependent sodium channel blockers, e.g. Indoxacarb; or Metaflumizone.

(23) Inhibitors of acetyl CoA carboxylase, for example tetronic and tetramic acid derivatives, e.g. Spirodiclofen, Spiromesifen, and Spirotetramat.

(24) Mitochondrial complex IV electron transport inhibitors, for example phosphines, e.g. Aluminium phosphide, Calcium phosphide, Phosphine, and Zinc phosphide; or Cyanide.

(25) Mitochondrial complex II electron transport inhibitors, for example Cyenopyrafen.

(28) Ryanodine receptor modulators, for example diamides, e.g. Chlorantraniliprole and Flubendiamide.

Further active ingredients with unknown or uncertain mode of action, for example Amidoflumet, Azadirachtin, Benclothiaz, Benzoximate, Bifenazate, Bromopropylate, Chinomethionat, Cryolite, Cyantraniliprole (Cyazypyr), Cyflumetofen, Dicofol, Diflovidazin, Fluensulfone, Flufenerim, Flufiprole, Fluopyram, Fufenozide, Imidaclothiz, Iprodione, Meperfluthrin, Pyridalyl, Pyrifluquinazon, Tetramethylfluthrin, and iodomethane; furthermore products based on Bacillus firmus (including but not limited to strain CNCM 1-1582, such as, for example, VOTiVO™, BioNem) or one of the following known active compounds: 3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934), 4-{[(6-bromopyridin-3-yl)methyl](2-fluoroethyl)amino}furan-2(5H)-one (known from WO2007/115644), 4-{[(6-fluoropyridin-3-yl)methyl] (2,2-difluoroethyl)amino}furan-2(5H)-one (known from WO2007/115644), 4-{[(2-chloro-1,3-thiazol-5-yl)methyl](2-fluoroethyl)amino}furan-2(5H)-one (known from WO2007/115644), 4-{[(6-chlorpyridin-3-yl)methyl] (2-fluoroethyl)amino}furan-2(5H)-one (known from WO2007/115644), Flupyradifurone, 4-{[(6-chlor-5-fluoropyridin-3-yl)methyl](methyl)amino}furan-2(5H)-one (known from WO2007/115643), 4-{[(5,6-dichloropyridin-3-yl)methyl](2-fluoroethyl)amino}furan-2(5H)-one (known from WO2007/115646), 4-{[(6-chloro-5-fluoropyridin-3-yl)methyl](cyclopropyl)amino}furan-2(5H)-one (known from WO2007/115643), 4-{[(6-chloropyridin-3-yl)methyl](cyclopropyl)amino}furan-2(5H)-one (known from EP-A-0 539 588), 4-{[(6-chlorpyridin-3-yl)methyl](methyl)amino}furan-2(5H)-one (known from EP-A-0 539 588), {[1-(6-chloropyridin-3-yl)ethyl](methyl)oxido-λ4-sulfanylidene}cyanamide (known from WO2007/149134) and its diastereomers {[(1R)-1-(6-chloropyridin-3-yl)ethyl](methyl)oxido-λ4-sulfanylidene}cyanamide (A) and {[(1S)-1-(6-chloropyridin-3-yl)ethyl](methyl)oxido-λ4-sulfanylidene}cyanamide (B) (also known from WO2007/149134) as well as Sulfoxaflor and its diastereomers [(R)-methyl(oxido){(1R)-1-[6-(trifluoromethyl)pyridin-3-yl]ethyl}-λ4-sulfanylidene]cyanamide (A1) and [(S)-methyl(oxido) {(1S)-1-[6-(trifluoromethyl)pyridin-3-yl]ethyl}-λ4-sulfanylidene]cyanamide (A2), referred to as group of diastereomers A (known from WO2010/074747, WO2010/074751), [(R)-methyl(oxido){(1S)-1-[6-(trifluoromethyl)pyridin-3-yl]ethyl}-λ4-sulfanylidene]cyanamide (B1) and [(S)-methyl(oxido){(1R)-1-[6-(trifluoromethyl)pyridin-3-yl]ethyl}-λ4-sulfanylidene]cyanamide (B2), referred to as group of diastereomers B (also known from WO2010/074747, WO2010/074751), and 11-(4-chloro-2,6-dimethylphenyl)-12-hydroxy-1,4-dioxa-9-azadispiro[4.2.4.2]tetradec-11-en-10-one (known from WO2006/089633), 3-(4′-fluoro-2,4-dimethylbiphenyl-3-yl)-4-hydroxy-8-oxa-1-azaspiro[4.5]dec-3-en-2-one (known from WO2008/067911), 1-{2-fluoro-4-methyl-5-[(2,2,2-trifluorethyl)sulfinyl]phenyl}-3-(trifluoromethyl)-1H-1,2,4-triazol-5-amine (known from WO2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (known from WO2008/066153), 2-cyano-3-(difluoromethoxy)-N,N-dimethylbenzenesulfonamide (known from WO2006/056433), 2-cyano-3-(difluoromethoxy)-N-methylbenzenesulfonamide (known from WO2006/100288), 2-cyano-3-(difluoromethoxy)-N-ethylbenzenesulfonamide (known from WO2005/035486), 4-(difluoromethoxy)-N-ethyl-N-methyl-1,2-benzothiazol-3-amine 1,1-dioxide (known from WO2007/057407), N-[1-(2,3-dimethylphenyl)-2-(3,5-dimethylphenyl)ethyl]-4,5-dihydro-1,3-thiazol-2-amine (known from WO2008/104503), {1′-[(2E)-3-(4-chlorophenyl)prop-2-en-1-yl]-5-fluorospiro[indole-3,4′-piperidin]-1(2H)-yl}(2-chloropyridin-4-yl)methanone (known from WO2003/106457), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-yl ethyl carbonate (known from WO2009/049851), 4-(but-2-yn-1-yloxy)-6-(3,5-dimethylpiperidin-1-yl)-5-fluoropyrimidine (known from WO2004/099160), (2,2,3,3,4,4,5,5-octafluoropentyl)(3,3,3-trifluoropropyl)malononitrile (known from WO2005/063094), (2,2,3,3,4,4,5,5-octafluoropentyl)(3,3,4,4,4-pentafluorobutyl)malononitrile (known from WO2005/063094), 8-[2-(cyclopropylmethoxy)-4-(trifluoromethyl)phenoxy]-3-[6-(trifluoromethyl)pyridazin-3-yl]-3-azabicyclo[3.2.1]octane (known from WO2007/040280), Flometoquin, PF1364 (CAS-Reg. No. 1204776-60-2) (known from JP2010/018586), 5-[5-(3,5-dichlorophenyl)-5-(trifluoromethyl)-4,5-dihydro-1,2-oxazol-3-yl]-2-(1H-1,2,4-triazol-1-yl)benzonitrile (known from WO2007/075459), 5-[5-(2-chloropyridin-4-yl)-5-(trifluoromethyl)-4,5-dihydro-1,2-oxazol-3-yl]-2-(1H-1,2,4-triazol-1-yl)benzonitrile (known from WO2007/075459), 4-[5-(3,5-dichlorophenyl)-5-(trifluoromethyl)-4,5-dihydro-1,2-oxazol-3-yl]-2-methyl-N-{2-oxo-2-[(2,2,2-trifluoroethyl)amino]ethyl}benzamide (known from WO2005/085216), 4-{[(6-chloropyridin-3-yl)methyl](cyclopropyl)amino}-1,3-oxazol-2(5H)-one, 4-{[(6-chloropyridin-3-yl)methyl](2,2-difluoroethyl)amino}-1,3-oxazol-2(5H)-one, 4-{[(6-chloropyridin-3-yl)methyl](ethyl)amino}-1,3-oxazol-2(5H)-one, 4-{[(6-chloropyridin-3-yl)methyl](methyl)amino}-1,3-oxazol-2(5H)-one (all known from WO2010/005692), NNI-0711 (known from WO2002/096882), 1-acetyl-N-[4-(1,1,1,3,3,3-hexafluoro-2-methoxypropan-2-yl)-3-isobutylphenyl]-N-isobutyryl-3,5-dimethyl-1H-pyrazole-4-carboxamide (known from WO2002/096882), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-1,2-diethylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO2005/085216), (5RS,7RS;5RS,7SR)-1-(6-chloro-3-pyridylmethyl)-1,2,3,5,6,7-hexahydro-7-methyl-8-nitro-5-propoxyimidazo[1,2-a]pyridine (known from WO2007/101369), 2-{6-[2-(5-fluoropyridin-3-yl)-1,3-thiazol-5-yl]pyridin-2-yl}pyrimidine (known from WO2010/006713), 2-{6-[2-(pyridin-3-yl)-1,3-thiazol-5-yl]pyridin-2-yl}pyrimidine (known from WO2010/006713), 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide (known from WO2010/069502), 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide (known from WO2010/069502), N-[2-(tert-butylcarbamoyl)-4-cyano-6-methylphenyl]-1-(3-chloropyridin-2-yl)-3-{[5-(trifluoromethyl)-1H-tetrazol-1-yl]methyl}-1H-pyrazole-5-carboxamide (known from WO2010/069502), N-[2-(tert-butylcarbamoyl)-4-cyano-6-methylphenyl]-1-(3-chloropyridin-2-yl)-3-{[5-(trifluoromethyl)-2H-tetrazol-2-yl]methyl}-1H-pyrazole-5-carboxamide (known from WO2010/069502), (1E)-N-[(6-chloropyridin-3-yl)methyl]-N′-cyano-N-(2,2-difluoroethyl)ethanimidamide (known from WO2008/009360), N-[2-(5-amino-1,3,4-thiadiazol-2-yl)-4-chloro-6-methylphenyl]-3-bromo-1-(3-chloropyridin-2-yl)-1H-pyrazole-5-carboxamide (known from CN102057925), and methyl 2-[3,5-dibromo-2-({[3-bromo-1-(3-chloropyridin-2-yl)-1H-pyrazol-5-yl]carbonyl}amino)benzoyl]-2-ethyl-1-methylhydrazinecarboxylate (known from WO2011/049233), and combinations thereof.

Preferred combination partners from the group of insecticides are imidacloprid and spirotetramate.

Micronutrients and micronutrient-containing compounds:

In context of the present invention micronutrients and micronutrient-containing compounds relates to compounds selected from the group consisting of active ingredients containing at least one metal ion selected from the group consisting of zinc, manganese, molybdenum, iron and copper or the micronutrient boron. More preferably these micronutrients and micronutrient-containing compounds are selected from the group consisting of the zinc containing compounds Propineb, Polyoxin Z (zinc salt), Zineb, Ziram, zinc thiodazole, zinc naphthenate and Mancozeb (also containing manganese), the manganese containing compounds Maneb, Metiram and Mancopper (also containing copper), the iron containing compound Ferbam, copper (Cu) and the copper containing compounds Bordeaux mixture, Burgundy mixture, Cheshunt mixture, copper oxychloride, copper sulphate, basic copper sulphate (e.g. tribasic copper sulphate), copper oxide, copper octanoate, copper hydroxide, oxine-copper, copper ammonium acetate, copper naphthenate, chelated copper (e.g. as amino acid chelates), mancopper, acypetacs-copper, copper acetate, basic copper carbonate, copper oleate, copper silicate, copper zinc chromate, cufraneb, cuprobam, saisentong, and thiodiazole-copper, and combinations thereof.

More preferably the micronutrients and micronutrient-containing compounds are selected from the group consisting of (4.1) copper (Cu), (4.2) copper-hydroxyde, (4.3) copper-sulphate, (4.4) copper-oxychloride, (4.5) Propineb and (4.6) Mancozeb. Even more preferably the micronutrients and micronutrient-containing compounds are selected from the group consisting of (4.2) copper-hydroxyde, (4.3) copper-sulphate, and (4.5) Propineb.

Lipochito-oligosaccharide compounds (LCO) (5).

A preferred combination partner from the group of fungicides is (2.1) fosetyl-Al (fosetyl-aluminium). A further preferred combination partner from the group of fungicides is (2.2) penflufen.

Further preferred combination partners from the group of fungicides are selected from strobilurins, fungicides belonging to the group of inhibitors of the respiratory chain at complex III, for example (3.1) ametoctradin, (3.2) amisulbrom, (3.3) azoxystrobin, (3.4) cyazofamid, (3.5) coumethoxystrobin, (3.6) coumoxystrobin, (3.7) dimoxystrobin, (3.8) enestroburin (WO 2004/058723), (3.9) famoxadone (WO 2004/058723), (3.10) fenamidone (WO 2004/058723), (3.11) fenoxystrobin, (3.12) fluoxastrobin (WO 2004/058723), (3.13) kresoxim-methyl (WO 2004/058723), (3.14) metominostrobin (WO 2004/058723), (3.15) orysastrobin (WO 2004/058723), (3.16) picoxystrobin (WO 2004/058723), (3.17) pyraclostrobin (WO 2004/058723), (3.18) pyrametostrobin (WO 2004/058723), (3.19) pyraoxystrobin (WO 2004/058723), (3.20) pyribencarb (WO 2004/058723), (3.21) triclopyricarb, (3.22) trifloxystrobin (WO 2004/058723), (3.23) (2E)-2-(2-{[6-(3-chloro-2-methylphenoxy)-5-fluoropyrimidin-4-yl]oxy}phenyl)-2-(methoxyimino)-N-methylethanamide (WO 2004/058723), (3.24) (2E)-2-(methoxyimino)-N-methyl-2-(2-{[({(1E)-1-[3-(trifluoromethyl)phenyl]ethylidene}amino)oxy]methyl}phenyl)ethanamide (WO 2004/058723), (3.25) (2E)-2-(methoxyimino)-N-methyl-2-{2-[(E)-({1-[3-(trifluoromethyl)phenyl]ethoxy}imino)methyl]phenyl}ethanamide (158169-73-4), (3.26) (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide (326896-28-0), (3.27) (2E)-2-{2-[({[(2E,3E)-4-(2,6-dichlorophenyl)but-3-en-2-ylidene]amino}oxy)methyl]phenyl}-2-(methoxyimino)-N-methylethanamide, (3.28) 2-chloro-N-(1,1,3-trimethyl-2,3-dihydro-1H-inden-4-yl)pyridine-3-carboxamide (119899-14-8), (3.29) 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (3.30) methyl (2E)-2-{2-[({cyclopropyl[(4-methoxyphenyl)imino]methyl}sulfanyl)methyl]phenyl}-3-methoxyprop-2-enoate, (3.31) N-(3-ethyl-3,5,5-trimethylcyclohexyl)-3-(formylamino)-2-hydroxybenzamide, (3.32) 2-{2-[(2,5-dimethylphenoxy)methyl]phenyl}-2-methoxy-N-methylacetamide and (3.33) (2R)-2-{2-[(2,5-dimethylphenoxy)methyl]phenyl}-2-methoxy-N-methylacetamide. According to a more preferred embodiment of the present invention, the combination partners from the group of strobilurin fungicides is selected from (3.3) azoxystrobin and (3.22) trifloxystrobin.

A preferred combination partner from the group of antibiotics is selected from the group consisting of (6.1) kasugamycin, (6.2) streptomycin, and (6.3) oxytetracyclin.

According to the present invention, preference is given to the following binary combinations selected from the group consisting of:

(1.1)+(2.1), (1.2)+(2.1), (1.3)+(2.1), (1.4)+(2.1),

(1.1)+(2.2), (1.2)+(2.2), (1.3)+(2.2), (1.4)+(2.2),

(1.1)+(3.1), (1.1)+(3.2), (1.1)+(3.3), (1.1)+(3.4), (1.1)+(3.5), (1.1)+(3.6), (1.1)+(3.7), (1.1)+(3.8), (1.1)+(3.9), (1.1)+(3.10), (1.1)+(3.11), (1.1)+(3.12), (1.1)+(3.13), (1.1)+(3.14), (1.1)+(3.15), (1.1)+(3.16), (1.1)+(3.17), (1.1)+(3.18), (1.1)+(3.19), (1.1)+(3.20), (1.1)+(3.21), (1.1)+(3.22), (1.1)+(3.23), (1.1)+(3.24), (1.1)+(3.25), (1.1)+(3.26), (1.1)+(3.27), (1.1)+(3.28), (1.1)+(3.29), (1.1)+(3.30), (1.1)+(3.31), (1.1)+(3.32), (1.1)+(3.33),

(1.2)+(3.1), (1.2)+(3.2), (1.2)+(3.3), (1.2)+(3.4), (1.2)+(3.5), (1.2)+(3.6), (1.2)+(3.7), (1.2)+(3.8), (1.2)+(3.9), (1.2)+(3.10), (1.2)+(3.11), (1.2)+(3.12), (1.2)+(3.13), (1.2)+(3.14), (1.2)+(3.15), (1.2)+(3.16), (1.2)+(3.17), (1.2)+(3.18), (1.2)+(3.19), (1.2)+(3.20), (1.2)+(3.21), (1.2)+(3.22), (1.2)+(3.23), (1.2)+(3.24), (1.2)+(3.25), (1.2)+(3.26), (1.2)+(3.27), (1.2)+(3.28), (1.2)+(3.29), (1.2)+(3.30), (1.2)+(3.31), (1.2)+(3.32), (1.2)+(3.33),

(1.3)+(3.1), (1.3)+(3.2), (1.3)+(3.3), (1.3)+(3.4), (1.3)+(3.5), (1.3)+(3.6), (1.3)+(3.7), (1.3)+(3.8), (1.3)+(3.9), (1.3)+(3.10), (1.3)+(3.11), (1.3)+(3.12), (1.3)+(3.13), (1.3)+(3.14), (1.3)+(3.15), (1.3)+(3.16), (1.3)+(3.17), (1.3)+(3.18), (1.3)+(3.19), (1.3)+(3.20), (1.3)+(3.21), (1.3)+(3.22), (1.3)+(3.23), (1.3)+(3.24), (1.3)+(3.25), (1.3)+(3.26), (1.3)+(3.27), (1.3)+(3.28), (1.3)+(3.29), (1.3)+(3.30), (1.3)+(3.31), (1.3)+(3.32), (1.3)+(3.33),

(1.4)+(3.1), (1.4)+(3.2), (1.4)+(3.3), (1.4)+(3.4), (1.4)+(3.5), (1.4)+(3.6), (1.4)+(3.7), (1.4)+(3.8), (1.4)+(3.9), (1.4)+(3.10), (1.4)+(3.11), (1.4)+(3.12), (1.4)+(3.13), (1.4)+(3.14), (1.4)+(3.15), (1.4)+(3.16), (1.4)+(3.17), (1.4)+(3.18), (1.4)+(3.19), (1.4)+(3.20), (1.4)+(3.21), (1.4)+(3.22), (1.4)+(3.23), (1.4)+(3.24), (1.4)+(3.25), (1.4)+(3.26), (1.4)+(3.27), (1.4)+(3.28), (1.4)+(3.29), (1.4)+(3.30), (1.4)+(3.31), (1.4)+(3.32), (1.4)+(3.33),

(1.1)+(4.1), (1.1)+(4.2), (1.1)+(4.3), (1.2)+(4.1), (1.2)+(4.2), (1.2)+(4.3), (1.3)+(4.1), (1.3)+(4.2), (1.3)+(4.3), (1.4)+(4.1), (1.4)+(4.2), (1.4)+(4.3), (1.1)+(4.4), (1.1)+(4.5), (1.1)+(4.6), (1.2)+(4.4), (1.2)+(4.5), (1.2)+(4.6), (1.3)+(4.4), (1.3)+(4.5), (1.3)+(4.6), (1.4)+(4.4), (1.4)+(4.5), (1.4)+(4.6),

(1.1)+(5), (1.2)+(5), (1.3)+(5), (1.4)+(5),

(1.1)+(6.1), (1.1)+(6.2), (1.1)+(6.3), (1.2)+(6.1), (1.2)+(6.2), (1.2)+(6.3), (1.3)+(6.1), (1.3)+(6.2), (1.3)+(6.3), (1.4)+(6.1), (1.4)+(6.2), (1.4)+(6.3).

Out of these the following combinations are even further preferred:

(1.1)+(2.1), (1.2)+(2.1), (1.3)+(2.1), (1.4)+(2.1), (1.1)+(2.2), (1.2)+(2.2), (1.3)+(2.2), (1.4)+(2.2), (1.1)+(3.3), (1.1)+(3.22), (1.2)+(3.3), (1.2)+(3.22), (1.3)+(3.3), (1.3)+(3.22), (1.4)+(3.3), (1.4)+(3.22), (1.1)+(4.2), (1.2)+(4.2), (1.3)+(4.2), (1.4)+(4.2), (1.1)+(4.3), (1.2)+(4.3), (1.3)+(4.3), (1.4)+(4.3), (1.1)+(4.5), (1.2)+(4.5), (1.3)+(4.5), (1.4)+(4.5), (1.1)+(5), (1.2)+(5), (1.3)+(5), (1.4)+(5), (1.1)+(6.1), (1.2)+(6.1), (1.3)+(6.1), (1.4)+(6.1), (1.1)+(6.2), (1.2)+(6.2), (1.3)+(6.2), (1.4)+(6.2), (1.1)+(6.3), (1.2)+(6.3), (1.3)+(6.3), (1.4)+(6.3).

Out of these the following combinations are even further preferred:

(1.1)+(2.1), (1.2)+(2.1), (1.1)+(2.2), (1.2)+(2.2), (1.1)+(3.3), (1.1)+(3.22), (1.2)+(3.3), (1.2)+(3.22), (1.1)+(4.2), (1.2)+(4.2), (1.1)+(4.3), (1.2)+(4.3), (1.1)+(4.5), (1.2)+(4.5), (1.1)+(5), (1.2)+(5), (1.1)+(6.1), (1.2)+(6.1), (1.1)+(6.2), (1.2)+(6.2), (1.1)+(6.3), (1.2)+(6.3).

Most preference is given to the following combinations:

(1.2)+(2.1), (1.2)+(2.2), (1.2)+(3.3), (1.2)+(3.22), (1.2)+(4.2), (1.2)+(4.3), (1.2)+(4.5), (1.2)+(5), (1.2)+(6.1), (1.2)+(6.2), (1.2)+(6.3).

There from the combination (1.2)+(2.1) is even most preferred.

All binary combinations mentioned above can be combined with at least one further known bactericide, antibiotic, fungicide, acaricide, nematicide, herbicide, insecticide, micronutrients and micronutrient-containing compound, safener, lipochito-oligosaccharides (LCO), soil-improvement product or product for reducing plant stress, for example Myconate, in order to widen the spectrum of action or to prevent the development of resistance, for example.

According to the present invention, preference is given to the following ternary combinations selected from the group consisting of:

(1.1)+(2.1)+(3.1), (1.1)+(2.1)+(3.2), (1.1)+(2.1)+(3.3), (1.1)+(2.1)+(3.4), (1.1)+(2.1)+(3.5), (1.1)+(2.1)+(3.6), (1.1)+(2.1)+(3.7), (1.1)+(2.1)+(3.8), (1.1)+(2.1)+(3.9), (1.1)+(2.1)+(3.10), (1.1)+(2.1)+(3.11), (1.1)+(2.1)+(3.12), (1.1)+(2.1)+(3.13), (1.1)+(2.1)+(3.14), (1.1)+(2.1)+(3.15), (1.1)+(2.1)+(3.16), (1.1)+(2.1)+(3.17), (1.1)+(2.1)+(3.18), (1.1)+(2.1)+(3.19), (1.1)+(2.1)+(3.20), (1.1)+(2.1)+(3.21), (1.1)+(2.1)+(3.22), (1.1)+(2.1)+(3.23), (1.1)+(2.1)+(3.24), (1.1)+(2.1)+(3.25), (1.1)+(2.1)+(3.26), (1.1)+(2.1)+(3.27), (1.1)+(2.1)+(3.28), (1.1)+(2.1)+(3.29), (1.1)+(2.1)+(3.30), (1.1)+(2.1)+(3.31), (1.1)+(2.1)+(3.32), (1.1)+(2.1)+(3.33),

(1.2)+(2.1)+(3.1), (1.2)+(2.1)+(3.2), (1.2)+(2.1)+(3.3), (1.2)+(2.1)+(3.4), (1.2)+(2.1)+(3.5), (1.2)+(2.1)+(3.6), (1.2)+(2.1)+(3.7), (1.2)+(2.1)+(3.8), (1.2)+(2.1)+(3.9), (1.2)+(2.1)+(3.10), (1.2)+(2.1)+(3.11), (1.2)+(2.1)+(3.12), (1.2)+(2.1)+(3.13), (1.2)+(2.1)+(3.14), (1.2)+(2.1)+(3.15), (1.2)+(2.1)+(3.16), (1.2)+(2.1)+(3.17), (1.2)+(2.1)+(3.18), (1.2)+(2.1)+(3.19), (1.2)+(2.1)+(3.20), (1.2)+(2.1)+(3.21), (1.2)+(2.1)+(3.22), (1.2)+(2.1)+(3.23), (1.2)+(2.1)+(3.24), (1.2)+(2.1)+(3.25), (1.2)+(2.1)+(3.26), (1.2)+(2.1)+(3.27), (1.2)+(2.1)+(3.28), (1.2)+(2.1)+(3.29), (1.2)+(2.1)+(3.30), (1.2)+(2.1)+(3.31), (1.2)+(2.1)+(3.32), (1.2)+(2.1)+(3.33),

(1.3)+(2.1)+(3.1), (1.3)+(2.1)+(3.2), (1.3)+(2.1)+(3.3), (1.3)+(2.1)+(3.4), (1.3)+(2.1)+(3.5), (1.3)+(2.1)+(3.6), (1.3)+(2.1)+(3.7), (1.3)+(2.1)+(3.8), (1.3)+(2.1)+(3.9), (1.3)+(2.1)+(3.10), (1.3)+(2.1)+(3.11), (1.3)+(2.1)+(3.12), (1.3)+(2.1)+(3.13), (1.3)+(2.1)+(3.14), (1.3)+(2.1)+(3.15), (1.3)+(2.1)+(3.16), (1.3)+(2.1)+(3.17), (1.3)+(2.1)+(3.18), (1.3)+(2.1)+(3.19), (1.3)+(2.1)+(3.20), (1.3)+(2.1)+(3.21), (1.3)+(2.1)+(3.22), (1.3)+(2.1)+(3.23), (1.3)+(2.1)+(3.24), (1.3)+(2.1)+(3.25), (1.3)+(2.1)+(3.26), (1.3)+(2.1)+(3.27), (1.3)+(2.1)+(3.28), (1.3)+(2.1)+(3.29), (1.3)+(2.1)+(3.30), (1.3)+(2.1)+(3.31), (1.3)+(2.1)+(3.32), (1.3)+(2.1)+(3.33),

(1.4)+(2.1)+(3.1), (1.4)+(2.1)+(3.2), (1.4)+(2.1)+(3.3), (1.4)+(2.1)+(3.4), (1.4)+(2.1)+(3.5), (1.4)+(2.1)+(3.6), (1.4)+(2.1)+(3.7), (1.4)+(2.1)+(3.8), (1.4)+(2.1)+(3.9), (1.4)+(2.1)+(3.10), (1.4)+(2.1)+(3.11), (1.4)+(2.1)+(3.12), (1.4)+(2.1)+(3.13), (1.4)+(2.1)+(3.14), (1.4)+(2.1)+(3.15), (1.4)+(2.1)+(3.16), (1.4)+(2.1)+(3.17), (1.4)+(2.1)+(3.18), (1.4)+(2.1)+(3.19), (1.4)+(2.1)+(3.20), (1.4)+(2.1)+(3.21), (1.4)+(2.1)+(3.22), (1.4)+(2.1)+(3.23), (1.4)+(2.1)+(3.24), (1.4)+(2.1)+(3.25), (1.4)+(2.1)+(3.26), (1.4)+(2.1)+(3.27), (1.4)+(2.1)+(3.28), (1.4)+(2.1)+(3.29), (1.1)+(2.1)+(3.30), (1.1)+(2.1)+(3.31), (1.1)+(2.1)+(3.32), (1.1)+(2.1)+(3.33),

(1.1)+(2.1)+(4.1), (1.1)+(2.1)+(4.2), (1.1)+(2.1)+(4.3), (1.2)+(2.1)+(4.1), (1.2)+(2.1)+(4.2), (1.2)+(2.1)+(4.3), (1.3)+(2.1)+(4.1), (1.3)+(2.1)+(4.2), (1.3)+(2.1)+(4.3), (1.4)+(2.1)+(4.1), (1.4)+(2.1)+(4.2), (1.4)+(2.1)+(4.3), (1.1)+(2.1)+(4.4), (1.1)+(2.1)+(4.5), (1.1)+(2.1)+(4.6), (1.2)+(2.1)+(4.4), (1.2)+(2.1)+(4.5), (1.2)+(2.1)+(4.6), (1.3)+(2.1)+(4.4), (1.3)+(2.1)+(4.5), (1.3)+(2.1)+(4.6), (1.4)+(2.1)+(4.4), (1.4)+(2.1)+(4.5), (1.4)+(2.1)+(4.6),

(1.1)+(2.1)+(5), (1.2)+(2.1)+(5), (1.3)+(2.1)+(5), (1.4)+(2.1)+(5),

(1.1)+(2.1)+(6.1), (1.1)+(2.1)+(6.2), (1.1)+(2.1)+(6.3), (1.2)+(2.1)+(6.1), (1.2)+(2.1)+(6.2), (1.2)+(2.1)+(6.3), (1.3)+(2.1)+(6.1), (1.3)+(2.1)+(6.2), (1.3)+(2.1)+(6.3), (1.4)+(2.1)+(6.1), (1.4)+(2.1)+(6.2), (1.4)+(2.1)+(6.3),

(1.1)+(3.1)+(4.1), (1.1)+(3.2)+(4.1), (1.1)+(3.3)+(4.1), (1.1)+(3.4)+(4.1), (1.1)+(3.5)+(4.1), (1.1)+(3.6)+(4.1), (1.1)+(3.7)+(4.1), (1.1)+(3.8)+(4.1), (1.1)+(3.9)+(4.1), (1.1)+(3.10)+(4.1), (1.1)+(3.11)+(4.1), (1.1)+(3.12)+(4.1), (1.1)+(3.13)+(4.1), (1.1)+(3.14)+(4.1), (1.1)+(3.15)+(4.1), (1.1)+(3.16)+(4.1), (1.1)+(3.17)+(4.1), (1.1)+(3.18)+(4.1), (1.1)+(3.19)+(4.1), (1.1)+(3.20)+(4.1), (1.1)+(3.21)+(4.1), (1.1)+(3.22)+(4.1), (1.1)+(3.23)+(4.1), (1.1)+(3.24)+(4.1), (1.1)+(3.25)+(4.1), (1.1)+(3.26)+(4.1), (1.1)+(3.27)+(4.1), (1.1)+(3.28)+(4.1), (1.1)+(3.29)+(4.1), (1.1)+(3.30)+(4.1), (1.1)+(3.31)+(4.1), (1.1)+(3.32)+(4.1), (1.1)+(3.33)+(4.1),

(1.1)+(3.1)+(4.2), (1.1)+(3.2)+(4.2), (1.1)+(3.3)+(4.2), (1.1)+(3.4)+(4.2), (1.1)+(3.5)+(4.2), (1.1)+(3.6)+(4.2), (1.1)+(3.7)+(4.2), (1.1)+(3.8)+(4.2), (1.1)+(3.9)+(4.2), (1.1)+(3.10)+(4.2), (1.1)+(3.11)+(4.2), (1.1)+(3.12)+(4.2), (1.1)+(3.13)+(4.2), (1.1)+(3.14)+(4.2), (1.1)+(3.15)+(4.2), (1.1)+(3.16)+(4.2), (1.1)+(3.17)+(4.2), (1.1)+(3.18)+(4.2), (1.1)+(3.19)+(4.2), (1.1)+(3.20)+(4.2), (1.1)+(3.21)+(4.2), (1.1)+(3.22)+(4.2), (1.1)+(3.23)+(4.2), (1.1)+(3.24)+(4.2), (1.1)+(3.25)+(4.2), (1.1)+(3.26)+(4.2), (1.1)+(3.27)+(4.2), (1.1)+(3.28)+(4.2), (1.1)+(3.29)+(4.2), (1.1)+(3.30)+(4.2), (1.1)+(3.31)+(4.2), (1.1)+(3.32)+(4.2), (1.1)+(3.33)+(4.2),

(1.1)+(3.1)+(4.3), (1.1)+(3.2)+(4.3), (1.1)+(3.3)+(4.3), (1.1)+(3.4)+(4.3), (1.1)+(3.5)+(4.3), (1.1)+(3.6)+(4.3), (1.1)+(3.7)+(4.3), (1.1)+(3.8)+(4.3), (1.1)+(3.9)+(4.3), (1.1)+(3.10)+(4.3), (1.1)+(3.11)+(4.3), (1.1)+(3.12)+(4.3), (1.1)+(3.13)+(4.3), (1.1)+(3.14)+(4.3), (1.1)+(3.15)+(4.3), (1.1)+(3.16)+(4.3), (1.1)+(3.17)+(4.3), (1.1)+(3.18)+(4.3), (1.1)+(3.19)+(4.3), (1.1)+(3.20)+(4.3), (1.1)+(3.21)+(4.3), (1.1)+(3.22)+(4.3), (1.1)+(3.23)+(4.3), (1.1)+(3.24)+(4.3), (1.1)+(3.25)+(4.3), (1.1)+(3.26)+(4.3), (1.1)+(3.27)+(4.3), (1.1)+(3.28)+(4.3), (1.1)+(3.29)+(4.3), (1.1)+(3.30)+(4.3), (1.1)+(3.31)+(4.3), (1.1)+(3.32)+(4.3), (1.1)+(3.33)+(4.3),

(1.1)+(3.1)+(4.4), (1.1)+(3.2)+(4.4), (1.1)+(3.3)+(4.4), (1.1)+(3.4)+(4.4), (1.1)+(3.5)+(4.4), (1.1)+(3.6)+(4.4), (1.1)+(3.7)+(4.4), (1.1)+(3.8)+(4.4), (1.1)+(3.9)+(4.4), (1.1)+(3.10)+(4.4), (1.1)+(3.11)+(4.4), (1.1)+(3.12)+(4.4), (1.1)+(3.13)+(4.4), (1.1)+(3.14)+(4.4), (1.1)+(3.15)+(4.4), (1.1)+(3.16)+(4.4), (1.1)+(3.17)+(4.4), (1.1)+(3.18)+(4.4), (1.1)+(3.19)+(4.4), (1.1)+(3.20)+(4.4), (1.1)+(3.21)+(4.4), (1.1)+(3.22)+(4.4), (1.1)+(3.23)+(4.4), (1.1)+(3.24)+(4.4), (1.1)+(3.25)+(4.4), (1.1)+(3.26)+(4.4), (1.1)+(3.27)+(4.4), (1.1)+(3.28)+(4.4), (1.1)+(3.29)+(4.4), (1.1)+(3.30)+(4.4), (1.1)+(3.31)+(4.4), (1.1)+(3.32)+(4.4), (1.1)+(3.33)+(4.4),

(1.1)+(3.1)+(4.5), (1.1)+(3.2)+(4.5), (1.1)+(3.3)+(4.5), (1.1)+(3.4)+(4.5), (1.1)+(3.5)+(4.5), (1.1)+(3.6)+(4.5), (1.1)+(3.7)+(4.5), (1.1)+(3.8)+(4.5), (1.1)+(3.9)+(4.5), (1.1)+(3.10)+(4.5), (1.1)+(3.11)+(4.5), (1.1)+(3.12)+(4.5), (1.1)+(3.13)+(4.5), (1.1)+(3.14)+(4.5), (1.1)+(3.15)+(4.5), (1.1)+(3.16)+(4.5), (1.1)+(3.17)+(4.5), (1.1)+(3.18)+(4.5), (1.1)+(3.19)+(4.5), (1.1)+(3.20)+(4.5), (1.1)+(3.21)+(4.5), (1.1)+(3.22)+(4.5), (1.1)+(3.23)+(4.5), (1.1)+(3.24)+(4.5), (1.1)+(3.25)+(4.5), (1.1)+(3.26)+(4.5), (1.1)+(3.27)+(4.5), (1.1)+(3.28)+(4.5), (1.1)+(3.29)+(4.5), (1.1)+(3.30)+(4.5), (1.1)+(3.31)+(4.5), (1.1)+(3.32)+(4.5), (1.1)+(3.33)+(4.5),

(1.1)+(3.1)+(4.6), (1.1)+(3.2)+(4.6), (1.1)+(3.3)+(4.6), (1.1)+(3.4)+(4.6), (1.1)+(3.5)+(4.6), (1.1)+(3.6)+(4.6), (1.1)+(3.7)+(4.6), (1.1)+(3.8)+(4.6), (1.1)+(3.9)+(4.6), (1.1)+(3.10)+(4.6), (1.1)+(3.11)+(4.6), (1.1)+(3.12)+(4.6), (1.1)+(3.13)+(4.6), (1.1)+(3.14)+(4.6), (1.1)+(3.15)+(4.6), (1.1)+(3.16)+(4.6), (1.1)+(3.17)+(4.6), (1.1)+(3.18)+(4.6), (1.1)+(3.19)+(4.6), (1.1)+(3.20)+(4.6), (1.1)+(3.21)+(4.6), (1.1)+(3.22)+(4.6), (1.1)+(3.23)+(4.6), (1.1)+(3.24)+(4.6), (1.1)+(3.25)+(4.6), (1.1)+(3.26)+(4.6), (1.1)+(3.27)+(4.6), (1.1)+(3.28)+(4.6), (1.1)+(3.29)+(4.6), (1.1)+(3.30)+(4.6), (1.1)+(3.31)+(4.6), (1.1)+(3.32)+(4.6), (1.1)+(3.33)+(4.6),

(1.2)+(3.1)+(4.1), (1.2)+(3.2)+(4.1), (1.2)+(3.3)+(4.1), (1.2)+(3.4)+(4.1), (1.2)+(3.5)+(4.1), (1.2)+(3.6)+(4.1), (1.2)+(3.7)+(4.1), (1.2)+(3.8)+(4.1), (1.2)+(3.9)+(4.1), (1.2)+(3.10)+(4.1), (1.2)+(3.11)+(4.1), (1.2)+(3.12)+(4.1), (1.2)+(3.13)+(4.1), (1.2)+(3.14)+(4.1), (1.2)+(3.15)+(4.1), (1.2)+(3.16)+(4.1), (1.2)+(3.17)+(4.1), (1.2)+(3.18)+(4.1), (1.2)+(3.19)+(4.1), (1.2)+(3.20)+(4.1), (1.2)+(3.21)+(4.1), (1.2)+(3.22)+(4.1), (1.2)+(3.23)+(4.1), (1.2)+(3.24)+(4.1), (1.2)+(3.25)+(4.1), (1.2)+(3.26)+(4.1), (1.2)+(3.27)+(4.1), (1.2)+(3.28)+(4.1), (1.2)+(3.29)+(4.1), (1.2)+(3.30)+(4.1), (1.2)+(3.31)+(4.1), (1.2)+(3.32)+(4.1), (1.2)+(3.33)+(4.1),

(1.2)+(3.1)+(4.2), (1.2)+(3.2)+(4.2), (1.2)+(3.3)+(4.2), (1.2)+(3.4)+(4.2), (1.2)+(3.5)+(4.2), (1.2)+(3.6)+(4.2), (1.2)+(3.7)+(4.2), (1.2)+(3.8)+(4.2), (1.2)+(3.9)+(4.2), (1.2)+(3.10)+(4.2), (1.2)+(3.11)+(4.2), (1.2)+(3.12)+(4.2), (1.2)+(3.13)+(4.2), (1.2)+(3.14)+(4.2), (1.2)+(3.15)+(4.2), (1.2)+(3.16)+(4.2), (1.2)+(3.17)+(4.2), (1.2)+(3.18)+(4.2), (1.2)+(3.19)+(4.2), (1.2)+(3.20)+(4.2), (1.2)+(3.21)+(4.2), (1.2)+(3.22)+(4.2), (1.2)+(3.23)+(4.2), (1.2)+(3.24)+(4.2), (1.2)+(3.25)+(4.2), (1.2)+(3.26)+(4.2), (1.2)+(3.27)+(4.2), (1.2)+(3.28)+(4.2), (1.2)+(3.29)+(4.2), (1.2)+(3.30)+(4.2), (1.2)+(3.31)+(4.2), (1.2)+(3.32)+(4.2), (1.2)+(3.33)+(4.2),

(1.2)+(3.1)+(4.3), (1.2)+(3.2)+(4.3), (1.2)+(3.3)+(4.3), (1.2)+(3.4)+(4.3), (1.2)+(3.5)+(4.3), (1.2)+(3.6)+(4.3), (1.2)+(3.7)+(4.3), (1.2)+(3.8)+(4.3), (1.2)+(3.9)+(4.3), (1.2)+(3.10)+(4.3), (1.2)+(3.11)+(4.3), (1.2)+(3.12)+(4.3), (1.2)+(3.13)+(4.3), (1.2)+(3.14)+(4.3), (1.2)+(3.15)+(4.3), (1.2)+(3.16)+(4.3), (1.2)+(3.17)+(4.3), (1.2)+(3.18)+(4.3), (1.2)+(3.19)+(4.3), (1.2)+(3.20)+(4.3), (1.2)+(3.21)+(4.3), (1.2)+(3.22)+(4.3), (1.2)+(3.23)+(4.3), (1.2)+(3.24)+(4.3), (1.2)+(3.25)+(4.3), (1.2)+(3.26)+(4.3), (1.2)+(3.27)+(4.3), (1.2)+(3.28)+(4.3), (1.2)+(3.29)+(4.3), (1.2)+(3.30)+(4.3), (1.2)+(3.31)+(4.3), (1.2)+(3.32)+(4.3), (1.2)+(3.33)+(4.3),

(1.2)+(3.1)+(4.4), (1.2)+(3.2)+(4.4), (1.2)+(3.3)+(4.4), (1.2)+(3.4)+(4.4), (1.2)+(3.5)+(4.4), (1.2)+(3.6)+(4.4), (1.2)+(3.7)+(4.4), (1.2)+(3.8)+(4.4), (1.2)+(3.9)+(4.4), (1.2)+(3.10)+(4.4), (1.2)+(3.11)+(4.4), (1.2)+(3.12)+(4.4), (1.2)+(3.13)+(4.4), (1.2)+(3.14)+(4.4), (1.2)+(3.15)+(4.4), (1.2)+(3.16)+(4.4), (1.2)+(3.17)+(4.4), (1.2)+(3.18)+(4.4), (1.2)+(3.19)+(4.4), (1.2)+(3.20)+(4.4), (1.2)+(3.21)+(4.4), (1.2)+(3.22)+(4.4), (1.2)+(3.23)+(4.4), (1.2)+(3.24)+(4.4), (1.2)+(3.25)+(4.4), (1.2)+(3.26)+(4.4), (1.2)+(3.27)+(4.4), (1.2)+(3.28)+(4.4), (1.2)+(3.29)+(4.4), (1.2)+(3.30)+(4.4), (1.2)+(3.31)+(4.4), (1.2)+(3.32)+(4.4), (1.2)+(3.33)+(4.4),

(1.2)+(3.1)+(4.5), (1.2)+(3.2)+(4.5), (1.2)+(3.3)+(4.5), (1.2)+(3.4)+(4.5), (1.2)+(3.5)+(4.5), (1.2)+(3.6)+(4.5), (1.2)+(3.7)+(4.5), (1.2)+(3.8)+(4.5), (1.2)+(3.9)+(4.5), (1.2)+(3.10)+(4.5), (1.2)+(3.11)+(4.5), (1.2)+(3.12)+(4.5), (1.2)+(3.13)+(4.5), (1.2)+(3.14)+(4.5), (1.2)+(3.15)+(4.5), (1.2)+(3.16)+(4.5), (1.2)+(3.17)+(4.5), (1.2)+(3.18)+(4.5), (1.2)+(3.19)+(4.5), (1.2)+(3.20)+(4.5), (1.2)+(3.21)+(4.5), (1.2)+(3.22)+(4.5), (1.2)+(3.23)+(4.5), (1.2)+(3.24)+(4.5), (1.2)+(3.25)+(4.5), (1.2)+(3.26)+(4.5), (1.2)+(3.27)+(4.5), (1.2)+(3.28)+(4.5), (1.2)+(3.29)+(4.5), (1.2)+(3.30)+(4.5), (1.2)+(3.31)+(4.5), (1.2)+(3.32)+(4.5), (1.2)+(3.33)+(4.5),

(1.2)+(3.1)+(4.6), (1.2)+(3.2)+(4.6), (1.2)+(3.3)+(4.6), (1.2)+(3.4)+(4.6), (1.2)+(3.5)+(4.6), (1.2)+(3.6)+(4.6), (1.2)+(3.7)+(4.6), (1.2)+(3.8)+(4.6), (1.2)+(3.9)+(4.6), (1.2)+(3.10)+(4.6), (1.2)+(3.11)+(4.6), (1.2)+(3.12)+(4.6), (1.2)+(3.13)+(4.6), (1.2)+(3.14)+(4.6), (1.2)+(3.15)+(4.6), (1.2)+(3.16)+(4.6), (1.2)+(3.17)+(4.6), (1.2)+(3.18)+(4.6), (1.2)+(3.19)+(4.6), (1.2)+(3.20)+(4.6), (1.2)+(3.21)+(4.6), (1.2)+(3.22)+(4.6), (1.2)+(3.23)+(4.6), (1.2)+(3.24)+(4.6), (1.2)+(3.25)+(4.6), (1.2)+(3.26)+(4.6), (1.2)+(3.27)+(4.6), (1.2)+(3.28)+(4.6), (1.2)+(3.29)+(4.6), (1.2)+(3.30)+(4.6), (1.2)+(3.31)+(4.6), (1.2)+(3.32)+(4.6), (1.2)+(3.33)+(4.6),

(1.3)+(3.1)+(4.1), (1.3)+(3.2)+(4.1), (1.3)+(3.3)+(4.1), (1.3)+(3.4)+(4.1), (1.3)+(3.5)+(4.1), (1.3)+(3.6)+(4.1), (1.3)+(3.7)+(4.1), (1.3)+(3.8)+(4.1), (1.3)+(3.9)+(4.1), (1.3)+(3.10)+(4.1), (1.3)+(3.11)+(4.1), (1.3)+(3.12)+(4.1), (1.3)+(3.13)+(4.1), (1.3)+(3.14)+(4.1), (1.3)+(3.15)+(4.1), (1.3)+(3.16)+(4.1), (1.3)+(3.17)+(4.1), (1.3)+(3.18)+(4.1), (1.3)+(3.19)+(4.1), (1.3)+(3.20)+(4.1), (1.3)+(3.21)+(4.1), (1.3)+(3.22)+(4.1), (1.3)+(3.23)+(4.1), (1.3)+(3.24)+(4.1), (1.3)+(3.25)+(4.1), (1.3)+(3.26)+(4.1), (1.3)+(3.27)+(4.1), (1.3)+(3.28)+(4.1), (1.3)+(3.29)+(4.1), (1.3)+(3.30)+(4.1), (1.3)+(3.31)+(4.1), (1.3)+(3.32)+(4.1), (1.3)+(3.33)+(4.1),

(1.3)+(3.1)+(4.2), (1.3)+(3.2)+(4.2), (1.3)+(3.3)+(4.2), (1.3)+(3.4)+(4.2), (1.3)+(3.5)+(4.2), (1.3)+(3.6)+(4.2), (1.3)+(3.7)+(4.2), (1.3)+(3.8)+(4.2), (1.3)+(3.9)+(4.2), (1.3)+(3.10)+(4.2), (1.3)+(3.11)+(4.2), (1.3)+(3.12)+(4.2), (1.3)+(3.13)+(4.2), (1.3)+(3.14)+(4.2), (1.3)+(3.15)+(4.2), (1.3)+(3.16)+(4.2), (1.3)+(3.17)+(4.2), (1.3)+(3.18)+(4.2), (1.3)+(3.19)+(4.2), (1.3)+(3.20)+(4.2), (1.3)+(3.21)+(4.2), (1.3)+(3.22)+(4.2), (1.3)+(3.23)+(4.2), (1.3)+(3.24)+(4.2), (1.3)+(3.25)+(4.2), (1.3)+(3.26)+(4.2), (1.3)+(3.27)+(4.2), (1.3)+(3.28)+(4.2), (1.3)+(3.29)+(4.2), (1.3)+(3.30)+(4.2), (1.3)+(3.31)+(4.2), (1.3)+(3.32)+(4.2), (1.3)+(3.33)+(4.2),

(1.3)+(3.1)+(4.3), (1.3)+(3.2)+(4.3), (1.3)+(3.3)+(4.3), (1.3)+(3.4)+(4.3), (1.3)+(3.5)+(4.3), (1.3)+(3.6)+(4.3), (1.3)+(3.7)+(4.3), (1.3)+(3.8)+(4.3), (1.3)+(3.9)+(4.3), (1.3)+(3.10)+(4.3), (1.3)+(3.11)+(4.3), (1.3)+(3.12)+(4.3), (1.3)+(3.13)+(4.3), (1.3)+(3.14)+(4.3), (1.3)+(3.15)+(4.3), (1.3)+(3.16)+(4.3), (1.3)+(3.17)+(4.3), (1.3)+(3.18)+(4.3), (1.3)+(3.19)+(4.3), (1.3)+(3.20)+(4.3), (1.3)+(3.21)+(4.3), (1.3)+(3.22)+(4.3), (1.3)+(3.23)+(4.3), (1.3)+(3.24)+(4.3), (1.3)+(3.25)+(4.3), (1.3)+(3.26)+(4.3), (1.3)+(3.27)+(4.3), (1.3)+(3.28)+(4.3), (1.3)+(3.29)+(4.3), (1.3)+(3.30)+(4.3), (1.3)+(3.31)+(4.3), (1.3)+(3.32)+(4.3), (1.3)+(3.33)+(4.3),

(1.3)+(3.1)+(4.4), (1.3)+(3.2)+(4.4), (1.3)+(3.3)+(4.4), (1.3)+(3.4)+(4.4), (1.3)+(3.5)+(4.4), (1.3)+(3.6)+(4.4), (1.3)+(3.7)+(4.4), (1.3)+(3.8)+(4.4), (1.3)+(3.9)+(4.4), (1.3)+(3.10)+(4.4), (1.3)+(3.11)+(4.4), (1.3)+(3.12)+(4.4), (1.3)+(3.13)+(4.4), (1.3)+(3.14)+(4.4), (1.3)+(3.15)+(4.4), (1.3)+(3.16)+(4.4), (1.3)+(3.17)+(4.4), (1.3)+(3.18)+(4.4), (1.3)+(3.19)+(4.4), (1.3)+(3.20)+(4.4), (1.3)+(3.21)+(4.4), (1.3)+(3.22)+(4.4), (1.3)+(3.23)+(4.4), (1.3)+(3.24)+(4.4), (1.3)+(3.25)+(4.4), (1.3)+(3.26)+(4.4), (1.3)+(3.27)+(4.4), (1.3)+(3.28)+(4.4), (1.3)+(3.29)+(4.4), (1.3)+(3.30)+(4.4), (1.3)+(3.31)+(4.4), (1.3)+(3.32)+(4.4), (1.3)+(3.33)+(4.4),

(1.3)+(3.1)+(4.5), (1.3)+(3.2)+(4.5), (1.3)+(3.3)+(4.5), (1.3)+(3.4)+(4.5), (1.3)+(3.5)+(4.5), (1.3)+(3.6)+(4.5), (1.3)+(3.7)+(4.5), (1.3)+(3.8)+(4.5), (1.3)+(3.9)+(4.5), (1.3)+(3.10)+(4.5), (1.3)+(3.11)+(4.5), (1.3)+(3.12)+(4.5), (1.3)+(3.13)+(4.5), (1.3)+(3.14)+(4.5), (1.3)+(3.15)+(4.5), (1.3)+(3.16)+(4.5), (1.3)+(3.17)+(4.5), (1.3)+(3.18)+(4.5), (1.3)+(3.19)+(4.5), (1.3)+(3.20)+(4.5), (1.3)+(3.21)+(4.5), (1.3)+(3.22)+(4.5), (1.3)+(3.23)+(4.5), (1.3)+(3.24)+(4.5), (1.3)+(3.25)+(4.5), (1.3)+(3.26)+(4.5), (1.3)+(3.27)+(4.5), (1.3)+(3.28)+(4.5), (1.3)+(3.29)+(4.5), (1.3)+(3.30)+(4.5), (1.3)+(3.31)+(4.5), (1.3)+(3.32)+(4.5), (1.3)+(3.33)+(4.5),

(1.3)+(3.1)+(4.6), (1.3)+(3.2)+(4.6), (1.3)+(3.3)+(4.6), (1.3)+(3.4)+(4.6), (1.3)+(3.5)+(4.6), (1.3)+(3.6)+(4.6), (1.3)+(3.7)+(4.6), (1.3)+(3.8)+(4.6), (1.3)+(3.9)+(4.6), (1.3)+(3.10)+(4.6), (1.3)+(3.11)+(4.6), (1.3)+(3.12)+(4.6), (1.3)+(3.13)+(4.6), (1.3)+(3.14)+(4.6), (1.3)+(3.15)+(4.6), (1.3)+(3.16)+(4.6), (1.3)+(3.17)+(4.6), (1.3)+(3.18)+(4.6), (1.3)+(3.19)+(4.6), (1.3)+(3.20)+(4.6), (1.3)+(3.21)+(4.6), (1.3)+(3.22)+(4.6), (1.3)+(3.23)+(4.6), (1.3)+(3.24)+(4.6), (1.3)+(3.25)+(4.6), (1.3)+(3.26)+(4.6), (1.3)+(3.27)+(4.6), (1.3)+(3.28)+(4.6), (1.3)+(3.29)+(4.6), (1.3)+(3.30)+(4.6), (1.3)+(3.31)+(4.6), (1.3)+(3.32)+(4.6), (1.3)+(3.33)+(4.6),

(1.4)+(3.1)+(4.1), (1.4)+(3.2)+(4.1), (1.4)+(3.3)+(4.1), (1.4)+(3.4)+(4.1), (1.4)+(3.5)+(4.1), (1.4)+(3.6)+(4.1), (1.4)+(3.7)+(4.1), (1.4)+(3.8)+(4.1), (1.4)+(3.9)+(4.1), (1.4)+(3.10)+(4.1), (1.4)+(3.11)+(4.1), (1.4)+(3.12)+(4.1), (1.4)+(3.13)+(4.1), (1.4)+(3.14)+(4.1), (1.4)+(3.15)+(4.1), (1.4)+(3.16)+(4.1), (1.4)+(3.17)+(4.1), (1.4)+(3.18)+(4.1), (1.4)+(3.19)+(4.1), (1.4)+(3.20)+(4.1), (1.4)+(3.21)+(4.1), (1.4)+(3.22)+(4.1), (1.4)+(3.23)+(4.1), (1.4)+(3.24)+(4.1), (1.4)+(3.25)+(4.1), (1.4)+(3.26)+(4.1), (1.4)+(3.27)+(4.1), (1.4)+(3.28)+(4.1), (1.4)+(3.29)+(4.1), (1.4)+(3.30)+(4.1), (1.4)+(3.31)+(4.1), (1.4)+(3.32)+(4.1), (1.4)+(3.33)+(4.1),

(1.4)+(3.1)+(4.2), (1.4)+(3.2)+(4.2), (1.4)+(3.3)+(4.2), (1.4)+(3.4)+(4.2), (1.4)+(3.5)+(4.2), (1.4)+(3.6)+(4.2), (1.4)+(3.7)+(4.2), (1.4)+(3.8)+(4.2), (1.4)+(3.9)+(4.2), (1.4)+(3.10)+(4.2), (1.4)+(3.11)+(4.2), (1.4)+(3.12)+(4.2), (1.4)+(3.13)+(4.2), (1.4)+(3.14)+(4.2), (1.4)+(3.15)+(4.2), (1.4)+(3.16)+(4.2), (1.4)+(3.17)+(4.2), (1.4)+(3.18)+(4.2), (1.4)+(3.19)+(4.2), (1.4)+(3.20)+(4.2), (1.4)+(3.21)+(4.2), (1.4)+(3.22)+(4.2), (1.4)+(3.23)+(4.2), (1.4)+(3.24)+(4.2), (1.4)+(3.25)+(4.2), (1.4)+(3.26)+(4.2), (1.4)+(3.27)+(4.2), (1.4)+(3.28)+(4.2), (1.4)+(3.29)+(4.2), (1.4)+(3.30)+(4.2), (1.4)+(3.31)+(4.2), (1.4)+(3.32)+(4.2), (1.4)+(3.33)+(4.2), (1.4)+(3.1)+(4.3), (1.4)+(3.2)+(4.3), (1.4)+(3.3)+(4.3), (1.4)+(3.4)+(4.3), (1.4)+(3.5)+(4.3), (1.4)+(3.6)+(4.3), (1.4)+(3.7)+(4.3), (1.4)+(3.8)+(4.3), (1.4)+(3.9)+(4.3), (1.4)+(3.10)+(4.3), (1.4)+(3.11)+(4.3), (1.4)+(3.12)+(4.3), (1.4)+(3.13)+(4.3), (1.4)+(3.14)+(4.3), (1.4)+(3.15)+(4.3), (1.4)+(3.16)+(4.3), (1.4)+(3.17)+(4.3), (1.4)+(3.18)+(4.3), (1.4)+(3.19)+(4.3), (1.4)+(3.20)+(4.3), (1.4)+(3.21)+(4.3), (1.4)+(3.22)+(4.3), (1.4)+(3.23)+(4.3), (1.4)+(3.24)+(4.3), (1.4)+(3.25)+(4.3), (1.4)+(3.26)+(4.3), (1.4)+(3.27)+(4.3), (1.4)+(3.28)+(4.3), (1.4)+(3.29)+(4.3), (1.4)+(3.30)+(4.3), (1.4)+(3.31)+(4.3), (1.4)+(3.32)+(4.3), (1.4)+(3.33)+(4.3),

(1.4)+(3.1)+(4.4), (1.4)+(3.2)+(4.4), (1.4)+(3.3)+(4.4), (1.4)+(3.4)+(4.4), (1.4)+(3.5)+(4.4), (1.4)+(3.6)+(4.4), (1.4)+(3.7)+(4.4), (1.4)+(3.8)+(4.4), (1.4)+(3.9)+(4.4), (1.4)+(3.10)+(4.4), (1.4)+(3.11)+(4.4), (1.4)+(3.12)+(4.4), (1.4)+(3.13)+(4.4), (1.4)+(3.14)+(4.4), (1.4)+(3.15)+(4.4), (1.4)+(3.16)+(4.4), (1.4)+(3.17)+(4.4), (1.4)+(3.18)+(4.4), (1.4)+(3.19)+(4.4), (1.4)+(3.20)+(4.4), (1.4)+(3.21)+(4.4), (1.4)+(3.22)+(4.4), (1.4)+(3.23)+(4.4), (1.4)+(3.24)+(4.4), (1.4)+(3.25)+(4.4), (1.4)+(3.26)+(4.4), (1.4)+(3.27)+(4.4), (1.4)+(3.28)+(4.4), (1.4)+(3.29)+(4.4), (1.4)+(3.30)+(4.4), (1.4)+(3.31)+(4.4), (1.4)+(3.32)+(4.4), (1.4)+(3.33)+(4.4),

(1.4)+(3.1)+(4.5), (1.4)+(3.2)+(4.5), (1.4)+(3.3)+(4.5), (1.4)+(3.4)+(4.5), (1.4)+(3.5)+(4.5), (1.4)+(3.6)+(4.5), (1.4)+(3.7)+(4.5), (1.4)+(3.8)+(4.5), (1.4)+(3.9)+(4.5), (1.4)+(3.10)+(4.5), (1.4)+(3.11)+(4.5), (1.4)+(3.12)+(4.5), (1.4)+(3.13)+(4.5), (1.4)+(3.14)+(4.5), (1.4)+(3.15)+(4.5), (1.4)+(3.16)+(4.5), (1.4)+(3.17)+(4.5), (1.4)+(3.18)+(4.5), (1.4)+(3.19)+(4.5), (1.4)+(3.20)+(4.5), (1.4)+(3.21)+(4.5), (1.4)+(3.22)+(4.5), (1.4)+(3.23)+(4.5), (1.4)+(3.24)+(4.5), (1.4)+(3.25)+(4.5), (1.4)+(3.26)+(4.5), (1.4)+(3.27)+(4.5), (1.4)+(3.28)+(4.5), (1.4)+(3.29)+(4.5), (1.4)+(3.30)+(4.5), (1.4)+(3.31)+(4.5), (1.4)+(3.32)+(4.5), (1.4)+(3.33)+(4.5),

(1.4)+(3.1)+(4.6), (1.4)+(3.2)+(4.6), (1.4)+(3.3)+(4.6), (1.4)+(3.4)+(4.6), (1.4)+(3.5)+(4.6), (1.4)+(3.6)+(4.6), (1.4)+(3.7)+(4.6), (1.4)+(3.8)+(4.6), (1.4)+(3.9)+(4.6), (1.4)+(3.10)+(4.6), (1.4)+(3.11)+(4.6), (1.4)+(3.12)+(4.6), (1.4)+(3.13)+(4.6), (1.4)+(3.14)+(4.6), (1.4)+(3.15)+(4.6), (1.4)+(3.16)+(4.6), (1.4)+(3.17)+(4.6), (1.4)+(3.18)+(4.6), (1.4)+(3.19)+(4.6), (1.4)+(3.20)+(4.6), (1.4)+(3.21)+(4.6), (1.4)+(3.22)+(4.6), (1.4)+(3.23)+(4.6), (1.4)+(3.24)+(4.6), (1.4)+(3.25)+(4.6), (1.4)+(3.26)+(4.6), (1.4)+(3.27)+(4.6), (1.4)+(3.28)+(4.6), (1.4)+(3.29)+(4.6), (1.4)+(3.30)+(4.6), (1.4)+(3.31)+(4.6), (1.4)+(3.32)+(4.6), (1.4)+(3.33)+(4.6), (1.1)+(3.1)+(5), (1.1)+(3.2)+(5), (1.1)+(3.3)+(5), (1.1)+(3.4)+(5), (1.1)+(3.5)+(5), (1.1)+(3.6)+(5), (1.1)+(3.7)+(5), (1.1)+(3.8)+(5), (1.1)+(3.9)+(5), (1.1)+(3.10)+(5), (1.1)+(3.11)+(5), (1.1)+(3.12)+(5), (1.1)+(3.13)+(5), (1.1)+(3.14)+(5), (1.1)+(3.15)+(5), (1.1)+(3.16)+(5), (1.1)+(3.17)+(5), (1.1)+(3.18)+(5), (1.1)+(3.19)+(5), (1.1)+(3.20)+(5), (1.1)+(3.21)+(5), (1.1)+(3.22)+(5), (1.1)+(3.23)+(5), (1.1)+(3.24)+(5), (1.1)+(3.25)+(5), (1.1)+(3.26)+(5), (1.1)+(3.27)+(5), (1.1)+(3.28)+(5), (1.1)+(3.29)+(5), (1.1)+(3.30)+(5), (1.1)+(3.31)+(5), (1.1)+(3.32)+(5), (1.1)+(3.33)+(5),

(1.2)+(3.1)+(5), (1.2)+(3.2)+(5), (1.2)+(3.3)+(5), (1.2)+(3.4)+(5), (1.2)+(3.5)+(5), (1.2)+(3.6)+(5), (1.2)+(3.7)+(5), (1.2)+(3.8)+(5), (1.2)+(3.9)+(5), (1.2)+(3.10)+(5), (1.2)+(3.11)+(5), (1.2)+(3.12)+(5), (1.2)+(3.13)+(5), (1.2)+(3.14)+(5), (1.2)+(3.15)+(5), (1.2)+(3.16)+(5), (1.2)+(3.17)+(5), (1.2)+(3.18)+(5), (1.2)+(3.19)+(5), (1.2)+(3.20)+(5), (1.2)+(3.21)+(5), (1.2)+(3.22)+(5), (1.2)+(3.23)+(5), (1.2)+(3.24)+(5), (1.2)+(3.25)+(5), (1.2)+(3.26)+(5), (1.2)+(3.27)+(5), (1.2)+(3.28)+(5), (1.2)+(3.29)+(5), (1.2)+(3.30)+(5), (1.2)+(3.31)+(5), (1.2)+(3.32)+(5), (1.2)+(3.33)+(5),

(1.3)+(3.1)+(5), (1.3)+(3.2)+(5), (1.3)+(3.3)+(5), (1.3)+(3.4)+(5), (1.3)+(3.5)+(5), (1.3)+(3.6)+(5), (1.3)+(3.7)+(5), (1.3)+(3.8)+(5), (1.3)+(3.9)+(5), (1.3)+(3.10)+(5), (1.3)+(3.11)+(5), (1.3)+(3.12)+(5), (1.3)+(3.13)+(5), (1.3)+(3.14)+(5), (1.3)+(3.15)+(5), (1.3)+(3.16)+(5), (1.3)+(3.17)+(5), (1.3)+(3.18)+(5), (1.3)+(3.19)+(5), (1.3)+(3.20)+(5), (1.3)+(3.21)+(5), (1.3)+(3.22)+(5), (1.3)+(3.23)+(5), (1.3)+(3.24)+(5), (1.3)+(3.25)+(5), (1.3)+(3.26)+(5), (1.3)+(3.27)+(5), (1.3)+(3.28)+(5), (1.3)+(3.29)+(5), (1.3)+(3.30)+(5), (1.3)+(3.31)+(5), (1.3)+(3.32)+(5), (1.3)+(3.33)+(5),

(1.4)+(3.1)+(5), (1.4)+(3.2)+(5), (1.4)+(3.3)+(5), (1.4)+(3.4)+(5), (1.4)+(3.5)+(5), (1.4)+(3.6)+(5), (1.4)+(3.7)+(5), (1.4)+(3.8)+(5), (1.4)+(3.9)+(5), (1.4)+(3.10)+(5), (1.4)+(3.11)+(5), (1.4)+(3.12)+(5), (1.4)+(3.13)+(5), (1.4)+(3.14)+(5), (1.4)+(3.15)+(5), (1.4)+(3.16)+(5), (1.4)+(3.17)+(5), (1.4)+(3.18)+(5), (1.4)+(3.19)+(5), (1.4)+(3.20)+(5), (1.4)+(3.21)+(5), (1.4)+(3.22)+(5), (1.4)+(3.23)+(5), (1.4)+(3.24)+(5), (1.4)+(3.25)+(5), (1.4)+(3.26)+(5), (1.4)+(3.27)+(5), (1.4)+(3.28)+(5), (1.4)+(3.29)+(5), (1.4)+(3.30)+(5), (1.4)+(3.31)+(5), (1.4)+(3.32)+(5), (1.4)+(3.33)+(5),

(1.1)+(3.1)+(6.1), (1.1)+(3.2)+(6.1), (1.1)+(3.3)+(6.1), (1.1)+(3.4)+(6.1), (1.1)+(3.5)+(6.1), (1.1)+(3.6)+(6.1), (1.1)+(3.7)+(6.1), (1.1)+(3.8)+(6.1), (1.1)+(3.9)+(6.1), (1.1)+(3.10)+(6.1), (1.1)+(3.11)+(6.1), (1.1)+(3.12)+(6.1), (1.1)+(3.13)+(6.1), (1.1)+(3.14)+(6.1), (1.1)+(3.15)+(6.1), (1.1)+(3.16)+(6.1), (1.1)+(3.17)+(6.1), (1.1)+(3.18)+(6.1), (1.1)+(3.19)+(6.1), (1.1)+(3.20)+(6.1), (1.1)+(3.21)+(6.1), (1.1)+(3.22)+(6.1), (1.1)+(3.23)+(6.1), (1.1)+(3.24)+(6.1), (1.1)+(3.25)+(6.1), (1.1)+(3.26)+(6.1), (1.1)+(3.27)+(6.1), (1.1)+(3.28)+(6.1), (1.1)+(3.29)+(6.1), (1.1)+(3.30)+(6.1), (1.1)+(3.31)+(6.1), (1.1)+(3.32)+(6.1), (1.1)+(3.33)+(6.1),

(1.1)+(3.1)+(6.2), (1.1)+(3.2)+(6.2), (1.1)+(3.3)+(6.2), (1.1)+(3.4)+(6.2), (1.1)+(3.5)+(6.2), (1.1)+(3.6)+(6.2), (1.1)+(3.7)+(6.2), (1.1)+(3.8)+(6.2), (1.1)+(3.9)+(6.2), (1.1)+(3.10)+(6.2), (1.1)+(3.11)+(6.2), (1.1)+(3.12)+(6.2), (1.1)+(3.13)+(6.2), (1.1)+(3.14)+(6.2), (1.1)+(3.15)+(6.2), (1.1)+(3.16)+(6.2), (1.1)+(3.17)+(6.2), (1.1)+(3.18)+(6.2), (1.1)+(3.19)+(6.2), (1.1)+(3.20)+(6.2), (1.1)+(3.21)+(6.2), (1.1)+(3.22)+(6.2), (1.1)+(3.23)+(6.2), (1.1)+(3.24)+(6.2), (1.1)+(3.25)+(6.2), (1.1)+(3.26)+(6.2), (1.1)+(3.27)+(6.2), (1.1)+(3.28)+(6.2), (1.1)+(3.29)+(6.2), (1.1)+(3.30)+(6.2), (1.1)+(3.31)+(6.2), (1.1)+(3.32)+(6.2), (1.1)+(3.33)+(6.2),

(1.1)+(3.1)+(6.3), (1.1)+(3.2)+(6.3), (1.1)+(3.3)+(6.3), (1.1)+(3.4)+(6.3), (1.1)+(3.5)+(6.3), (1.1)+(3.6)+(6.3), (1.1)+(3.7)+(6.3), (1.1)+(3.8)+(6.3), (1.1)+(3.9)+(6.3), (1.1)+(3.10)+(6.3), (1.1)+(3.11)+(6.3), (1.1)+(3.12)+(6.3), (1.1)+(3.13)+(6.3), (1.1)+(3.14)+(6.3), (1.1)+(3.15)+(6.3), (1.1)+(3.16)+(6.3), (1.1)+(3.17)+(6.3), (1.1)+(3.18)+(6.3), (1.1)+(3.19)+(6.3), (1.1)+(3.20)+(6.3), (1.1)+(3.21)+(6.3), (1.1)+(3.22)+(6.3), (1.1)+(3.23)+(6.3), (1.1)+(3.24)+(6.3), (1.1)+(3.25)+(6.3), (1.1)+(3.26)+(6.3), (1.1)+(3.27)+(6.3), (1.1)+(3.28)+(6.3), (1.1)+(3.29)+(6.3), (1.1)+(3.30)+(6.3), (1.1)+(3.31)+(6.3), (1.1)+(3.32)+(6.3), (1.1)+(3.33)+(6.3),

(1.2)+(3.1)+(6.1), (1.2)+(3.2)+(6.1), (1.2)+(3.3)+(6.1), (1.2)+(3.4)+(6.1), (1.2)+(3.5)+(6.1), (1.2)+(3.6)+(6.1), (1.2)+(3.7)+(6.1), (1.2)+(3.8)+(6.1), (1.2)+(3.9)+(6.1), (1.2)+(3.10)+(6.1), (1.2)+(3.11)+(6.1), (1.2)+(3.12)+(6.1), (1.2)+(3.13)+(6.1), (1.2)+(3.14)+(6.1), (1.2)+(3.15)+(6.1), (1.2)+(3.16)+(6.1), (1.2)+(3.17)+(6.1), (1.2)+(3.18)+(6.1), (1.2)+(3.19)+(6.1), (1.2)+(3.20)+(6.1), (1.2)+(3.21)+(6.1), (1.2)+(3.22)+(6.1), (1.2)+(3.23)+(6.1), (1.2)+(3.24)+(6.1), (1.2)+(3.25)+(6.1), (1.2)+(3.26)+(6.1), (1.2)+(3.27)+(6.1), (1.2)+(3.28)+(6.1), (1.2)+(3.29)+(6.1), (1.2)+(3.30)+(6.1), (1.2)+(3.31)+(6.1), (1.2)+(3.32)+(6.1), (1.2)+(3.33)+(6.1),

(1.2)+(3.1)+(6.2), (1.2)+(3.2)+(6.2), (1.2)+(3.3)+(6.2), (1.2)+(3.4)+(6.2), (1.2)+(3.5)+(6.2), (1.2)+(3.6)+(6.2), (1.2)+(3.7)+(6.2), (1.2)+(3.8)+(6.2), (1.2)+(3.9)+(6.2), (1.2)+(3.10)+(6.2), (1.2)+(3.11)+(6.2), (1.2)+(3.12)+(6.2), (1.2)+(3.13)+(6.2), (1.2)+(3.14)+(6.2), (1.2)+(3.15)+(6.2), (1.2)+(3.16)+(6.2), (1.2)+(3.17)+(6.2), (1.2)+(3.18)+(6.2), (1.2)+(3.19)+(6.2), (1.2)+(3.20)+(6.2), (1.2)+(3.21)+(6.2), (1.2)+(3.22)+(6.2), (1.2)+(3.23)+(6.2), (1.2)+(3.24)+(6.2), (1.2)+(3.25)+(6.2), (1.2)+(3.26)+(6.2), (1.2)+(3.27)+(6.2), (1.2)+(3.28)+(6.2), (1.2)+(3.29)+(6.2), (1.2)+(3.30)+(6.2), (1.2)+(3.31)+(6.2), (1.2)+(3.32)+(6.2), (1.2)+(3.33)+(6.2),

(1.2)+(3.1)+(6.3), (1.2)+(3.2)+(6.3), (1.2)+(3.3)+(6.3), (1.2)+(3.4)+(6.3), (1.2)+(3.5)+(6.3), (1.2)+(3.6)+(6.3), (1.2)+(3.7)+(6.3), (1.2)+(3.8)+(6.3), (1.2)+(3.9)+(6.3), (1.2)+(3.10)+(6.3), (1.2)+(3.11)+(6.3), (1.2)+(3.12)+(6.3), (1.2)+(3.13)+(6.3), (1.2)+(3.14)+(6.3), (1.2)+(3.15)+(6.3), (1.2)+(3.16)+(6.3), (1.2)+(3.17)+(6.3), (1.2)+(3.18)+(6.3), (1.2)+(3.19)+(6.3), (1.2)+(3.20)+(6.3), (1.2)+(3.21)+(6.3), (1.2)+(3.22)+(6.3), (1.2)+(3.23)+(6.3), (1.2)+(3.24)+(6.3), (1.2)+(3.25)+(6.3), (1.2)+(3.26)+(6.3), (1.2)+(3.27)+(6.3), (1.2)+(3.28)+(6.3), (1.2)+(3.29)+(6.3), (1.2)+(3.30)+(6.3), (1.2)+(3.31)+(6.3), (1.2)+(3.32)+(6.3), (1.2)+(3.33)+(6.3),

(1.3)+(3.1)+(6.1), (1.3)+(3.2)+(6.1), (1.3)+(3.3)+(6.1), (1.3)+(3.4)+(6.1), (1.3)+(3.5)+(6.1), (1.3)+(3.6)+(6.1), (1.3)+(3.7)+(6.1), (1.3)+(3.8)+(6.1), (1.3)+(3.9)+(6.1), (1.3)+(3.10)+(6.1), (1.3)+(3.11)+(6.1), (1.3)+(3.12)+(6.1), (1.3)+(3.13)+(6.1), (1.3)+(3.14)+(6.1), (1.3)+(3.15)+(6.1), (1.3)+(3.16)+(6.1), (1.3)+(3.17)+(6.1), (1.3)+(3.18)+(6.1), (1.3)+(3.19)+(6.1), (1.3)+(3.20)+(6.1), (1.3)+(3.21)+(6.1), (1.3)+(3.22)+(6.1), (1.3)+(3.23)+(6.1), (1.3)+(3.24)+(6.1), (1.3)+(3.25)+(6.1), (1.3)+(3.26)+(6.1), (1.3)+(3.27)+(6.1), (1.3)+(3.28)+(6.1), (1.3)+(3.29)+(6.1), (1.3)+(3.30)+(6.1), (1.3)+(3.31)+(6.1), (1.3)+(3.32)+(6.1), (1.3)+(3.33)+(6.1),

(1.3)+(3.1)+(6.2), (1.3)+(3.2)+(6.2), (1.3)+(3.3)+(6.2), (1.3)+(3.4)+(6.2), (1.3)+(3.5)+(6.2), (1.3)+(3.6)+(6.2), (1.3)+(3.7)+(6.2), (1.3)+(3.8)+(6.2), (1.3)+(3.9)+(6.2), (1.3)+(3.10)+(6.2), (1.3)+(3.11)+(6.2), (1.3)+(3.12)+(6.2), (1.3)+(3.13)+(6.2), (1.3)+(3.14)+(6.2), (1.3)+(3.15)+(6.2), (1.3)+(3.16)+(6.2), (1.3)+(3.17)+(6.2), (1.3)+(3.18)+(6.2), (1.3)+(3.19)+(6.2), (1.3)+(3.20)+(6.2), (1.3)+(3.21)+(6.2), (1.3)+(3.22)+(6.2), (1.3)+(3.23)+(6.2), (1.3)+(3.24)+(6.2), (1.3)+(3.25)+(6.2), (1.3)+(3.26)+(6.2), (1.3)+(3.27)+(6.2), (1.3)+(3.28)+(6.2), (1.3)+(3.29)+(6.2), (1.3)+(3.30)+(6.2), (1.3)+(3.31)+(6.2), (1.3)+(3.32)+(6.2), (1.3)+(3.33)+(6.2),

(1.3)+(3.1)+(6.3), (1.3)+(3.2)+(6.3), (1.3)+(3.3)+(6.3), (1.3)+(3.4)+(6.3), (1.3)+(3.5)+(6.3), (1.3)+(3.6)+(6.3), (1.3)+(3.7)+(6.3), (1.3)+(3.8)+(6.3), (1.3)+(3.9)+(6.3), (1.3)+(3.10)+(6.3), (1.3)+(3.11)+(6.3), (1.3)+(3.12)+(6.3), (1.3)+(3.13)+(6.3), (1.3)+(3.14)+(6.3), (1.3)+(3.15)+(6.3), (1.3)+(3.16)+(6.3), (1.3)+(3.17)+(6.3), (1.3)+(3.18)+(6.3), (1.3)+(3.19)+(6.3), (1.3)+(3.20)+(6.3), (1.3)+(3.21)+(6.3), (1.3)+(3.22)+(6.3), (1.3)+(3.23)+(6.3), (1.3)+(3.24)+(6.3), (1.3)+(3.25)+(6.3), (1.3)+(3.26)+(6.3), (1.3)+(3.27)+(6.3), (1.3)+(3.28)+(6.3), (1.3)+(3.29)+(6.3), (1.3)+(3.30)+(6.3), (1.3)+(3.31)+(6.3), (1.3)+(3.32)+(6.3), (1.3)+(3.33)+(6.3),

(1.4)+(3.1)+(6.1), (1.4)+(3.2)+(6.1), (1.4)+(3.3)+(6.1), (1.4)+(3.4)+(6.1), (1.4)+(3.5)+(6.1), (1.4)+(3.6)+(6.1), (1.4)+(3.7)+(6.1), (1.4)+(3.8)+(6.1), (1.4)+(3.9)+(6.1), (1.4)+(3.10)+(6.1), (1.4)+(3.11)+(6.1), (1.4)+(3.12)+(6.1), (1.4)+(3.13)+(6.1), (1.4)+(3.14)+(6.1), (1.4)+(3.15)+(6.1), (1.4)+(3.16)+(6.1), (1.4)+(3.17)+(6.1), (1.4)+(3.18)+(6.1), (1.4)+(3.19)+(6.1), (1.4)+(3.20)+(6.1), (1.4)+(3.21)+(6.1), (1.4)+(3.22)+(6.1), (1.4)+(3.23)+(6.1), (1.4)+(3.24)+(6.1), (1.4)+(3.25)+(6.1), (1.4)+(3.26)+(6.1), (1.4)+(3.27)+(6.1), (1.4)+(3.28)+(6.1), (1.4)+(3.29)+(6.1), (1.4)+(3.30)+(6.1), (1.4)+(3.31)+(6.1), (1.4)+(3.32)+(6.1), (1.4)+(3.33)+(6.1),

(1.4)+(3.1)+(6.2), (1.4)+(3.2)+(6.2), (1.4)+(3.3)+(6.2), (1.4)+(3.4)+(6.2), (1.4)+(3.5)+(6.2), (1.4)+(3.6)+(6.2), (1.4)+(3.7)+(6.2), (1.4)+(3.8)+(6.2), (1.4)+(3.9)+(6.2), (1.4)+(3.10)+(6.2), (1.4)+(3.11)+(6.2), (1.4)+(3.12)+(6.2), (1.4)+(3.13)+(6.2), (1.4)+(3.14)+(6.2), (1.4)+(3.15)+(6.2), (1.4)+(3.16)+(6.2), (1.4)+(3.17)+(6.2), (1.4)+(3.18)+(6.2), (1.4)+(3.19)+(6.2), (1.4)+(3.20)+(6.2), (1.4)+(3.21)+(6.2), (1.4)+(3.22)+(6.2), (1.4)+(3.23)+(6.2), (1.4)+(3.24)+(6.2), (1.4)+(3.25)+(6.2), (1.4)+(3.26)+(6.2), (1.4)+(3.27)+(6.2), (1.4)+(3.28)+(6.2), (1.4)+(3.29)+(6.2), (1.4)+(3.30)+(6.2), (1.4)+(3.31)+(6.2), (1.4)+(3.32)+(6.2), (1.4)+(3.33)+(6.2),

(1.4)+(3.1)+(6.3), (1.4)+(3.2)+(6.3), (1.4)+(3.3)+(6.3), (1.4)+(3.4)+(6.3), (1.4)+(3.5)+(6.3), (1.4)+(3.6)+(6.3), (1.4)+(3.7)+(6.3), (1.4)+(3.8)+(6.3), (1.4)+(3.9)+(6.3), (1.4)+(3.10)+(6.3), (1.4)+(3.11)+(6.3), (1.4)+(3.12)+(6.3), (1.4)+(3.13)+(6.3), (1.4)+(3.14)+(6.3), (1.4)+(3.15)+(6.3), (1.4)+(3.16)+(6.3), (1.4)+(3.17)+(6.3), (1.4)+(3.18)+(6.3), (1.4)+(3.19)+(6.3), (1.4)+(3.20)+(6.3), (1.4)+(3.21)+(6.3), (1.4)+(3.22)+(6.3), (1.4)+(3.23)+(6.3), (1.4)+(3.24)+(6.3), (1.4)+(3.25)+(6.3), (1.4)+(3.26)+(6.3), (1.4)+(3.27)+(6.3), (1.4)+(3.28)+(6.3), (1.4)+(3.29)+(6.3), (1.4)+(3.30)+(6.3), (1.4)+(3.31)+(6.3), (1.4)+(3.32)+(6.3), (1.4)+(3.33)+(6.3),

(1.1)+(4.1)+(5), (1.1)+(4.2)+(5), (1.1)+(4.3)+(5), (1.1)+(4.4)+(5), (1.1)+(4.5)+(5), (1.1)+(4.6)+(5), (1.2)+(4.1)+(5), (1.2)+(4.2)+(5), (1.2)+(4.3)+(5), (1.2)+(4.4)+(5), (1.2)+(4.5)+(5), (1.2)+(4.6)+(5), (1.3)+(4.1)+(5), (1.3)+(4.2)+(5), (1.3)+(4.3)+(5), (1.3)+(4.4)+(5), (1.3)+(4.5)+(5), (1.3)+(4.6)+(5), (1.4)+(4.1)+(5), (1.4)+(4.2)+(5), (1.4)+(4.3)+(5), (1.4)+(4.4)+(5), (1.4)+(4.5)+(5), (1.4)+(4.6)+(5).

(1.1)+(4.1)+(6.1), (1.1)+(4.2)+(6.1), (1.1)+(4.3)+(6.1), (1.1)+(4.4)+(6.1), (1.1)+(4.5)+(6.1), (1.1)+(4.6)+(6.1), (1.2)+(4.1)+(6.1), (1.2)+(4.2)+(6.1), (1.2)+(4.3)+(6.1), (1.2)+(4.4)+(6.1), (1.2)+(4.5)+(6.1), (1.2)+(4.6)+(6.1), (1.3)+(4.1)+(6.1), (1.3)+(4.2)+(6.1), (1.3)+(4.3)+(6.1), (1.3)+(4.4)+(6.1), (1.3)+(4.5)+(6.1), (1.3)+(4.6)+(6.1), (1.4)+(4.1)+(6.1), (1.4)+(4.2)+(6.1), (1.4)+(4.3)+(6.1), (1.4)+(4.4)+(6.1), (1.4)+(4.5)+(6.1), (1.4)+(4.6)+(6.1).

(1.1)+(4.1)+(6.2), (1.1)+(4.2)+(6.2), (1.1)+(4.3)+(6.2), (1.1)+(4.4)+(6.2), (1.1)+(4.5)+(6.2), (1.1)+(4.6)+(6.2), (1.2)+(4.1)+(6.2), (1.2)+(4.2)+(6.2), (1.2)+(4.3)+(6.2), (1.2)+(4.4)+(6.2), (1.2)+(4.5)+(6.2), (1.2)+(4.6)+(6.2), (1.3)+(4.1)+(6.2), (1.3)+(4.2)+(6.2), (1.3)+(4.3)+(6.2), (1.3)+(4.4)+(6.2), (1.3)+(4.5)+(6.2), (1.3)+(4.6)+(6.2), (1.4)+(4.1)+(6.2), (1.4)+(4.2)+(6.2), (1.4)+(4.3)+(6.2), (1.4)+(4.4)+(6.2), (1.4)+(4.5)+(6.2), (1.4)+(4.6)+(6.2).

(1.1)+(4.1)+(6.3), (1.1)+(4.2)+(6.3), (1.1)+(4.3)+(6.3), (1.1)+(4.4)+(6.3), (1.1)+(4.5)+(6.3), (1.1)+(4.6)+(6.3), (1.2)+(4.1)+(6.3), (1.2)+(4.2)+(6.3), (1.2)+(4.3)+(6.3), (1.2)+(4.4)+(6.3), (1.2)+(4.5)+(6.3), (1.2)+(4.6)+(6.3), (1.3)+(4.1)+(6.3), (1.3)+(4.2)+(6.3), (1.3)+(4.3)+(6.3), (1.3)+(4.4)+(6.3), (1.3)+(4.5)+(6.3), (1.3)+(4.6)+(6.3), (1.4)+(4.1)+(6.3), (1.4)+(4.2)+(6.3), (1.4)+(4.3)+(6.3), (1.4)+(4.4)+(6.3), (1.4)+(4.5)+(6.3), (1.4)+(4.6)+(6.3).

Out of these the following combinations are even further preferred:

(1.1)+(2.1)+(3.3), (1.1)+(2.1)+(3.22), (1.2)+(2.1)+(3.3), (1.2)+(2.1)+(3.22), (1.3)+(2.1)+(3.3), (1.3)+(2.1)+(3.22), (1.4)+(2.1)+(3.3), (1.4)+(2.1)+(3.22), (1.1)+(2.1)+(4.2), (1.2)+(2.1)+(4.2), (1.3)+(2.1)+(4.2), (1.4)+(2.1)+(4.2), (1.1)+(2.1)+(5), (1.2)+(2.1)+(5), (1.3)+(2.1)+(5), (1.4)+(2.1)+(5), (1.1)+(3.3)+(4.2), (1.1)+(3.22)+(4.2), (1.1)+(3.3)+(4.3), (1.1)+(3.22)+(4.3), (1.1)+(3.3)+(4.5), (1.1)+(3.22)+(4.5), (1.2)+(3.3)+(4.2), (1.2)+(3.22)+(4.2), (1.2)+(3.3)+(4.3), (1.2)+(3.22)+(4.3), (1.2)+(3.3)+(4.5), (1.2)+(3.22)+(4.5), (1.3)+(3.3)+(4.2), (1.3)+(3.22)+(4.2), (1.3)+(3.3)+(4.3), (1.3)+(3.22)+(4.3), (1.3)+(3.3)+(4.5), (1.3)+(3.22)+(4.5), (1.4)+(3.3)+(4.2), (1.4)+(3.22)+(4.2), (1.4)+(3.3)+(4.3), (1.4)+(3.22)+(4.3), (1.4)+(3.3)+(4.5), (1.4)+(3.22)+(4.5), (1.1)+(4.2)+(5), (1.2)+(4.2)+(5), (1.3)+(4.2)+(5), (1.4)+(4.2)+(5), (1.1)+(4.3)+(5), (1.2)+(4.3)+(5), (1.3)+(4.3)+(5), (1.4)+(4.3)+(5), (1.1)+(4.5)+(5), (1.2)+(4.5)+(5), (1.3)+(4.5)+(5), (1.4)+(4.5)+(5),

(1.1)+(2.1)+(6.1), (1.1)+(2.1)+(6.2), (1.1)+(2.1)+(6.3), (1.2)+(2.1)+(6.1), (1.2)+(2.1)+(6.2), (1.2)+(2.1)+(6.3), (1.3)+(2.1)+(6.1), (1.3)+(2.1)+(6.2), (1.3)+(2.1)+(6.3), (1.4)+(2.1)+(6.1), (1.4)+(2.1)+(6.2), (1.4)+(2.1)+(6.3), (1.1)+(3.3)+(6.1), (1.1)+(3.22)+(6.1), (1.1)+(3.3)+(6.2), (1.1)+(3.22)+(6.2), (1.1)+(3.3)+(6.3), (1.1)+(3.22)+(6.3), (1.2)+(3.3)+(6.1), (1.2)+(3.22)+(6.1), (1.2)+(3.3)+(6.2), (1.2)+(3.22)+(6.2), (1.2)+(3.3)+(6.3), (1.2)+(3.22)+(6.3), (1.3)+(3.3)+(6.1), (1.3)+(3.22)+(6.1), (1.3)+(3.3)+(6.2), (1.3)+(3.22)+(6.2), (1.3)+(3.3)+(6.3), (1.3)+(3.22)+(6.3), (1.4)+(3.3)+(6.1), (1.4)+(3.22)+(6.1), (1.4)+(3.3)+(6.2), (1.4)+(3.22)+(6.2), (1.4)+(3.3)+(6.3), (1.4)+(3.22)+(6.3), (1.1)+(4.2)+(6.1), (1.1)+(4.3)+(6.1), (1.1)+(4.5)+(6.1), (1.2)+(4.2)+(6.1), (1.2)+(4.3)+(6.1), (1.2)+(4.5)+(6.1), (1.3)+(4.2)+(6.1), (1.3)+(4.3)+(6.1), (1.3)+(4.5)+(6.1), (1.4)+(4.2)+(6.1), (1.4)+(4.3)+(6.1), (1.4)+(4.5)+(6.1), (1.1)+(4.2)+(6.2), (1.1)+(4.3)+(6.2), (1.1)+(4.5)+(6.2), (1.2)+(4.2)+(6.2), (1.2)+(4.3)+(6.2), (1.2)+(4.5)+(6.2), (1.3)+(4.2)+(6.2), (1.3)+(4.3)+(6.2), (1.3)+(4.5)+(6.2), (1.4)+(4.2)+(6.2), (1.4)+(4.3)+(6.2), (1.4)+(4.5)+(6.2), (1.1)+(4.2)+(6.3), (1.1)+(4.3)+(6.3), (1.1)+(4.5)+(6.3), (1.2)+(4.2)+(6.3), (1.2)+(4.3)+(6.3), (1.2)+(4.5)+(6.3), (1.3)+(4.2)+(6.3), (1.3)+(4.3)+(6.3), (1.3)+(4.5)+(6.3), (1.4)+(4.2)+(6.3), (1.4)+(4.3)+(6.3), (1.4)+(4.5)+(6.3).

Out of these the following combinations are even further preferred:

(1.1)+(2.1)+(3.3), (1.1)+(2.1)+(3.22), (1.2)+(2.1)+(3.3), (1.2)+(2.1)+(3.22), (1.1)+(2.1)+(4.2), (1.2)+(2.1)+(4.2), (1.1)+(2.1)+(4.3), (1.2)+(2.1)+(4.3), (1.1)+(2.1)+(4.5), (1.2)+(2.1)+(4.5), (1.1)+(2.1)+(5), (1.2)+(2.1)+(5), (1.1)+(3.3)+(4.2), (1.1)+(3.22)+(4.2), (1.1)+(3.3)+(4.3), (1.1)+(3.22)+(4.3), (1.1)+(3.3)+(4.5), (1.1)+(3.22)+(4.5), (1.2)+(3.3)+(4.2), (1.2)+(3.22)+(4.2), (1.2)+(3.3)+(4.3), (1.2)+(3.22)+(4.3), (1.2)+(3.3)+(4.5), (1.2)+(3.22)+(4.5), (1.1)+(4.2)+(5), (1.2)+(4.2)+(5), (1.1)+(4.3)+(5), (1.2)+(4.3)+(5), (1.1)+(4.5)+(5), (1.2)+(4.5)+(5), (1.1)+(2.1)+(6.1), (1.1)+(2.1)+(6.2), (1.1)+(2.1)+(6.3), (1.2)+(2.1)+(6.1), (1.2)+(2.1)+(6.2), (1.2)+(2.1)+(6.3), (1.3)+(2.1)+(6.1), (1.1)+(3.3)+(6.1), (1.1)+(3.22)+(6.1), (1.1)+(3.3)+(6.2), (1.1)+(3.22)+(6.2), (1.1)+(3.3)+(6.3), (1.1)+(3.22)+(6.3), (1.2)+(3.3)+(6.1), (1.2)+(3.22)+(6.1), (1.2)+(3.3)+(6.2), (1.2)+(3.22)+(6.2), (1.2)+(3.3)+(6.3), (1.2)+(3.22)+(6.3), (1.1)+(4.2)+(6.1), (1.1)+(4.3)+(6.1), (1.1)+(4.5)+(6.1), (1.2)+(4.2)+(6.1), (1.2)+(4.3)+(6.1), (1.2)+(4.5)+(6.1), (1.1)+(4.2)+(6.2), (1.1)+(4.3)+(6.2), (1.1)+(4.5)+(6.2), (1.2)+(4.2)+(6.2), (1.2)+(4.3)+(6.2), (1.2)+(4.5)+(6.2), (1.1)+(4.2)+(6.3), (1.1)+(4.3)+(6.3), (1.1)+(4.5)+(6.3), (1.2)+(4.2)+(6.3), (1.2)+(4.3)+(6.3), (1.2)+(4.5)+(6.3).

Most preference is given to the following combinations:

(1.2)+(2.1)+(3.3), (1.2)+(2.1)+(3.22), (1.2)+(2.1)+(4.2), (1.2)+(2.1)+(4.3), (1.2)+(2.1)+(4.5), (1.2)+(2.1)+(5), (1.2)+(3.3)+(4.2), (1.2)+(3.22)+(4.2), (1.2)+(3.3)+(4.3), (1.2)+(3.22)+(4.3), (1.2)+(3.3)+(4.5), (1.2)+(3.22)+(4.5), (1.2)+(4.2)+(5), (1.2)+(4.3)+(5), (1.2)+(4.5)+(5), (1.1)+(2.1)+(6.1), (1.1)+(2.1)+(6.2), (1.1)+(2.1)+(6.3), (1.1)+(3.3)+(6.1), (1.1)+(3.22)+(6.1), (1.1)+(3.3)+(6.2), (1.1)+(3.22)+(6.2), (1.1)+(3.3)+(6.3), (1.1)+(3.22)+(6.3), (1.1)+(4.2)+(6.1), (1.1)+(4.3)+(6.1), (1.1)+(4.5)+(6.1), (1.1)+(4.2)+(6.2), (1.1)+(4.3)+(6.2), (1.1)+(4.5)+(6.2), (1.1)+(4.2)+(6.3), (1.1)+(4.3)+(6.3), (1.1)+(4.5)+(6.3).

There from the combination (1.2)+(2.1)+(4.5) is even most preferred.

All ternary combinations mentioned above can be combined with at least one further known bactericide, fungicide, acaricide, nematicide, herbicide, insecticide, micronutrients and micronutrient-containing compound, safener, lipochito-oligosaccharides (LCO), soil-improvement product or product for reducing plant stress, for example Myconate, in order to widen the spectrum of action or to prevent the development of resistance, for example.

Preferably, the ternary combinations mentioned above may be further combined with at least one compound selected from the group consisting of (1.1) acibenzolar-S-methyl, (1.2) isotianil, (1.3) probenazole, (1.4) tiadinil, (2.1) Fosetyl-Al, (3.3) azoxystrobin, (3.22) trifloxystrobin, (4.1) copper (Cu), (4.2) copper-hydroxide, (4.3) copper-sulphate, (4.4) copper-oxychloride, (4.5) Propineb, (4.6) Mancozeb, and (5) Lipochito-oligosaccharide compounds (LCO) (5)

All named combination partners, as well as the host defense inducers of the present invention can, if their functional groups enable this, optionally form salts with suitable bases or acids.

Further, the host defense inducers of the present invention can be combined with at least one active compound selected from the group consisting of:

Acetic acid (e.g. naphthalene acetic acid), peracetic acid, organic acids (e.g. citric acid, lactic acid), amino acids (e.g. 1-arginine), humic acids, fulvic acids, boric acid, oxolinic acid, 1,2,3-Benzothiadiazole-7-thiocarboxylic acid-S-methyl-ester, 5-hydroxy-1,4-naphthalenedione, bromo-chloro-dimethylhydantoin, Trichloroisoyanuric acid, salicylic acid, dichlorophen, kanamycin, kasugamycin, streptomycin, strepromycin sulfate, oxytetracycline, gentamycin (e.g. gentamycin sulphate hydrate), imidacloprid, tebuconazole thiabendzole, thiram, teracep, octhilinone, quinoxyfen, azadirachtin, furanoflavone, forchlorfenuron, plant minerals (e.g. calcium, calcium calcium carbonate, hypochlorite, calcium EDTA), enzymes (e.g. protease, amylase, lipase), trace elements and chelated trace elements (e.g. as amino acid chelates), vitamins and plant extracts, salicylate derivatives, bioflavonoids and organic acids derived from vegetables and fruit, natural fruit extracted polyphenols, bitter orange oil, citrus extracts, chitosan, starch, seaweed extract, organosilicone, activated ionized silicon complex (Zumsil®), bee wax, urea, Bacillus subtilis, Bacillus amyloliquefaciens, Pseudomonas fluorescens, Pseudomonas putida, Pantoea agglomerans, Trichoderma koningii, Trichoderma harzianum, chlorine and chlorine compounds (e.g. chlorinated water, chlorine dioxide, sodium chlorite, sodium hypochlorite, hypochlorous acid, ammonium chloride, didecyl dimethyl ammonium chloride, benzalkonium chloride), oxygen, hydrogen peroxide (H₂O₂) and peroxygen compounds, hydrogen cyanamide, nickel (III) sulphate, sodium persulphate, phosphite, phosphate, Trisodium phosphate, phosphoric acid, inorganic nitrogen, silver and silver containing compounds (e.g. colloidal silver), glutaraldehyde, rhamnolipid (Zonix®).

Thereunder, preference is given to combinations of at least one of the host defense inducers of the present invention with at least one further compound selected from the group consisting of:

Fosetyl-Al, strobilurins preferably selected from azoxystrobin and trifloxystrobin and micronutrients and micronutrient-containing compounds as defined herein, preferably selected from copper (Cu), copper-hydroxyde, copper-sulphate, copper-oxychloride, Propineb, and Mancozeb.

In this context, the term “combination” or “formulation” means various combinations of at least two of the abovementioned additional active compounds which are possible, such as, for example, ready mixes, tank mixes (which is understood as meaning spray slurries prepared from the formulations of the individual active compounds by combining and diluting prior to the application) or combinations of these (for example, a binary ready mix of two of the abovementioned active compounds is made into a tank mix by using a formulation of the third individual substance). According to the invention, the individual active compounds may also be employed sequentially, i.e. one after the other, at a reasonable interval of a few hours or days, in the case of the treatment of seed for example also by applying a plurality of layers which contain different active compounds. Preferably, it is immaterial in which order the individual active compounds can be employed.

The host defense inducers can be employed as such, in the form of their formulations or the use forms prepared therefrom, such as ready-to-use solutions, suspensions, wettable powders, pastes, soluble powders, dusts and granules. They are applied in the customary manner, for example by pouring, spraying, atomizing, scattering, dusting, foaming, painting on and the like. It is furthermore possible to apply the compounds or formulations of the present invention by the ultra-low-volume method or to inject the active compound preparation, or the active compound itself, into the soil. The vegetative propagation material of the plants may also be treated.

The application rates may be varied within a substantial range, depending on the type of application. In the treatment of plant parts, the application rates of active compound are generally between 0.1 and 10 000 g/ha, preferably between 10 and 1000 g/ha. In the treatment of vegetative propagation material, the application rates of active compound are generally between 0.001 and 50 g per kilogram of vegetative propagation material, preferably between 0.01 and 10 g per kilogram of vegetative propagation material. In the treatment of the soil, the application rates of active compound are generally between 0.1 and 10 000 g/ha, preferably between 1 and 5000 g/ha.

The active compound formulations of the present invention comprise an effective and non-phytotoxic amount of the active ingredients with the expression “effective and non-phytotoxic amount” means an amount of the ingredients and the active compositions according to the invention which is sufficient for controlling or destroying pathogenic bacterial organisms present or liable to appear on the plants, by notably avoiding the development of resistant strains to the active ingredients and in each case does not entail any appreciable symptom of phytotoxicity for the said crops. Such an amount can vary within a wide range depending on the pathogen to be combated or controlled bacteria, the type of crop, the climatic conditions and the compounds included in the bactericide composition according to the invention. This amount can be determined by systematic field trials, which are within the capabilities of a person skilled in the art.

According to the present invention, a synergistic effect of e.g. fungicides is always present when the fungicidal activity of the active compound combinations exceeds the total of the activities of the active compounds when applied individually. The expected activity for a given combination of two active compounds (binary composition) can be calculated as follows:

$$E = x + y - \frac{x * y}{100}$$

in which E represents the expected percentage of inhibition of the disease for the combination of two fungicides at defined doses (for example equal to x and y respectively), x is the percentage of inhibition observed for the disease by the compound (A) at a defined dose (equal to x), y is the percentage of inhibition observed for the disease by the compound (B) at a defined dose (equal to y). When the percentage of inhibition observed for the combination is greater than E, there is a synergistic effect.

The expected activity for a given combination of three active compounds (ternary composition) can be calculated as follows:

$$E = X + Y + Z - ( \frac{X \cdot Y + X \cdot Z + Y \cdot Z}{100} ) + \frac{X \cdot Y \cdot Z}{10000}$$

wherein

X is the efficacy when active compound A is applied at an application rate of m ppm (or g/ha),

Y is the efficacy when active compound B is applied at an application rate of n ppm (or g/ha),

Z is the efficacy when active compound C is applied at an application rate of r ppm (or g/ha),

E is the efficacy when the active compounds A, B and C are applied at application rates of m, n and r ppm (or g/ha), respectively.

The degree of efficacy, expressed in % is denoted. 0% means an efficacy which corresponds to that of the control while an efficacy of 100% means that no disease is observed.

If the actual activity exceeds the calculated value, then the activity of the combination is superadditive, i.e. a synergistic effect exists. In this case, the efficacy which was actually observed must be greater than the value for the expected efficacy (E) calculated from the abovementioned formula.

A further way of demonstrating a synergistic effect is the method of Tammes (cf. “Isoboles, a graphic representation of synergism in pesticides” in Neth. J. Plant Path., 1964, 70, 73-80).

The present invention will now be illustrated with the following examples:

### EXAMPLES

### Example 1

### Burkholderia glumae (=Pseudomonas glumae) Infestation Control with Isotianil on Rice

This example illustrates the efficacy of a composition containing Isotianil against Burkholderia glumae bacterial disease infecting mainly panicles on rice crop.

Field trials were implemented in 2011 in Colombia to evaluate the performance of Isotianil against Burkholderia glumae natural infection on rice crop—variety local Fedearroz 473.

A typical fungicide formulation containing 200 g of Isotianil per liter was applied, for the first trial in 2 consecutive sprays at BBCH29 (tittering stages) and BBCH52 (heading stages) and, in a second trial only at BBCH52. The trial was conducted according to standard experimental practice.

Trial 1:

Results from assessments of Burkholderia glumae incidence on panicles, 44 days after the 2nd spray demonstrated the efficacy of the composition when applied at rates ranging from 100 to 200 g ai/ha and together with the leaf protection the positive effect on the yield at harvest time.

Results from Trial 1 in Colombia, 2011:

TABLE 1
Burkholderia glumae infestation on panicles and effect on yield.

| | | | Yield |
|---|---|---|---|
| | | | T/ha |
| Composition | Rate g ai/ha | | (% of untreated) |
| | | % Incidence | |
| | | on panicles | |
| UNTREATED | | 23.3 | 8.38 Tons |
| | | % efficacy | |
| | | (Abbott) | |
| ISOTIANIL 200 SC | 100 | 57 | 10.04 T (119%) |
| ISOTIANIL 200 SC | 200 | 64 | 10.07 T (120%) |
| PROPINEB | 700 | 14 | 9.8 T (117%) |
| (ANTRACOL) | | | |
| CARPROPAMID | 150 | 43 | 9.06 T (108%) |
| KASUGAMYCIN 2 SL | 30 | 36 | 8.96 T (107%) |

Trial 2:

Results from assessments of Burkholderia glumae incidence on panicles, 29 days after the 1st spray demonstrated the efficacy of the composition when applied at rates ranging from 100 to 200 g ai/ha.

Results from Trial 2 in Colombia, 2011:

TABLE 2
Burkholderia glumae infestation on panicles.

| Composition | Rate g ai/ha | |
|---|---|---|
| | | % Incidence |
| | | on panicles |
| UNTREATED | | 18.3 |
| | | % efficacy |
| | | (Abbott) |
| ISOTIANIL 200 SC | 100 | 36 |
| ISOTIANIL 200 SC | 200 | 55 |
| PROPINEB | 700 | 18 |
| (ANTRACOL) | | |
| CARPROPAMID | 150 | 36 |
| KASUGAMYCIN 2 SL | 30 | 36 |

Conclusion Protection of Rice Against Burkholderia glumae:

The examples show that the level of protection is superior when the compound is applied 2 times (Trial 1) compared to 1 time (Trial 2) but in the two cases, the protection reached by Isotianil at least at 200 g ai/ha is superior to the protection allowed by an antibiotic compound Kasugamycin used in rice to control bacterial diseases. In the harvest trial, the leaf and panicle protection allows final yield increase of about 20% in Isotianil treated plots.

### Example 2a Candidatus Liberibacter Spec. Infestation Control with Isotianil and Isotianil+Fosetyl AL on Citrus

This example illustrates the efficacy of compositions against Candidatus Liberibacter bacterial disease infecting citrus plantations also called HLB huanglongbing or Citrus Greening. In order to propose a solution to prevent the infection of new orchards and to prevent the extension of the disease in existing orchards, this trial was implemented to test compositions containing Isotianil (SC200) or Isotianil+Fosetyl AL (Isotianil SC200+Aliette®).

Materials and Methods:

Six different treatments were designed in the trial. Three replicates were done for each treatment and 10 healthy plants were used per replicate.

The products were applied by foliar application (spraying till run off). Eleven days after foliar application of the products, the plants were infected by inoculating the pathogenic bacteria, Candidatus Liberibacter asiaticus, from diseased young citrus plants into healthy plants via grafting three diseased citrus buds into each healthy citrus plant.

Every 30 days after inoculation, plant leaves from the untreated control were sampled and checked for bacterial DNA. The plant leaves from treated plants were not sampled until the pathogenic bacteria were detected in the untreated control by nested PCR.

The plants with typical symptoms of greening disease were counted and the efficacy was calculated according to ABBOTT (% efficacy). 0% means an efficacy which corresponds to that of the control, while an efficacy of 100% means that no disease was observed.

Nested PCT Detection:

The DNA of citrus leaves was extracted using E.Z.N.A.™ Plant DNA Kit (provided by OMEGA Company, USA). Nested-PCR (Harakava et al. 2000) was used for detection of Candidatus Liberibacter asiaticus' (Las) DNA in the citrus plants and psyllid nymphs. The primer 1500R/27F (AAGGAGGTGATCCAGCCGC/AGAGTTTGATCATGGCTCAG) was used for the first amplification, and OI1/OI2c (GCGCGTATGCAATACGAGCGGCA/GCCTCGCGACTTCGCA ACCCAT) was used for the second amplification (Jagoueix et al. 1994). The first amplification system was carried out in a final volume of 25 μl. The mixture contained 17.6 μL of ddH2O, 2.5 μl of dNTPs (2.5 mmol/L), 0.5 μl each of primers (10 μmol/L), 0.4 μl of Taq enzyme (2.5 U/μL), and 1 μl of Sample DNA. DNA amplification by PCR was performed as follows: reactions were preheated at 94° C. for 5 min; followed by 20 cycles of denaturation at 94° C. for 30 s, annealing at 50° C. for 30 s, and extension at 72° C. for 90 s, with a final extension at 72° C. for 4 min. The second amplification system was also carried out in a final volume of 25 μl. The mixture contained 17.6 μL, of ddH2O, 2.5 μl of dNTPs (2.5 mmol/L), 0.5 μl each of primers (10 mmol/L), 0.4 μl of Taq enzyme (2.5 U/μL), and 1 μl of PCR product of the first amplification. DNA amplification by PCR was performed as follows: reactions were preheated at 96° C. for 1 min; followed by 35 cycles of denaturation at 94° C. for 30 s, annealing at 55° C. for 30 s, and extension at 72° C. for 60 s, with a final extension at 72° C. for 4 min.

Results and Discussion:

The efficacy of the different treatment in suppressing the symptoms of greening disease is shown in Tab. 3. The number of plants with typical symptom of blotchy yellow pattern in plants treated with Isotianil solo and Isotanil+Fosetyl-Al was less than that in untreated plants.

TABLE 3
Percentage of different symptoms and % of disease
control in all treatments

| | Treatments of plants | | % of plants | Disease |
|---|---|---|---|---|
| Treatment | with grafted diseased | Dosage | with | control |
| No. | buds | [ppm] | symptoms^{a)} | [% Abbott] |
| 1 | Water | | 43.3 | 0 |
| 2 | Isotianil 200SC | 50 | 10 | 77 |
| 3 | Isotianil 200SC | 100 | 13.3 | 69 |
| 4 | Isotianil 200SC | 200 | 6.7 | 85 |
| 5 | Isotianil 200SC + | 100 + | 3.3 | 92 |
| | Fosetyl-AL 80% WG | 1600 | | |
| 6 | Fosetyl-AL 80% WG | 1600 | 36.7 | 15 |

Note:
^{a)}blotchy yellow pattern which is the specific symptom of HLB in citrus

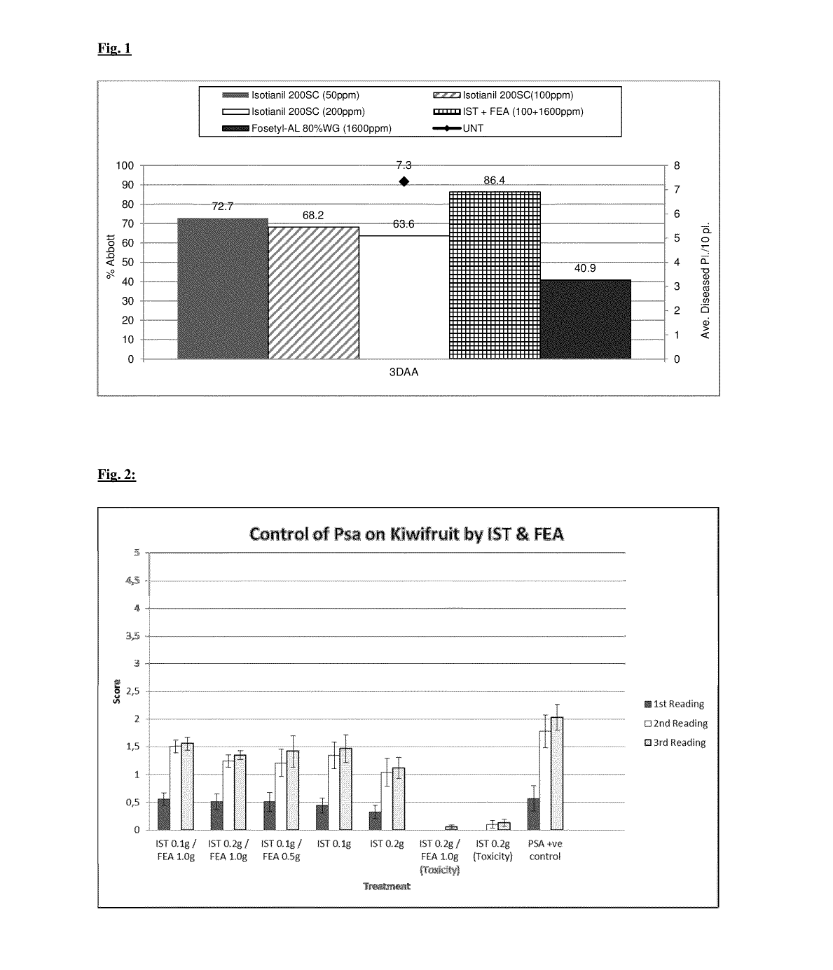

The nested PCR detection result showed that the treatment of plants with Isotianil solo or Isotianil+Fosetyl-Al gave a reduction of the number of leaves infested by greening disease in citrus (see Tab. 4 and FIG. 1). Table 4 shows the percentage of plants which leaves were tested positive among the PCR analysed plants per plot and replicates.

TABLE 4
Nested-PCR result of efficacy of Isotianil 200SC or Isotianil
200SC + Fosetyl-AL 80% WG for the control of
Candidatus Liberibacter asiaticus

| | Dosage | | Disease control |
|---|---|---|---|
| Treatments | [ppm] | % of positive plants | [% Abbott] |
| Untreated | | 73.3 | 0 |
| Isotianil 200SC | 50 | 20.0 | 73 |
| Isotianil 200SC | 100 | 23.3 | 68 |
| Isotianil 200SC | 200 | 26.7 | 64 |
| Isotianil 200SC + | 100 + | 10.0 | 86 |
| Fosetyl-AL 80% WG | 1600 | | |
| Fosetyl-AL 80% WG | 1600 | 43.3 | 41 |

Conclusions:

The symptoms of citrus greening detected on the leaves of grafted diseased plants and the DNA of Candidatus Liberibacter asiaticus detected by nested PCR showed that Isotianil solo or Isotianil+Fosetyl-Al applied prior to bacterial infection effectively decreased the percentage of infection and the severity of the greening disease in citrus. Fosetyl-Al increased the efficacy of Isotianil in the control or suppression of greening disease in citrus.

### Example 2b

### Xanthomonas campestris Pv. Citri Infestation Control with Isotianil on Citrus

This example illustrates the efficacy of a composition containing Isotianil against Xanthomonas campestris pv. citri bacterial disease infecting mainly citrus leaves.

Greenhouse tests were implemented in 2000 in Japan to evaluate the performance of Isotianil against Xanthomonas campestris pv. citri infection on citrus variety Shiroyanagi Navel. Detached citrus leaves were artificially inoculated with wound 1 day after the application with a bacterial strain of Xanthomonas campestris pv. citri.

To produce a suitable preparation of active compound, 1 part by weight of active compound is mixed with the stated amounts of solvent and emulsifier, and the concentrate is diluted with water to the desired concentration.
Solvent: 28.5 parts by weight of acetone
Emulsifier: 1.5 parts by weight of polyoxyethylene alkyl phenyl ether

The preparation of active compound was applied once on the detached citrus leaves by dripping application. 1 day after the application, the detached leaves were inoculated with wound and then placed in a plastic case at approximately 20° C. and a relative atmospheric humidity of approximately 100% for 7 days. The trial was conducted according to standard experimental practice.

Results from assessments of Xanthomonas campestris pv. citri incidence on leaves, 8 days after the application demonstrated the efficacy of the composition when applied at 250 ppm.

Results in Japan, 2000:

TABLE 5
Xanthomonas campestris pv. citri infestation on leaves.

| | Rate | Incidence on |
|---|---|---|
| Composition | ppm | leaves |
| UNTREATED | | 36 |
| | | % efficacy |
| | | (Abbott) |
| ISOTIANIL a.i. | 250 | 37 |
| KASUGAMYCIN | 50 & 756 | 17 |
| & COPPER | | |
| OXYCHLORIDE | | |
| 5.0 & 75.6% WP | | |

Conclusion Protection of Citrus Against Xanthomonas campestris Pv. Citri:

The examples show that the level of protection reached by Isotianil at 250 ppm on citrus is superior to the protection allowed by copper and antibiotic mixture compound used in many crops to control bacterial diseases.

### Example 2c

### Xanthomonas campestris Pv. Citri Infestation Control with Isotianil by Foliar Application on Citrus (Lime)/Field Trial

This example illustrates the efficacy of a composition containing Isotianil against Xanthomonas campestris pv. citri bacterial disease infecting citrus plantations on leaves and fruits also called Canker. A trial was implemented for research purpose, in 2012 in Thailand:

Citrus type: Lime (Citrus Aurentifolia); Plot design: Orchard—1 tree per plot (plot size=9 m²−3×3 m)−3 replicates; Natural infestation

Treatments:

| | | Dose rate | |
|---|---|---|---|
| TRT No. | Product | G ai/ha | Applications |
| 1 | Water | | 7 applications |
| 2 | Isotianil 200SC | 100 g | Foliar spray to run |
| 3 | Isotianil 200SC | 200 g | off - 1500 L/Ha |
| 4 | Copper (Funguran | 1134 g | |
| | 75.6% WG) | | |

Application dates: Day 0, 7, 15, 22, 36, 43, 51

Results

TABLE 5b
Xanthomonas campestris pv. citri infestation on leaves and fruits

| | rates active | Incidence on | Incidence on |
|---|---|---|---|
| | ingredient g | LEAVES 7 days | FRUITS - 7 days |
| composition | ai/ha | after application 7 | after application 7 |
| UNTREATED | | 39% | 29% |
| | | % efficacy Abbott | % efficacy Abbott |
| | | (% incidence) | (% incidence) |
| Isotianil 200SC | 100 | 10.3% (35) | 69.3% (9) |
| Isotianil 200SC | 200 | 69.8% (12) | 40.9% (17) |
| Copper (Funguran | 1134 | 39.7% (23) | 71.6 (8) |
| 75.6% WG) | | | |

Conclusion Protection of Lime Citrus Against Canker (Xanthomonas campestris Pv. citri):

The example shows that the level of protection reached by Isotianil at 100 g and 200 gai/ha against canker on leaves and fruits is comparable to the protection allowed by copper based compound used in many crops to control bacterial diseases. The active dose rate is variable according leaf or fruit protection.

### Example 2d

### Xanthomonas campestris Pv. Citri Infestation Control with Isotianil as Soil Application on Citrus (Orange)/Field Trial

This example illustrates the efficacy of a composition containing Isotianil against Xanthomonas campestris pv. citri bacterial disease infecting citrus plantations on leaves and fruits also called Canker. There is no existing solution for soil application to control Canker so there is no commercial standard in the trial.

A trial was implemented for research purpose, in 2012 in USA:

Citrus type: Sweet Orange (Citrus sinensis)—variety Hamlin; Plot design: Orchard—5 tree per plot (4 replicates)—124 trees/acre; Natural infestation

Treatments

| | | Dose rate | |
|---|---|---|---|
| TRT No. | Product | g ai/ha | Applications |
| 1 | Water | | 2 applications on |
| 2 | Isotianil 200SC | 200 g | wetted soil |
| 3 | Isotianil 200SC | 100 g | (about 2 Liters |
| 4 | Isotianil 200SC | 50 g | water per tree) |

Application dates: Day 0, 51

Results

2 Methodologies for Assessments:

Rating scale 1 to 5 (1=no infestation−5=severe infestation); Number of dropped fruits per tree (fruit fall consecutive to disease infestation)

TABLE 5c
Xanthomonas campestris pv. citri infestation on leaves and fruits

| | | Infestation on | | |
|---|---|---|---|---|
| | | LEAVES | Infestation on FRUITS - | |
| | | 71 days after | 71 days after | |
| | | application 2 | application 2 | Infestation on FRUITS - |
| | | Average rating | Average rating | 71 days after |
| | rates active | (scale 1-5) | (scale 1-5) | application 2 |
| | ingredient g | (Significant | (Significant | Mean of number fruits |
| composition | ai/ha | difference*) | difference*) | dropped per tree* |
| UNTREATED | | 3.2 a | 2.9 a | 12.8 a |
| Isotianil 200SC | 200 g | 1.3 b | 1.2 b | 1.4 b |
| Isotianil 200SC | 100 g | 1.4 b | 1.3 b | 1.2 b |
| Isotianil 200SC | 50 g | 1.8 b | 1.6 b | 2.6 b |

*Means followed by the same letter do not significantly differ (P = 0.05, Duncan)

Conclusion Protection of Lime Citrus Against Canker (Xanthomonas campestris Pv. citri):

The example shows that Isotianil applied directly on the soil close to the root system is able to protect orange leaves and fruits from canker infestation. The systemic efficacy is significant from the lowest tested rate 50 g ai/ha and seems stable from 100 g ai/ha.

This method of application in soil drench with water irrigation system can be an alternative to foliar sprays with high flexibility and is usually highly appreciated by the growers in USA.

### Example 3a

### Pseudomonas syringae Pv. Glycinea (Bacterial Blight) Disease Control with Isotianil by Foliar Application on Soybean

This example illustrates the efficacy of a composition according to the invention against Pseudomonas syringae pv. glycinea disease on Soybean.

Field trials were implemented in 2011 in soybean in Argentina to evaluate the performance of Isotianil against bacterial diseases on soybean.

A typical fungicide formulation containing 200 g of Isotianil per liter was applied in 1 foliar spray in 2011 from flowering stages. The field trial was conducted according to standard experimental practice. The infestation of bacterial disease was natural.

Results from assessments of Pseudomonas syringae on leaves, 17 days after the first application and 16 days after the second application, demonstrated a significant efficacy after Isotianil spray at 100 g ai/ha compared to the untreated plots. One application of Isotianil at 100 g ai/ha is sufficient to reach a good control of Bacterial blight whatever the timing of application.

Results from 1 Trial in Argentina, 2011:

TABLE 6
Pseudomonas syringae pv. glycinea infestation severity
on leaves (Soybean)
(9% severity on leaves in untreated plots - 1st assessment after 1
application BBCH 64/8% severity on leaves in untreated plots - 2nd
assessment after second application - 16 days after application 1)

| | | 1^{st} Assessment | 2^{nd} Assessment |
|---|---|---|---|
| | | % efficacy (Abbott) | % efficacy (Abbott) |
| | Rate | 17 days after | 16 days after |
| Composition | g ai/ha | application A | application B |
| ISOTIANIL 200 SC | 100 g | 66.7 | 93.8 |
| A = application | | | |
| BBCH64 | | | |
| ISOTIANIL 200 SC | 100 g | — | 95.0 |
| B = application | | | |
| 16 days after A | | | |
| ISOTIANIL 200 SC | 100 g | 55.6 | 96.9 |
| 2 applications | | | |
| A + B | | | |

### Example 3b

### Efficacy of Isotianil Against Bacteria (Xanthomonas spp.) in Soybeans

The following example illustrates the efficacy of Isotianil against Xanthomonas spp. (Xanthomonas axonopodis pv. glycines) bacterial disease infecting mainly leaves on soybeans.

The field trial was implemented in 2011 in Argentina to evaluate the performance of Isotianil against Xanthomonas spp. (Xanthomonas axonopodis pv. glycines) natural infection on soybeans.

The trial was set up as a completely randomised block, planted the 26. 10.10. (variety Nidera 4613) and the foliar applications were done the 7.11.11. Isotianil was sprayed as a 200 SC formulation at growth stage BBCH EC 64 of the crop.

The trial was conducted according to standard experimental practice.

TABLE 7
Efficacy of Isotianil 10 days after application against bacteria
Xanthomonas spp. (Xanthomonas axonopodis pv. glycines) infecting
soybean leaves.

| | | | Disease |
|---|---|---|---|
| | Rate g | Severity | Control |
| Treatment | a.i./ha | (%) | [% Abbott] |
| Untreated | | 9 | |
| Isotianil | 100 | 3 | 67 |
| 200 SC | | | |

This example shows the efficacy of Isotianil—demonstrating that the severity of Xanthomonas (Xanthomonas axonopodis pv. glycines) bacterial leaf disease clearly was reduced by a foliar application of Isotianil compared to untreated.

### Example 4a

### Isotianil/Pseudomonas syringae Pv Tomato (Bacterial Speck) on Tomato

This example illustrates the efficacy of a composition according to the invention against Psuedomonas syringae (Pseudomonas syringae pv. tomato) disease on Tomato (Bacterial speck).

A standard experiment was conducted in Spain in 2011 to evaluate the performance of isotianil against bacterial speck of tomato caused by the bacteria Pseudomonas syringae pv tomato.

Tomato plants were grown under plastic tunnel. Plots were artificially inoculated with a suspension of bacteria and treated with different experimental chemical formulations using a conventional sprayer. Four chemical sprays were applied within 7 days intervals. One artificial inoculation was performed one day after the third application.

Disease assessment was done on 3 tomato plants per plot, 11 days after the last application. Infected leaflets were sorted in 3 classes according to a severity scale (Class 1=1 spot/leaflet; Class 2=2-5 spots/leaflet; Class 3=>5 spots/leaflet). Then results were expressed as severity index and transformed in efficacy values using the Abbott formula:

Abbott %={(untreated−treated)/untreated}×100

Results from this experiment demonstrate that applications of a typical formulation containing 200 g isotianil per liter at rates ranging from 400 to 800 g ai/ha can significantly reduce the level of bacterial infection on tomatoes, in comparison with untreated plots and a standard treatment with copper oxychloride.

Results from One Trial in Spain, 2011:

TABLE 8
Pseudomonas syringae pv. tomato severity on tomato

| | Rate g | Disease severity | % efficacy |
|---|---|---|---|
| Composition | ai/ha | index | (Abbott) |
| Untreated inoculated | — | 233 | — |
| Standard treatment | 2450 | 101.3 | 56.5 |
| (copper oxychloride) | | | |
| Isotianil 200 SC | 400 | 116.7 | 49.9 |
| Isotianil 200 SC | 800 | 109.3 | 53.1 |

### Example 4b

### Pseudomonas syringae Infestation Control with Isotianil on Tomato

This example illustrates the efficacy of a composition containing Isotianil against Pseudomonas syringae (Pseudomonas syringae pv. tomato) bacterial disease infecting tomato leaves.

A field trial was implemented for research purpose, in 2011 in Spain, on the Brenes Research Farm near Sevilla, to evaluate the performance of Isotianil against Pseudomonas syringae (Pseudomonas syringae pv. tomato) infection on tomato variety Genaros. The tomato crop was artificially inoculated after the 3rd application with a bacterial strain of Pseudomonas syringae DC3000 (origin University of Malaga). The tomato plants were inoculated at BBCH51 stage (beginning of flowering stage) on plots protected in preventative.

A typical fungicide formulation containing 200 g of Isotianil per liter was applied in 4 consecutive sprays at 7 days spray interval from BBCH14 (4 leaves) to BBCH52 (beginning of flowering stage). The trial was conducted according to standard experimental practice.

Results from the assessments of Pseudomonas syringae incidence on leaves, 4 days and 18 days after the 4th spray, demonstrated the efficacy of the composition when applied at the rate of 400 g ai/ha on leaves compared to copper based compounds well know to be used against bacterial diseases.

Results from One Trial in Spain, 2011:

TABLE 9
Pseudomonas syringae (Pseudomonas syringae pv. tomato)
infestation on leaves

| | | Incidence | Count number of |
|---|---|---|---|
| | Rates active | on leaves - | damaged leaflets per |
| | ingredient g | 4 days after | plot - 18 days after |
| Composition | ai/ha | application 4 | application 4 |
| UNTREATED | | 0 | 0 |
| Non contaminated | | | |
| UNTREATED | | 56 | 233 |
| Contaminated | | | |
| | | % efficacy | % efficacy |
| | | (Abbott) | (Abbott) |
| ISOTIANIL 200 SC | 400 | 40.2 | 49.9 |
| ISOTIANIL 200 SC | 800 | 55.6 | 53.1 |
| CUPROSAN WG50 | 1225 | 57.4 | 56.5 |
| Copper oxychloride | | | |
| CUPROSAN PRO | 400 + 300 | 53.8 | 14.2 |
| WG35 | | | |
| (20% + 15%) | | | |
| Copper | | | |
| oxychloride + | | | |
| Propineb | | | |

Conclusion protection of tomato against Pseudomonas syringae (Pseudomonas syringae pv. tomato): The examples show that the level of protection reached by Isotianil from 400 g ai/ha and more consistently at 800 g ai/ha on tomato is comparable or superior to the protection allowed by copper based compounds used in many crops to control bacterial diseases.

### Example 5

### Xanthomonas campestris Infestation Control with Isotianil on Peach Tree

This example illustrates the efficacy of a composition containing Isotianil against Xanthomonas campestris (Xanthomonas campestris pv. pruni) bacterial disease infecting leaves and fruits in peach trees.

A field trial was implemented in 2008 in Japan to evaluate the performance of Isotianil against Xanthomonas campestris (Xanthomonas campestris pv. pruni) natural infection on peaches—early maturating cultivar Hikawa-Hakuho.

A typical fungicide formulation containing 200 g of Isotianil per liter was applied in 5 consecutive sprays at 14 days spray interval from BBCH65 (full flowering) to BBCH75 (fruit has 50% of its final size). The trial was conducted according to standard experimental practice.

Results from the assessments of Xanthomonas campestris (Xanthomonas campestris pv. pruni) incidence on leaves, 12 days after the 5th spray, and incidence on fruits, 16 days after the 5th spray, demonstrated the efficacy of the composition when applied at the rate of 200 ppm on leaves and from 100 ppm on fruits compared to Streptomycin, a well know compound, used to control bacterial diseases.

Results from One Trial in Japan, 2008:

TABLE 10
Xanthomonas campestris (Xanthomonas campestris pv. pruni)
infestation on leaves and fruits.

| | Rates active | | |
|---|---|---|---|
| | ingredient | % Incidence | % |
| Composition | ppm | on leaves | Incidence on fruits |
| UNTREATED | | 33.8 | 10.0 |
| | | % efficacy | % efficacy |
| | | (Abbott) | (Abbott) |
| ISOTIANIL 200 SC | 100 | 34.5 | 89 |
| ISOTIANIL 200 SC | 200 | 71.4 | 100 |
| Streptomycin WP20% | 200 | 77.3 | 100 |
| (AGREPT) | | | |

Conclusion Protection of Peach Against Xanthomonas campestris:

The examples show that the level of protection reached by Isotianil from 100 ppm and more consistently at 200 ppm is comparable to the protection allowed by an antibiotic compound, Streptomycin, used in fruit orchards to control bacterial diseases.

### Example 6a

### Pseudomonas syringae Infestation Control with Isotianil and Isotianil+Fosetyl al on Cucumbers

This example illustrates the efficacy of a composition containing Isotianil against Pseudomonas syringae bacterial disease infecting cucumber plants.

Several field trials were implemented in 2011 in China to evaluate the performance of Isotianil against Pseudomonas syringae infection on cucumbers giving angular leaf spot symptoms. The trials are listed in the table below

| | | | First | Date of Last |
|---|---|---|---|---|
| Year | Country | State | Crop | update |
| 2011 | CHN | FUJIAN | CUMSA | 30/12/2011 |
| 2011 | CHN | ZHEJIANG | CUMSA | 30/12/2011 |

A typical fungicide formulation containing 200 g of Isotianil per liter and a tank mix of Isotianil 200SC+Fosetyl (Aliette®) W80 were applied in 3 consecutive foliar sprays at different spray intervals according the disease infection risk periods from BBCH 13 (3 leaves developed) to BBCH 72 (fruiting stages). The trials were carried out according to standard experimental practice in field and greenhouse.

Results from the assessments on leaf infection (Severity of infection after the second spray 14 days to 36 days after the second application) demonstrate that Isotianil from 200 g ai/ha and Isotianil+Fosetyl 200+1000 g ai/ha have a significant efficacy against bacterial infection. The efficacy of Isotianil at 400 g ai/ha is superior to the standards and gives superior yield. The addition of 1000 g ai/ha of Fosetyl compensate the lower rate of Isotianil in the mixture: better efficacy and persistency is observed in one trial versus Isotianil solo at 200 g ai/ha while the yield is higher than in plots treated with reference compounds.

Results from the Trials in China, 2011:

TABLE 11
Pseudomonas syringae infestation on leaves

| | Rates | | | |
|---|---|---|---|---|
| | active | Severity on | Severity on | |
| | ingredient | leaves (%) | leaves (%) | Yield |
| Composition | g a.i./ha | 15DAT2 | 14DAT2 | (Kg/plot) |
| UNTREATED | | 20.9 | 23.4 | 3.67 (100%) |
| | | | | Yield in kg |
| | | % efficacy | % efficacy | (% relative to |
| | | (Abbott) | (Abbott) | UTC) |
| ISOTIANIL 200SC | 50 | 45.9 | 33.9 | 5.62 (153%) |
| ISOTIANIL 200 SC | 200 | 58.9 | 49.1 | 10.12 (276%) |
| ISOTIANIL 200 SC | 400 | 68.2 | 65.7 | 10.83 (295%) |
| ISOTIANIL + FOSETYL AL | 200 + 1000 | 67.2 | 63.5 | 10.53 (287%) |
| FOSETYL AL | 1000 | 54.8 | 57.1 | 8.33 (227%) |
| COPPER OXYCHLORIDE (Kocide | 345* | 72.7* | 32.4** | 8.65 (236%) |
| 2000F) | 645** | | | |
| KASUGAMYCIN (Kasumin SL) | 50* | 62.3* | 39.4** | 8.75 (238%) |
| | 60** | | | |

DAT2: days after second treatment

Conclusion Protection of Cucumber Against Pseudomonas syringae:

The examples show that the level of protection reached by Isotianil from 200 g ai/ha and more consistently at 400 g ai/ha is comparable or superior to the protection allowed by the reference compounds used at local rate to control angular leaf spot infections on cucumbers after bacterial attacks of Pseudomonas syringae. The use of Isotianil at 400 g ai/ha gives to the producer a better yield production than what is expected with the standard compounds. The mixture Isotianil+Fosetyl 200+1000 g ai/ha allows to use a lower rate of Isotianil without loosing efficacy and persistency versus copper and Isotianil used at high rate.

### Example 6b

### Pseudomonas syringae Pv. Lachrymans Infestation Control with Isotianil on Cucumbers

This example illustrates the efficacy of a composition containing Isotianil against Pseudomonas syringae pv. lachrymans bacterial disease infecting mainly cucumber leaves.

Trial 1: Drenching Application

Greenhouse tests were implemented in 1998 in Japan to evaluate the performance of Isotianil against Pseudomonas syringae pv. lachrymans infection on cucumber variety Sagamihanjiro. The cucumber crop was artificially inoculated 7 days after the application with a bacterial strain of Pseudomonas syringae pv. lachrymans. The cucumber plants were inoculated at BBCH13 stage (third true leaf fully unfolded stage) on potted plants protected in preventative.

To produce a suitable preparation of active compound, 1 part by weight of active compound is mixed with the stated amounts of solvent and emulsifier, and the concentrate is diluted with water to the desired concentration.
Solvent: 28.5 parts by weight of acetone
Emulsifier: 1.5 parts by weight of polyoxyethylene alkyl phenyl ether

20 ml of the preparation of active compound was applied once at BBCH12 stage (second true leaf fully unfolded stage) by drenching. 7 days after the application, the plants were inoculated and then placed in a glass chamber at approximately 25° C. and a relative atmospheric humidity of approximately 100% for 7 days. The trial was conducted according to standard experimental practice.

Trial 2: Foliar Application

Greenhouse tests were implemented in 2000 in Japan to evaluate the performance of Isotianil against Pseudomonas syringae pv. lachrymans a infection on cucumber variety Sagamihanjiro. The cucumber crop was artificially inoculated 1 day after the application with a bacterial strain of Pseudomonas syringae pv. lachrymans. The cucumber plants were inoculated at BBCH14 stage (4th true leaf fully unfolded stage) on potted plants protected in preventative.

To produce a suitable preparation of active compound, 1 part by weight of active compound is mixed with the stated amounts of solvent and emulsifier, and the concentrate is diluted with water to the desired concentration.
Solvent: 28.5 parts by weight of acetone
Emulsifier: 1.5 parts by weight of polyoxyethylene alkyl phenyl ether

The preparation of active compound was applied once at BBCH14 stage (4th true leaf fully unfolded stage) by foliar application. 1 day after the application, the plants were inoculated and then placed in a glass chamber at approximately 25° C. and a relative atmospheric humidity of approximately 100% for 7 days. The trial was conducted according to standard experimental practice.

Trial 1: Results from assessments of Pseudomonas syringae pv. lachrymans severity on leaves, 22 days after the application demonstrated the efficacy of the composition when applied at rates range from 50 to 100 mg a.i./plant.

Results from Trial 1 in Japan, 1998:

TABLE 12
Pseudomonas syringae pv. lachrymans infestation on leaves.

| | Rate mg | % Severity |
|---|---|---|
| Composition | ai/plant | on leaves |
| UNTREATED | | 33.6 |
| | | % efficacy |
| | | (Abbott) |
| ISOTIANIL a.i. | 50 | 81 |
| ISOTIANIL a.i. | 100 | 91 |
| PROBENAZOLE a.i. | 50 | 74 |
| PROBENAZOLE a.i. | 100 | 61 |

Trial 2: Results from assessments of Pseudomonas syringae pv. lachrymans incidence on leaves, 8 days after the application demonstrated the efficacy of the composition when applied at 250 ppm.

Results from Trial 2 in Japan, 2000:

TABLE 13
Pseudomonas syringae pv. lachrymans infestation on leaves.

| | | No. of lesions |
|---|---|---|
| Composition | Rate ppm | on 15 leaves |
| UNTREATED | | 45 |
| | | % efficacy |
| | | (Abbott) |
| ISOTIANIL a.i. | 250 | 78 |
| OXOLINIC ACID | 200 | 78 |
| 2WP | | |

Conclusion Protection of Cucumber Against Pseudomonas syringae Pv. Lachrymans:

The examples show that the level of protection is superior when the compound is applied by drenching (Trial 1) and foliar application (Trial 2). The protection reached by Isotianil on cucumber is comparable or superior to the protection allowed by an antibiotic compound Oxolinic acid or a resistance inducer Probenazole used in many crops to control bacterial diseases.

### Example 6c

### Control of Disease Incidence Caused by Pseudomonas syringae Pv. Actinidiae in kiwifruit with Isotianil or Isotianil+Fosetyl-Al

The goal of the experiments was to determine whether Isotianil SC200, by itself or in combination with Fosetyl Aluminium, could reduce the incidence of bacterial canker on kiwifruit caused by Pseudomonas syringae pv. actinidiae (Psa).

Material and Methods

The experiment was conducted in the glasshouse on 15-20 cm tall Actinidia deliciosa ‘Bruno’ seedlings. The treatments consisted of different concentrations of Isotianil SC200 sample WW (IST) in combination or not with fosetyl aluminium (as Aliette® WDG) (FEA), assuming a rate of 2000 litres of products sprayed per hectare:

Treatments:

1. IST 0.1 g a.i./L

2. IST 0.2 g a.i/L

3. IST 0.1 g a.i./L+FEA 0.5 g/L

4. IST 0.2 g a.i/L+FEA 1.0 g/L

5. IST 0.1 a.i g/L+FEA 1.0 g/L

6. Water/Water

7. Water/Psa.

IST was applied first, followed 3½ hours later by FEA. The plants were then left in glasshouse until inoculation with Psa. In addition, some plants that were not inoculated were treated with IST at 0.2 g a.i/L or with IST at 0.2 g a.i/L plus FEA at 1.0 g/L to determine whether those treatments would result in phytotoxicity.

The plants were inoculated with a virulent strain of Psa (strain 10627) isolated from New Zealand. Inoculum was made in sterile water from freshly grown plates of King's B medium (King et al. 1954, Journal of Laboratory Clinical Medicine 44: 301-307) incubated at 28° C. The inoculum contained 1.2×109 colony forming unit (cfu)/ml. The severity of the disease was recorded on day 7, 14, and 21 after inoculation (7 DAI, 14 DAI and 21 DAI, respectively). Assessment of disease incidence was based on the percentage of the leaf necrosed. Leaves were scored from 0 to 5 according to the percentage of leaf surface showing necrosis: 0% necrosis was scored 0, 1-10% of the leaf area necrosed was scored 1, 11-25% necrosis was scored 2, 26-50% necrosis was scored 3, 51-75% necrosis was scored 4, and 76-100% necrosis was scored 5. The average score of all the leaves on a single plant was calculated. The score for a treatment was then determined as the average score of all the plants that received the same treatment.

Results and Discussion

The results are presented in Table 14 and FIG. 2.

TABLE 14
Control of disease incidence caused by Pseudomonas syringae
pv. actinidiae in kiwifruit

| | 1^{st} reading: | | % | 2^{nd} reading: | | % | 3^{rd} reading: | | % |
|---|---|---|---|---|---|---|---|---|---|
| | 7 DAI | | efficacy | 14 DAI | | efficacy | 21 DAI | | efficacy |
| Treatment | Mean | SE | (Abbott) | Mean | SE | (Abbott) | Mean | SE | (Abbott) |
| Psa | 0.57 | 0.23 | 0 | 1.78 | 0.30 | 0 | 2.03 | 0.24 | 0 |
| positive | | | | | | | | | |
| control | | | | | | | | | |
| IST 0.1 g/ | 0.56 | 0.11 | 2 | 1.51 | 0.12 | 15 | 1.56 | 0.12 | 23 |
| FEA 1.0 g | | | | | | | | | |
| IST 0.2 g/ | 0.51 | 0.14 | 11 | 1.25 | 0.11 | 30 | 1.35 | 0.08 | 33 |
| FEA 1.0 g | | | | | | | | | |
| IST 0.1 g/ | 0.51 | 0.17 | 11 | 1.21 | 0.24 | 32 | 1.42 | 0.28 | 30 |
| FEA 0.5 g | | | | | | | | | |
| IST 0.1 g | 0.45 | 0.13 | 21 | 1.34 | 0.24 | 25 | 1.46 | 0.25 | 28 |
| IST 0.2 g | 0.33 | 0.12 | 42 | 1.04 | 0.25 | 42 | 1.12 | 0.19 | 45 |

DAI = days after inoculation

When IST at 0.2 g/L or IST 0.2 g plus FEA at 1.0 g were applied on plants that were not inoculated, the percentage of leaf area showing necrosis was extremely low. Therefore, IST or IST in combination with FEA did not result in any significant degree of phytotoxicity. The negative control with water showed no disease (see FIG. 2).

FIG. 2: Disease incidence on kiwifruit seedlings treated with Isotianil SC200 (IST) or fosetyl aluminium (FEA) and inoculated with Pseudomonas syringae pv. actinidiae. The first (left columns), second (middle columns), and third (right columns) readings were carried out 7, 14 and 21 days after inoculation, respectively.

Between the first and second readings (day 7 and day 14 after inoculation) the disease progressed rapidly, as seen by the percentage of leaf surface necrosed. Then its development slowed down between the second reading and the third reading (day 14 and day 21 after inoculation). There was no significant increase in percentage of leaf necrosed, i.e. in amount of disease, between the second and the third reading for any of the treatments.

At 14 and 21 days after inoculation, there were no differences in the amount of disease between the different treatments, although IST on its own at 0.2 g a.i./L resulted in fewer symptoms than the other treatments. Fourteen days after inoculation, the plants that received IST alone at 0.2 g a.i./L showed significantly less disease than the water-treated plants. Twenty-one days after inoculation, all the treatments reduced the severity of the disease compared with the water treated control, with IST at 0.2 g/L being the best treatment. In this experiment, FEA, when added to IST, did not decrease the incidence of Psa.

### Example 7

### Control of Disease Incidence of Potato Tuber Bacterial Scab Caused by Streptomyces scabies in Potato with Isotianil or Isotianil+Trifloxystrobin or Isotianil+Penflufen

The objective of the study was to evaluate the performance of Isotianil against Potato tuber Bacterial scab (Common scab) caused by Streptomyces scabies and to find an effective economic dose rate.

Trial Locations were Sahiwal, Faisalabad, and Lahore in Pakistan.

TABLE 15
Details of treatments

| | | | Dose formulated/ | | Dose in g |
|---|---|---|---|---|---|
| | | g ai./L or | 100 kg | | ai./100 kg |
| Treatment | Product | kg | seed | | seed |
| T1 | Untreated | | | | |
| T2 | Isotianil 200FS | 200 | 12.0 | ml | 2.4 |
| T3 | Isotianil 200FS | 200 | 16.0 | ml | 3.2 |
| T4 | Isotianil 200FS | 200 | 20.0 | ml | 4.0 |
| T5 | Isotianil + | 200 + 80 | 7.5 | ml | 2.10 |
| | Trifloxystrobin | (280 FS) | | | |
| | FS 280 | | | | |
| T6 | Isotianil + | 200 + 80 | 10.0 | ml | 2.80 |
| | Trifloxystrobin | (280 FS) | | | |
| | FS 280 | | | | |
| T7 | Validamycin | 100 | 30 | ml | 3 |
| | 10SL | | | | |
| T8 | Isotianil | 200 + 240 | 12 + 10 | ml | 2.4 + 2.4 |
| | 200FS + | | | (tank mix) | |
| | Penflufen | | | | |
| | 240FS | | | | |

Application

Potato tubers were treated once at the time of sowing. The tuber quantity (seed) was determined according to plot size and weighed out separately for each treatment. Then product quantity was calculated and measured according to weight of tuber for each treatment on the basis of dose rate per 100 kg tuber. The water volume was calibrated to give proper coverage. The product was mixed in the calibrated volume of water for each treatment separately. The tubers were spread on a plastic sheet, sprayed thoroughly, dried, turned to the other side and sprayed thoroughly again. It was ensured that every seed has been covered with the product. After drying the tubers were sown in the marked plots. Preferably medium sized Potato tubers were used for sowing. In order to ensure disease infestation, infected tubers having a disease incidence of about 10% Potato Tuber Bacterial Scab were used.

At harvesting, the percentage of disease of potatoes for each treatment was determined and the efficacy was calculated according to ABBOTT (% efficacy). 0% means an efficacy which corresponds to that of the control, while an efficacy of 100% means that no disease was observed.

Results:

TABLE 16
Efficacy of different treatments against potato tuber bacterial scab (Streptomyces scabies)

| | | Dose | Dose | Lahore | Sahiwal | Faisalabad |
|---|---|---|---|---|---|---|
| | | [ml/100 | [g ai/100 | Efficacy | Efficacy | Efficacy |
| Treatment | Product | kg seed] | kg seed] | [% Abbott] | [% Abbott] | [% Abbott] |
| T1 | Untreated | | | 35 ^{a)} | 15 ^{a)} | 4 ^{a)} |
| T2 | Isotianil | 12 | 2.40 | 76 | 67 | 49 |
| T3 | | 16 | 3.20 | 77 | 67 | 57 |
| T4 | | 20 | 4.00 | 79 | 100 | 86 |
| T5 | Isotianil + Trifloxystrobin | 7.5 | 2.10 | 70 | 33 | 47 |
| T6 | | 10 | 2.80 | 71 | 33 | 55 |
| T7 | Validamycin | 30 | 3.00 | 65 | 33 | 47 |
| T8 | Isotianil + Penflufen | 12 + 10 | 2.4 + 2.4 | 83 | 100 | 90 |

^{a)} % infestation of untreated control plants

According to the results shown in Table 16, the efficacy of Isotianil 200FS+Penflufen 240FS (2.4 g a.i./100 kg seed of each a.i./tank mix) was equal or superior to the highest dose of Isotianil (4 g a.i./100 kg seed) and was superior compared to the two lower doses of isotianil (2.4 and 3.2 g a.i./100 kg seed) and compared to the 2 doses of Isotianil+Trifloxystrobin 280FS or to Validamycin.

1. A host defense inducer capable of being used for controlling one or more bacterial harmful organisms in one or more useful plants, wherein the bacterial harmful organisms are selected from the group consisting of Acidovorax avenae, Burkholderia spec., Burkholderia glumae, Candidatus Liberibacter spec., Corynebacterium, Erwinia spec., Pseudomonas syringae, Pseudomonas syringae pv. actinidae, Pseudomonas syringae pv. glycinea, Pseudomonas syringae pv. tomato, Pseudomonas syringae pv. lachrymans, Streptomyces spp., Xanthomonas spp., Xanthomonas axonopodis, Xanthomonas axonopodis pv. citri, Xanthomonas axonopodis pv. glycines, Xanthomonas campestris, Xanthomonas campestris pv. musacearum, Xanthomonas campestris pv. pruni, Xanthomonas fragariae and Xanthomonas transluscens.

2. A host defense inducer according to claim 1, wherein the host defense inducer is selected from the group consisting of acibenzolar-S-methyl, isotianil, probenazole and tiadinil or combinations thereof.

3. A host defense inducer according to claim 1, wherein the host defense inducer is isotianil.

4. A host defense inducer according to claim 1, wherein the bacterial harmful organisms are selected from the group consisting of Acidovorax avenae, Burkholderia spec., Burkholderia glumae, Candidatus Liberibacter spec., Corynebacterium, Erwinia amylovora, Erwinia carotovora, Erwinia carotovora subsp. atroseptica, Erwinia carotovora subsp. carotovora, Erwinia chrysanthemi, Erwinia chrysanthemi pv. zeae, Erwinia herbicola, Erwinia stewartiii, Erwinia uredovora, Pseudomonas syringae, Pseudomonas syringae pv. actinidae, Pseudomonas syringae pv. glycinea, Pseudomonas syringae pv. lachrymans, Pseudomonas syringae pv. tomato, Streptomyces scabies, Xanthomonas axonopodis, Xanthomonas axonopodis pv. citri, Xanthomonas axonopodis pv. glycines, Xanthomonas campestris, Xanthomonas campestris pv. musacearum, Xanthomonas campestris pv. pruni, Xanthomonas fragariae and Xanthomonas translucens

5. A host defense inducer according to claim 1, wherein the bacterial harmful organisms are selected from the group consisting of Burkholderia glumae, Candidatus Liberibacter spec., Xanthomonas axonopodis pv. citri, Pseudomonas syringae, Pseudomonas syringae pv. actinidae, Pseudomonas syringae pv. glycinea, Pseudomonas syringae pv. lachrymans, Pseudomonas syringae pv. tomato, Xanthomonas axonopodis pv. glycines, Xanthomonas campestris pv. pruni and Xanthomonas campestris.

6. A host defense inducer according to claim 1, wherein the useful plants are selected from the group consisting of fruit crops, vegetables, potatoes, cereals, corn, rice and soybeans.

7. A host defense inducer according to claim 1, wherein the useful plants are selected from the group consisting of apples, bananas, citrus, kiwi, melons, peaches, pears, pineapple, pome fruit, pomegranate, cabbage, cauliflower, cucumbers, cucurbits, tomatoes, potatoes, wheat, rice and soybeans.

8. A host defense inducer according to claim 1, wherein the useful plants are selected from the group consisting of citrus, kiwi, peaches, cucumbers, tomatoes, potatoes and wheat.

9. A host defense inducer according to claim 1 capable of being used for controlling Acidovorax avenae and/or Burkholderia glumae in rice, Candidatus Liberibacter spec. and/or Xanthomonas axonopodis pv. citri in citrus, Pseudomonas syringae pv. actinidae in Kiwi, Xanthomonas campestris and/or Xanthomonas campestris pv. pruni in peaches, Pseudomonas syringae pv. glycinea and/or Xanthomonas axonopodis pv. glycines in soybeans, Burkholderia spec. and/or Xanthomonas transluscens in cereals, Pseudomonas syringae, Pseudomonas syringae pv. tomato and/or Xanthomonas campestris in tomatoes, Pseudomonas syringae and/or Pseudomonas syringae pv. lachrymans in cucumbers, Erwinia atroseptica, Erwinia caratovora and/or Streptomyces scabies in potatoes.

10. A host defense inducer according to claim 1 capable of being used for controlling Burkholderia glumae in rice, Candidatus Liberibacter spec. and/or Xanthomonas axonopodis pv. citri in citrus, Pseudomonas syringae pv. actinidae in Kiwi, Xanthomonas campestris and/or Xanthomonas campestris pv. pruni in peaches, Pseudomonas syringae pv. glycinea and/or Xanthomonas axonopodis pv. glycines in soybeans, Pseudomonas syringae and/or Pseudomonas syringae pv. tomato in tomatoes, Pseudomonas syringae, Pseudomonas syringae pv. lachrymans in cucumbers and/or Streptomyces scabies in potatoes.

11. A host defense inducer according to claim 1, wherein the host defense inducer or a combination thereof is present in a composition comprising at least one further compound selected from the group consisting of bactericides, antibiotics, fungicides, herbicides, micronutrients and micronutrient-containing compounds, and lipochito-oligosaccharide compounds (LCO).

12. A host defense inducer present in a composition according to claim 11, wherein the at least one further compound is selected from the group consisting of fosetyl-Al, penflufen, strobilurins, copper-containing compounds, propineb and mancozeb, lipochito-oligosaccharide compounds (LCO), kasugamycin, streptomycin, and oxytetracyclin.

13. A host defense inducer present in a composition according to claim 11, wherein the host defense inducer is isotianil and the at least one further compound is selected from the group consisting of fosetyl-Al, penflufen, azoxystrobin, trifloxystrobin, copper-hydroxyde, copper-sulphate, copper-oxychloride, copper, propineb, mancozeb, lipochito-oligosaccharide compounds (LCO), kasugamycin, streptomycin, and oxytetracyclin.

14. Method for controlling one or more bacterial harmful organisms in one or more useful plants using a host inducer as claimed in claim 1, the method comprising treating the one or more plants with the host defense inducer.

15. Method according to claim 14, wherein the treated plants are transgenic plants.
